(19) United States
(12) Patent Application Publication
(10) Pub. No.: US 2026/0047981 A1
(43) Pub. Date: Feb. 19, 2026

(54) DRUG-MIXING SYSTEM AND PROGRAM

(71) Applicant: YUYAMA MFG. CO., LTD., Osaka (JP)

(72) Inventors: Junichiro NISHIDA, Toyonaka-shi (JP); Junya KITAGAWA, Toyonaka-shi (JP)

(73) Assignee: YUYAMA MFG. CO., LTD., Osaka (JP)

(21) Appl. No.: 19/367,818

(22) Filed: Oct. 24, 2025

Related U.S. Application Data
(63) Continuation of application No. PCT/JP2024/016254, filed on Apr. 25, 2024.

(30) Foreign Application Priority Data
Apr. 27, 2023 (JP) 2023-073459

(51) Int. Cl. A61J 1/22; A61J 1/20

(52) U.S. Cl. CPC A61J 1/22; A61J 1/2096

(57) ABSTRACT

A drug-mixing system according to one or more embodiments is disclosed that may include a drug-mixing apparatus. The drug-mixing apparatus may include a drug-injecting processor that executes drug-mixing processing of injecting a drug in a drug container into an infusion container based on preparation data; and a first recorder that records preset recorded information related to the preparation data on a recording medium to be attached to the infusion container; and a controller that causes the preset recorded information related to the preparation data to be recorded by a second recorder provided separately from the drug-mixing apparatus in response to the drug-mixing processing based on the preparation data in the drug-mixing apparatus being canceled.

### CROSS REFERENCE TO RELATED APPLICATIONS

This application is a continuation application of International Application No. PCT/JP2024/016254 filed on Apr. 25, 2024, which claims priority based on the Article 8 of Patent Cooperation Treaty from prior Japanese Patent Application No. 2023-073459 filed with the Japan Patent Office on Apr. 27, 2023, the entire contents of which are incorporated herein by reference.

### TECHNICAL FIELD

The disclosure relates to a drug-mixing system for executing drug-mixing processing for a drug.

### BACKGROUND ART

Drug-mixing processing of aspirating a drug housed in a drug container such as a vial with a syringe and injecting the drug in the syringe into an infusion container such as an infusion bag may be executed by a user such as a pharmacist. Further, a drug dispensing apparatus that dispenses a drug container used in the drug-mixing processing based on preparation data is known (see, for example, WO 2019/093413 A1). Still further, a drug-mixing apparatus capable of automatically executing the drug-mixing processing is also known (see, for example, Japanese Patent Application Laid-open No. 2022-40295).

Incidentally, when drug-mixing processing based on preparation data is executed by the drug-mixing apparatus, it is conceivable that recorded information related to the preparation data, which includes preset information of a drug and others, is recorded on a label by a recording unit, such as a label printer, provided in the drug-mixing apparatus.

However, after preparation data for which drug-mixing processing is to be executed by the drug-mixing apparatus is input to the drug-mixing apparatus, it is conceivable that the drug-mixing processing based on the preparation data is not executed by the drug-mixing apparatus for some reason such as an error or a schedule change. In this case, the recorded information is not recorded on the label by the recording unit provided in the drug-mixing apparatus, and hence user's work becomes complicated.

### SUMMARY

A drug-mixing system and a drug-mixing program according to one or more embodiments may be achieved that a workload of a user of a drug-mixing system including a drug-mixing apparatus that executes drug-mixing processing based on preparation data is reduced.

A drug-mixing system according to one or more embodiments may include: a drug-mixing apparatus including: a drug-injecting processor that executes drug-mixing processing of injecting a drug in a drug container into an infusion container based on preparation data; and a first recorder that records preset recorded information related to the preparation data on a recording medium to be attached to the infusion container; and a controller that causes the preset recorded information related to the preparation data to be recorded by a second recorder provided separately from the drug-mixing apparatus in response to the drug-mixing processing based on the preparation data in the drug-mixing apparatus being canceled.

A drug-mixing system according to one or more embodiments may include: a drug-mixing apparatus including: a drug-mixing apparatus including: a drug-injecting processor that executes drug-mixing processing of injecting a drug in a drug container into an infusion container based on preparation data; and a first recorder that executes recording processing of recording preset recorded information related to the preparation data on a recording medium to be attached to the infusion container; and a controller that transmits, to the drug-mixing apparatus, a drug-mixing instruction including an instruction to execute the drug-mixing processing based on the preparation data and an instruction to execute the recording processing. In one or more embodiment, the controller may change, in response to the drug-mixing processing in the drug-mixing apparatus being canceled, an entity that executes the recording processing from the first recorder to a second recorder provided separately from the drug-mixing apparatus.

A non-transitory computer-readable storage medium according to one or more embodiments storing a program for causing a processor provided in a drug-mixing system, the drug-mixing system comprising a drug-mixing apparatus that comprises: a drug-injecting processor that executes drug-mixing processing of injecting a drug in a drug container into an infusion container based on preparation data; and a first recorder that records preset recorded information related to the preparation data on a recording medium to be attached to the infusion container, the program, which when read and executed, causes the processor to perform operation that may include causing the preset recorded information related to the preparation data to be recorded by a second recorder provided separately from the drug-mixing apparatus when the drug-mixing processing based on the preparation data in the drug-mixing apparatus is canceled

A non-transitory computer-readable storage medium according to one or more embodiments storing a program for causing a processor provided in a drug-mixing system, the drug-mixing system comprising a drug-mixing apparatus that includes: a drug-injecting processor that executes drug-mixing processing of injecting a drug in a drug container into an infusion container based on preparation data; and a first recorder that executes recording processing of recording preset recorded information related to the preparation data on a recording medium to be attached to the infusion container, the program, which when read and executed, causes the processor to perform operations that nay include: transmitting, to the drug-mixing apparatus, a drug-mixing instruction including an instruction to execute the drug-mixing processing based on the preparation data and an instruction to execute the recording processing; and changing, when the drug-mixing processing in the drug-mixing apparatus is canceled, an entity that executes the recording processing from the first recorder to a second recorder provided separately from the drug-mixing apparatus.

According to one or more embodiments, it may be possible to provide the drug-mixing system and the drug-mixing program with which the work efficiency of the user of the drug-mixing system including the drug-mixing apparatus that executes the drug-mixing processing based on the preparation data may be improved.

### BRIEF DESCRIPTION OF DRAWINGS

FIG. 1 is a perspective view illustrating an example of an overall configuration of a drug-mixing apparatus according to one or more embodiments.

FIG. 2 is a perspective view illustrating an example of a schematic internal configuration of the drug-mixing apparatus when viewed from the front.

FIG. 3 is a perspective view illustrating an example of a schematic internal configuration of the drug-mixing apparatus when viewed from the rear.

FIG. 4 is a block diagram for illustrating an example of an overall configuration of the drug-mixing apparatus.

FIG. 5 is a perspective view illustrating an example of a configuration of a drug-mixing unit.

FIG. 6 is a front view illustrating an example of a schematic configuration of the drug-mixing unit.

FIG. 7 is an explanatory diagram illustrating adjustment of a needle tip position of a syringe.

FIG. 8 is a view illustrating an example of a configuration of a second conveyance unit.

FIG. 9 is an explanatory diagram illustrating a reading position of first information.

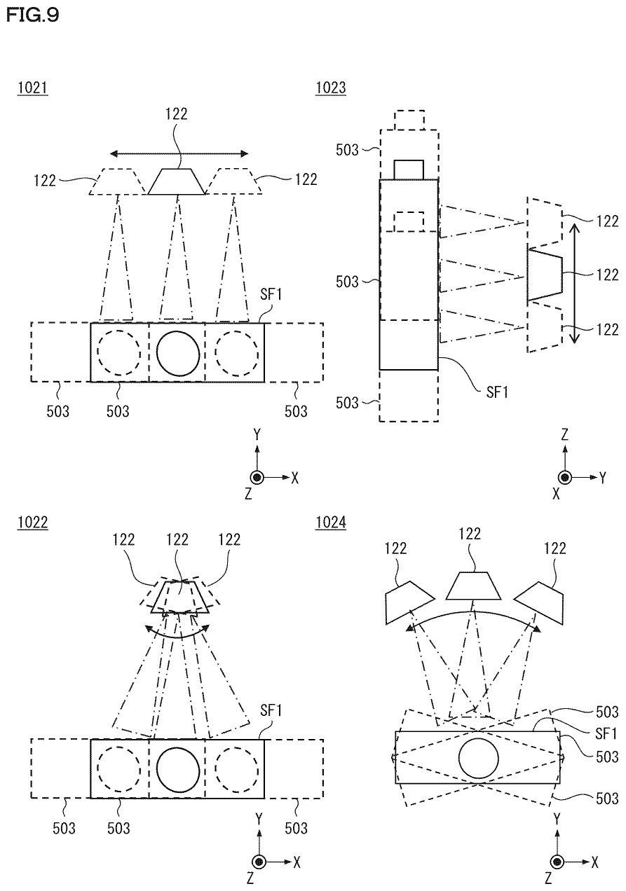

FIG. 10 is a perspective view illustrating an example of an overall configuration of syringe shelves and drug container shelves.

FIG. 11 is a view illustrating an example of a configuration of one syringe shelf and one drug container shelf when viewed from a first conveyance unit side, and an explanatory view for illustrating the drug container shelf.

FIG. 12 is a flowchart illustrating an example of a flow of processing of a controller performed when the controller receives an instruction to collect a drug container.

FIG. 13 is a perspective view for illustrating an example of a configuration of an infusion shelf.

FIG. 14 is a view illustrating an example of a specific configuration of a pushing-in unit.

FIG. 15 is a side view illustrating an example of a pushing-in conveyance unit.

FIG. 16 is a perspective view illustrating an example of an overall configuration of a printing/inspection unit.

FIG. 17 is a perspective view illustrating the printing/inspection unit viewed from the rear.

FIG. 18 is a perspective view illustrating an example of an internal configuration of the printing/inspection unit.

FIG. 19 is an explanatory view illustrating an example of an operation from reading of the first information to attachment of a second label.

FIG. 20 is a view illustrating an example of an infusion container in which a first label is attached to a first surface and an example of an infusion container in which the second label is attached to a second surface.

FIG. 21 is a front view illustrating an example of an infusion receiving shelf.

FIG. 22 is a side view illustrating an example of the infusion receiving shelf.

FIG. 23 is a view illustrating an example of a shape of rail portions.

FIG. 24 is an explanatory view illustrating a shutter.

FIG. 25 is a block diagram illustrating a configuration of a drug-mixing system.

FIG. 26 is a flowchart illustrating an example of data output processing.

FIG. 27 is a table illustrating an example of grouping of preparation data in the drug-mixing system.

FIG. 28 is a view illustrating an example of a display screen in the drug-mixing system.

FIG. 29 is a view illustrating an example of a conveyance tray used in the drug-mixing system.

FIG. 30A and FIG. 30B are each a view illustrating an example of a form printed by the drug-mixing system.

FIG. 31 is a flowchart illustrating an example of drug-mixing control processing.

FIG. 32 is a flowchart illustrating an example of drug-mixing cancellation processing.

FIG. 33 is a flowchart illustrating an example of switching control processing.

FIG. 34 is a view illustrating an example of a label printed by the drug-mixing system.

FIG. 35 is a flowchart for illustrating an example of drug dispensing processing.

FIG. 36 is a view illustrating an example of an injection prescription sheet printed by the drug-mixing system.

FIG. 37 is a flowchart illustrating an example of tray verification processing.

FIG. 38A and FIG. 38B are each a view illustrating an example of a display screen in the drug-mixing system.

### DETAILED DESCRIPTION

Now, one or more embodiments are described in detail. In each drawing, an X-axis and a Y-axis are axes in two directions perpendicular to each other in a horizontal plane (ground-contacting surface of a drug-mixing apparatus 1). A positive X-axis direction may be referred to as “rightward direction,” and a negative X-axis direction may be referred to as “leftward direction.” A positive Y-axis direction may be referred to as “deep direction” or “rearward direction,” and a negative Y-axis direction may be referred to as “near direction” or “forward direction.” A Z-axis is an axis extending vertically to an XY plane, and a positive Z-axis direction may be referred to as “upward direction,” and a negative Z-axis direction may be referred to as “downward direction.

### [Overall Configuration of Drug-mixing Apparatus 1]

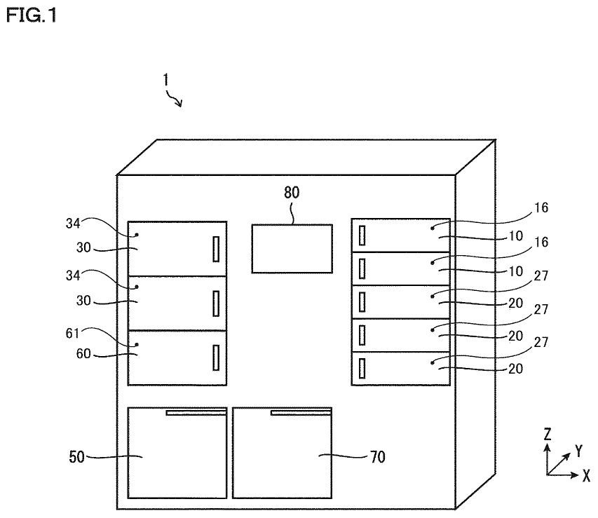

FIG. 1 is a perspective view for illustrating an example of an overall configuration of the drug-mixing apparatus 1. As illustrated in FIG. 1, the drug-mixing apparatus 1 according to one or more embodiments includes syringe shelves 10, drug container shelves 20, infusion shelves 30, a printing/inspection unit 50, an infusion receiving shelf 60, a waste box 70, and a touch panel 80.

The drug-mixing apparatus 1 is an apparatus that executes drug-mixing processing (drug-mixing operation) of mixing a drug and an infusion through use of the drug, a syringe, and the infusion indicated in data related to preparation and administration (hereinafter referred to as “preparation data”). More specifically, the drug-mixing apparatus 1 executes drug-mixing processing of aspirating, through use of a syringe, a drug indicated in the preparation data from a drug container, such as a vial, in which the drug is housed, and injecting the drug into an infusion container, such as an infusion bag, in which an infusion is housed. The infusion used for the drug-mixing processing may be, for example, a liquid containing saline (normal saline) or glucose. In one or more embodiments, the syringe, the drug container, the infusion container, and the like used in the drug-mixing processing may be hereinafter collectively referred to as “equipment.”

Other examples of the drug-mixing processing include processing of aspirating a drug from a drug container through use of a syringe and injecting the drug into another drug container, or processing of aspirating an infusion from an infusion container through use of a syringe and injecting the infusion into a drug container. When a solid drug (such as a powdered drug) is housed in a drug container, the drug-mixing apparatus 1 aspirates an infusion from an infusion container through use of a syringe and injects the infusion into the drug container. As a result, in the drug container, the solid drug can be made into a liquid form. After that, the drug-mixing apparatus 1 injects the liquid drug into the infusion container through use of the syringe.

In the drug-mixing apparatus 1, for example, a user can fill the inside of the drug-mixing apparatus 1 with a syringe, a drug container, and an infusion container by opening and closing a door. An air cleaning unit described later keeps the inside of the drug-mixing apparatus 1 in a clean state to reduce the possibility that the drug and the infusion are contaminated during the drug-mixing processing. In addition, in order to keep the inside of the drug-mixing apparatus 1 in a clean state, the inside of the drug-mixing apparatus 1 is kept at a positive pressure. When the drug-mixing apparatus 1 handles a drug such as an anticancer drug, however, the inside of the drug-mixing apparatus 1 is kept at a negative pressure.

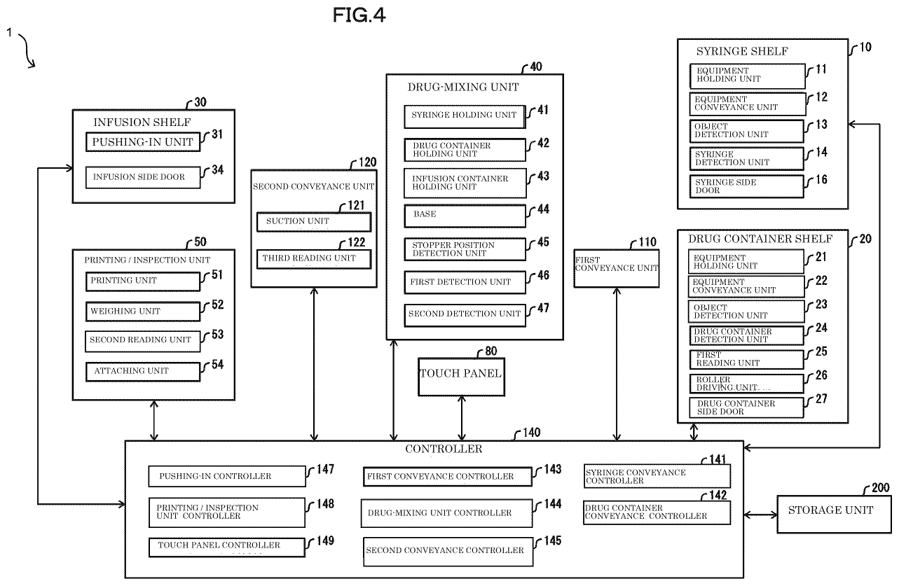

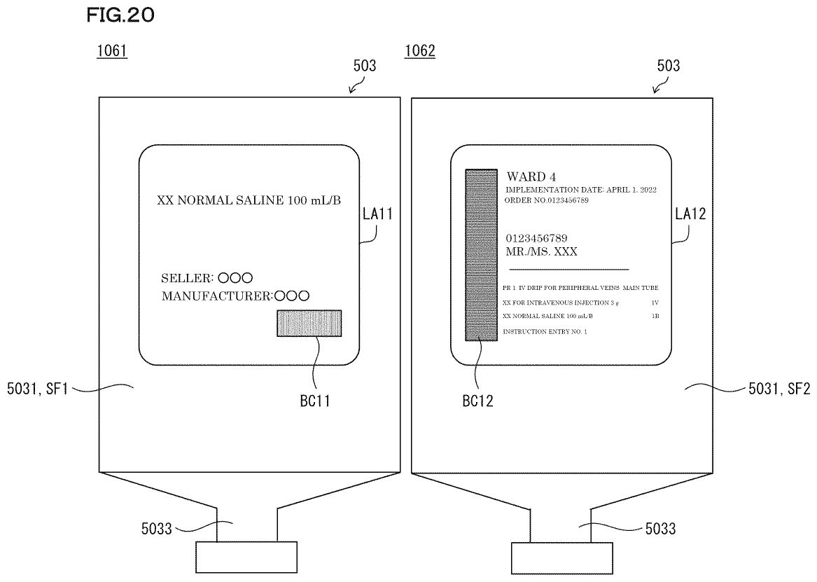

The preparation data is data required for a controller 140 (see FIG. 4) of the drug-mixing apparatus 1 to perform drug-mixing processing and printing processing of printing a second label (see reference numeral 1062 of FIG. 20), and is generated based on prescription data. Specifically, the preparation data is generated based on the prescription data by a host system 2 described later, and is input from the host system 2 to the drug-mixing apparatus 1. The preparation data may be generated by the controller 140 of the drug-mixing apparatus 1. Alternatively, after preparation data is generated by the host system 2 based on the prescription data and the preparation data is input to the drug-mixing apparatus 1, the preparation data may be converted by the controller 140 of the drug-mixing apparatus 1 into working preparation data for executing drug-mixing processing based on the preparation data in the drug-mixing apparatus 1 in accordance with a preset conversion condition, and then the drug-mixing processing may be executed.

More specifically, in one or more embodiments, after a plurality of pieces of preparation data are transmitted from the host system 2 of the drug-mixing apparatus 1 to the drug-mixing apparatus 1, the controller 140 automatically issues the plurality of pieces of preparation data received from the host system 2 to set the plurality of pieces of preparation data as processing targets, and thus drug-mixing processing based on each of the pieces of preparation data is sequentially executed. Therefore, the preparation data serves as a drug-mixing instruction (injection instruction) to execute the drug-mixing processing in the drug-mixing apparatus 1. As another embodiment or embodiments, after a plurality of pieces of preparation data are transmitted from the host system 2 of the drug-mixing apparatus 1 to the drug-mixing apparatus 1, execution of drug-mixing processing based on the preparation data may be suspended in the drug-mixing apparatus 1, and when an issuing operation of issuing the preparation data to be a processing target is performed in the drug-mixing apparatus 1, or when a preset timing arrives, the preparation data may be issued and the drug-mixing processing based on the issued preparation data may be executed. That is, even when the input of the preparation data to the drug-mixing apparatus 1 functions as a drug-mixing instruction, the drug-mixing instruction is not required to be one that instructs immediate execution of the drug-mixing processing based on the preparation data. Further, as another embodiment or embodiments, the preparation data may be transmitted from the host system 2 of the drug-mixing apparatus 1 to the drug-mixing apparatus 1 for each time of drug-mixing processing. In this case, when the drug-mixing processing by the drug-mixing apparatus 1 is completed, the controller 140 requests the host system 2 to transmit preparation data for the drug-mixing apparatus 1 to execute the next drug-mixing processing. When receiving the preparation data, the controller 140 starts the next drug-mixing processing.

The preparation data includes, for example, information indicating a type of a drug used in the drug-mixing processing, a prescribed amount of the drug, information indicating a type of a syringe, information indicating a type of an infusion (infusion type information), and information indicating an amount of the infusion to be withdrawn from the infusion container. The preparation data also includes information on the number of pieces of equipment, such as drug containers, infusion containers, or syringes, required for the drug-mixing processing based on the preparation data. As another embodiment or embodiments, even in a case in which the preparation data does not include information on the number of pieces of equipment, when the preparation data includes the usage amount of, for example, a drug or an infusion for specifying the information on the number of pieces of equipment, the controller 140 may specify the number of pieces of equipment, such as drug containers, infusion containers, or syringes, based on the usage amount.

Further, the preparation data includes information related to the infusion container into which the drug is injected, as information to be printed on a second label LA12. Examples of the information include prescription attribute information, prescription detail information, an order number indicating the position in the order of reception of prescriptions, and infusion type information (e.g., infusion name). The prescription attribute information, the prescription detail information, the order number indicating the position in the order of reception of prescriptions, the infusion type information, and the like are pieces of information included in prescription data referred to in order to generate the preparation data.

The prescription attribute information includes information indicating a patient name and a patient ID (example of patient identification information for identifying a patient) to whom a drug has been prescribed, a ward name and a hospital room name in which the patient is hospitalized, a full name of a medical worker (example of a person in charge) who administers the drug obtained by drug-mixing to the patient, a department name to which the medical worker belongs, and the like. The prescription attribute information may also include patient's physical information such as the patient's weight, height, or body surface area. The patient's physical information is used, for example, for the purpose of calculating a standard dose indicating the dose per body surface area of the patient's drug.

The prescription detail information includes information indicating a prescription classification (administration timing such as regular, temporary, emergency, and stock drug), a recipe (Rp) number, an IV drip procedure, a route, a drug name (example of drug identification information indicating the type of drug), a usage, a dose, an administration time (implementation time), a comment, and the like. The prescription classification indicates a classification of prescription data, and the prescription classification includes, for example, an administration timing such as regular, emergency, or stock drug. An Rp is information on a unit of application including a drug name, a usage, a dose, and the like, and one piece of prescription data may include one or a plurality of Rps. Specifically, in the drug-mixing processing based on the preparation data, one infusion container is generated as a product for each Rp. That is, one piece of preparation data includes data for executing the drug-mixing processing for one Rp. The route is information indicating a destination of the body for taking in the liquid in the infusion container into which the drug has been injected (e.g., peripheral vein or internal jugular peripheral). The administration time is information indicating, for example, a date (hereinafter also referred to as “administration date”) and a time at which the drug in the infusion container, which is a product of the drug-mixing processing by the drug-mixing apparatus 1, is administered to a patient. The prescription detail information also includes information to the effect that the drug is one for which early administration after drug-mixing is recommended because there is a possibility that a composition change may occur, when the drug is such a drug.

It is only required that the information related to the infusion container into which the drug is injected include at least information indicating the drug name, the patient name, the hospital room name, and the drug-mixing implementation date. The drug-mixing implementation date is information recorded as the date on which the drug-mixing apparatus 1 actually performs the drug-mixing processing (date on which the prescribed drug is injected into the infusion container).

The syringe shelves 10 are equipment storage shelves capable of storing syringes supplied to the drug-mixing apparatus 1. Specifically, in the drug-mixing apparatus 1, as illustrated in FIG. 1, upper and lower two-stage syringe shelves 10 are provided. Each syringe shelf 10 is provided with a syringe side door 16. The user can cause the syringe shelf 10 to hold a syringe by opening and closing the syringe side door 16. In particular, in the drug-mixing apparatus 1, the type of the syringe to be housed in each of the upper and lower two-stage syringe shelves 10 is determined in advance, and in the drug-mixing processing, a syringe housed in one of the syringe shelves 10 is used in accordance with the type of the syringe specified by the preparation data.

The drug container shelves 20 are equipment storage shelves capable of storing drug containers supplied to the drug-mixing apparatus 1. Specifically, in the drug-mixing apparatus 1, as illustrated in FIG. 1, three-stage drug container shelves 20 are provided. Each drug container shelf 20 is provided with a drug container side door 27. The user can cause the drug container shelf 20 to hold a drug container by opening and closing the drug container side door 27.

The infusion shelves 30 are infusion storage shelves capable of storing infusion containers supplied to the drug-mixing apparatus 1. Specifically, in the drug-mixing apparatus 1, as illustrated in FIG. 1, upper and lower two-stage infusion shelves 30 are provided. Each infusion shelf 30 is provided with an infusion side door 34. The user can cause the infusion shelf 30 to hold an infusion container by opening and closing the infusion side door 34.

The syringe side door 16, the drug container side door 27, and the infusion side door 34 are doors that can block user's access to the syringe shelf 10, the drug container shelf 20, and the infusion shelf 30, respectively. In the drug-mixing apparatus 1, only one of the syringe side door 16, the drug container side door 27, and the infusion side door 34 is controlled by the controller 140, which is described later, to be in an unlocked state.

The printing/inspection unit 50 is a unit that prints (records) preset second information (example of recorded information) related to the preparation data on a second label LA12 (example of a recording medium) to be attached to an infusion container, and attaches the obtained second label LA12 to the infusion container before or after drug injection, and is an example of a first recorder in one or more embodiments. The printing/inspection unit 50 may be one that records the second information on an IC tag or the like to be attached to the infusion container, or may be one that directly records the second information on the infusion container. The printing/inspection unit 50 may print an unsuitability information label (described later) and attach the unsuitability information label to the infusion container after drug injection. The printing/inspection unit 50 is also a unit that weighs the infusion container before and after drug injection.

The infusion receiving shelf 60 is a unit that receives the infusion container after drug injection to which the second label LA12 is attached. The infusion receiving shelf 60 is provided with an infusion receiving door 61. The waste box 70 is a box that receives used syringes. The touch panel 80 has a function of an operation unit that receives various types of operations by the user and a function of a display unit that displays various types of information. Instead of the touch panel 80, the operation unit and the display unit may be provided as separate members. A presentation unit (e.g., a speaker) that presents various types of information may be provided together with or instead of the display unit.

### [Outline of Internal Configuration of Drug-mixing Apparatus]

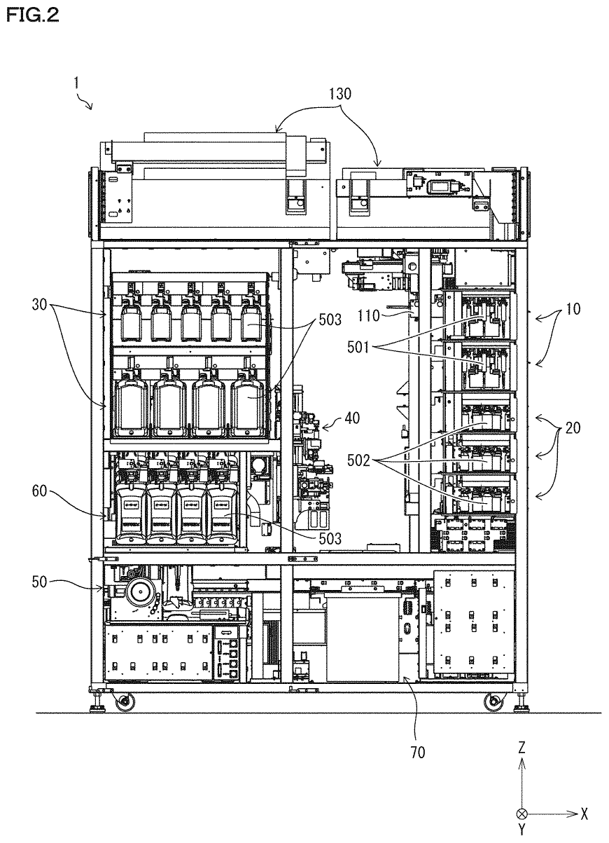

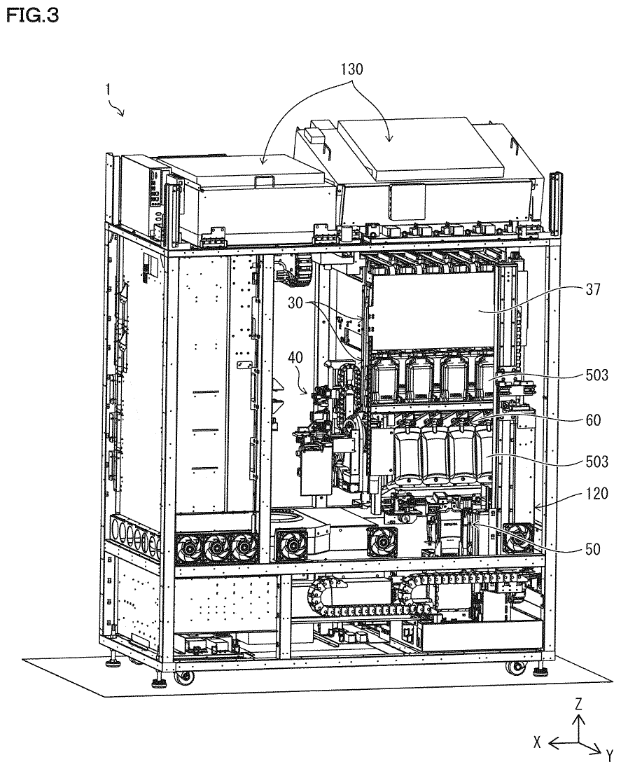

FIG. 2 is a perspective view for illustrating an example of a schematic internal configuration of the drug-mixing apparatus 1 when viewed from the front (near side). FIG. 3 is a perspective view for illustrating an example of a schematic internal configuration of the drug-mixing apparatus 1 when viewed from the rear (deep direction).

As illustrated in FIG. 2 and FIG. 3, the drug-mixing apparatus 1 includes, in addition to the above-mentioned syringe shelves 10, drug container shelves 20, infusion shelves 30, printing/inspection unit 50, infusion receiving shelf 60, and waste box 70, a drug-mixing unit 40 (example of a drug-injecting processor), a first conveyance unit 110, a second conveyance unit 120, and air cleaning units 130. A syringe, a drug container, and an infusion container which are used in the drug-mixing apparatus 1 may be hereinafter referred to as “syringe 501,” “drug container 502,” and “infusion container 503,” respectively.

The drug-mixing unit 40 functions as an injection unit that injects a drug into an infusion container 503 that houses an infusion. When the drug-mixing unit 40 injects the drug into the infusion container 503, the drug is mixed with the infusion in the infusion container 503. The drug-mixing unit 40 also functions as a member that withdraws an infusion from an infusion container 503. The drug-mixing unit 40 can inject the infusion into the drug container 502 by withdrawing the infusion from the infusion container 503. As a result, a solid drug housed in the drug container 502 can be made into a liquid form. In one or more embodiments, the drug-mixing unit 40 is located between the syringe shelves 10 and the drug container shelves 20, and the infusion shelves 30 and the infusion receiving shelf 60.

An example of an operation performed when the drug-mixing unit 40 executes an injection step of injecting 10 ml of an infusion from an infusion container 503 into each of two drug containers 502 in each of which 0.5 g of a solid drug is housed to make the drug into a liquid form, and then injecting the liquid drug into the infusion container 503 is described below. In this case, the drug-mixing unit 40 first aspirates 20 ml of the infusion used to dissolve the drug in the two drug containers 502 from the infusion container 503. Then, with the mouth of the first drug container 502 facing upward, downward, or horizontally, the drug-mixing unit 40 punctures the drug container 502 with an injection needle of the syringe 501. After that, the drug-mixing unit 40 repeatedly performs a series of steps of an injection-aspiration operation of injecting only 10 ml of the liquid in the syringe 501 from the syringe 501 into the first drug container 502, and then aspirating 10.5 ml of the liquid drug from the drug container 502 a preset plurality of times. As a result, the solid drug in the first drug container 502 is aspirated into the syringe 501 as a liquid drug. Next, similarly to the first drug container 502, the drug-mixing unit 40 punctures the mouth of the second drug container 502 with the injection needle of the syringe 501. After that, the drug-mixing unit 40 repeatedly performs a series of steps of an injection-aspiration operation of injecting only 10 ml of the liquid in the syringe 501 from the syringe 501 into the second drug container 502, and then aspirating 10.5 ml of the liquid drug from the drug container 502 a preset plurality of times. As a result, the solid drug in the second drug container 502 is also aspirated into the syringe 501 as a liquid drug. That is, for dissolving of the drug in the second drug container 502, 20 ml of the liquid drug in which 0.5 g of the drug in the first drug container 502 is dissolved is used. Then, the drug-mixing unit 40 injects the liquid drug in the syringe 501 into the infusion container 503 all at once. As a result, it is possible to shorten the time required for the drug-mixing processing as compared with a case in which the injection-aspiration operation is performed individually for each drug container 502 to inject the liquid drug into the infusion container 503, that is, a case in which aspiration of the infusion from the infusion container 503 and injection of the drug into the infusion container 503 are required the same number of times as the number of drug containers 502. As another embodiment or embodiments, 20 ml of the liquid in the syringe 501 may be injected only in the injection-aspiration operation for the second drug container 502, or 20 ml of the liquid in the syringe 501 may be injected in both the injection-aspiration operations for the first drug container 502 and the second drug container 502.

The first conveyance unit 110 functions as a container conveyance unit that conveys a syringe 501 indicated in preparation data from the syringe shelf 10 to the drug-mixing unit 40, or conveys a drug container 502 in which a drug indicated in the preparation data is housed from the drug container shelf 20 to the drug-mixing unit 40. When the preparation data is issued and the preparation data to be processed is determined, the first conveyance unit 110 conveys the syringe 501 stored in the syringe shelf 10 and the drug container 502 stored in the drug container shelf 20 to the drug-mixing unit 40. In one or more embodiments, the first conveyance unit 110 grips an upper part of a barrel portion of the syringe 501 stored in the syringe shelf 10, and delivers the syringe 501 to the drug-mixing unit 40. Similarly, the first conveyance unit 110 grips a neck portion of the drug container 502 stored in the drug container shelf 20, and delivers the drug container 502 to the drug-mixing unit 40.

In addition, the first conveyance unit 110 conveys the syringe 501 stored in the syringe shelf 10 to a cap attaching/detaching unit (not shown) before conveying the syringe 501 to the drug-mixing unit 40. As a result, the first conveyance unit 110 can remove a needle cap attached to a needle of the syringe 501, and can convey the syringe 501 from which the needle cap has been removed to the drug-mixing unit 40. The first conveyance unit 110 also conveys the syringe 501 and the drug container 502 after the drug-mixing processing (the syringe 501 and the drug container 502 that are no longer required) to the waste box 70.

The first conveyance unit 110 is a common conveyance unit for the syringe 501 and the drug container 502 that conveys the syringe 501 and the drug container 502, but the technical scope is not limited to this configuration. A dedicated conveyance unit that conveys the syringe 501 and a dedicated conveyance unit that conveys the drug container 502 may be provided separately.

The second conveyance unit 120 functions as an infusion container conveyance unit that conveys an infusion container 503 indicated in the preparation data among the infusion shelf 30, the drug-mixing unit 40, the printing/inspection unit 50, and the infusion receiving shelf 60.

As illustrated in FIG. 2, in the infusion shelf 30 arranged in the upper stage, infusion containers 503 are housed in an array of five lanes arranged in a left-right direction (X-axis direction). Meanwhile, in the infusion shelf 30 arranged in the lower stage, infusion containers 503 are housed in an array of four lanes arranged in the left-right direction (X-axis direction). In each of the infusion shelves 30, a predetermined number of infusion containers 503 can be housed in a front-rear direction (Y-axis direction) of each lane in accordance with the type of the infusion container 503. In the drug-mixing apparatus 1, the type of the infusion container 503 to be housed in each lane is determined in advance, and in the drug-mixing processing, an infusion container 503 housed in one of the lanes of the infusion shelf 30 is used in accordance with the type of the infusion container 503 specified by the preparation data.

The second conveyance unit 120 conveys the infusion container 503 to the drug-mixing unit 40. When the preparation data is issued and the preparation data to be processed is determined, the second conveyance unit 120 conveys the infusion container 503 stored in the infusion shelf 30 to the drug-mixing unit 40. In one or more embodiments, the second conveyance unit 120 suctions a barrel portion of the infusion container 503 stored in the infusion shelf 30 to deliver the infusion container 503 to the drug-mixing unit 40.

In addition, the second conveyance unit 120 conveys the infusion container 503 between the drug-mixing unit 40 and the printing/inspection unit 50. In one or more embodiments, for example, the second conveyance unit 120 suctions the barrel portion of the infusion container 503 after drug injection to convey the infusion container 503 to the printing/inspection unit 50.

The second conveyance unit 120 also functions as a delivery unit that delivers the infusion container 503 into which the drug has been injected by the drug-mixing unit 40 to the infusion receiving shelf 60. In one or more embodiments, the second conveyance unit 120 suctions the barrel portion of the infusion container 503 after drug injection, to which second information different from first information has been attached by the printing/inspection unit 50 (to which the second label LA12 has been attached, or the second label LA12 and the unsuitability information label have been attached) to deliver the infusion container 503 to the infusion receiving shelf 60. Details of the first information and the second information are described later.

Each of the air cleaning units 130 cleans the air inside the drug-mixing apparatus 1 and exhausts the air. In one or more embodiments, the air cleaning units 130 are provided in an upper part of the drug-mixing apparatus 1. The air cleaned by the air cleaning units 130 flows from the upper part to a bottom part of the drug-mixing apparatus 1. Each of the air cleaning units 130 includes, for example, a high-efficiency particulate air (HEPA) filter.

The arrangement of each member in the drug-mixing apparatus 1 is not limited to the above-mentioned arrangement. For example, the drug container shelves 20 may be provided on an upper stage of the syringe shelves 10. The arrangement positions of the syringe shelves 10 and the drug container shelves 20, and the infusion shelves 30, the infusion receiving shelf 60, and the printing/inspection unit 50 may be reversed. In one or more embodiments, the syringe shelf 10, the drug container shelf 20, and the infusion shelf 30 are each provided as a plurality of stages, but a configuration in which each thereof is provided as one stage is also possible. In one or more embodiments, the infusion receiving shelf 60 is provided as one stage, but a configuration in which the infusion receiving shelf 60 is provided as a plurality of stages is also possible. The arrangement positions of the printing/inspection unit 50 and the infusion receiving shelf 60 may be reversed. It is only required that the arrangement of each member in the drug-mixing apparatus 1 be determined in consideration of user convenience, ease of manufacturing, and the like.

In addition, a syringe side door 16 and/or a drug container side door 27 may be provided on a side surface of the drug-mixing apparatus 1 (right side of the drawing sheet of FIG. 2). As described later, one syringe 501 and one drug container 502 are supplied from the front surface of the drug-mixing apparatus 1. Meanwhile, a plurality of syringes 501 or a plurality of drug containers 502 can be supplied from the side surface side of the drug-mixing apparatus 1. When the infusion shelf 30 has the same configuration as those of the syringe shelf 10 and the drug container shelf 20, an infusion side door 34 may be provided on another side surface side of the drug-mixing apparatus 1 (left side of the drawing sheet of FIG. 2).

The drug-mixing apparatus 1 may have a configuration like that of a drug-mixing apparatus that executes drug-mixing processing through use of one or a plurality of robot arms as disclosed in, for example, Japanese Patent Application Laid-open No. 2022-40295.

The drug-mixing apparatus 1 includes a controller 140 and a storage unit 200. FIG. 4 shows, for the drug-mixing apparatus 1, a main hardware configuration that can be controlled by the controller 140 among hardware configurations included in the drug-mixing apparatus 1.

The controller 140 is one that comprehensively controls the operation of the drug-mixing apparatus 1 based on preparation data, and is an example of a drug-mixing control apparatus according to one or more embodiments. The controller 140 includes, for example, a syringe conveyance controller 141, a drug container conveyance controller 142, a first conveyance controller 143, a drug-mixing unit controller 144, a second conveyance controller 145, a pushing-in controller 147, a printing/inspection unit controller 148, and a touch panel controller 149.

The syringe conveyance controller 141 controls the operation of members related to the conveyance of a syringe 501 in the syringe shelf 10. The drug container conveyance controller 142 controls the operation of members related to the conveyance of a drug container 502 in the drug container shelf 20. The drug-mixing unit controller 144 controls the operation of members included in the drug-mixing unit 40.

The first conveyance controller 143 controls the operation of members included in the first conveyance unit 110. The first conveyance controller 143 controls, for example, the movement of the first conveyance unit 110 among the syringe shelf 10, the drug container shelf 20, the drug-mixing unit 40, the waste box 70, and the cap attaching/detaching unit (not shown). The second conveyance controller 145 controls the operation of members included in the second conveyance unit 120. The second conveyance controller 145 controls, for example, the movement of the second conveyance unit 120 among the infusion shelf 30, the drug-mixing unit 40, the printing/inspection unit 50, and the infusion receiving shelf 60.

The pushing-in controller 147 controls the operation of members related to the conveyance of an infusion container 503 in the infusion shelf 30. The printing/inspection unit controller 148 controls the operation of members included in the printing/inspection unit 50. The touch panel controller 149 controls the touch panel 80.

In addition, the storage unit 200 stores data for the controller 140 to perform drug-mixing processing and printing processing. The storage unit 200 stores, for example, preparation data. The storage unit 200 also stores a drug master. For example, the drug master includes information such as a drug code, a drug name, a JAN code (or RSS), a drug bottle code, a classification (dosage form: powder (powdered drug), tablet, liquid drug, external preparation, and the like), specific gravity, viscosity, drug type (ordinary drug, anticancer drug, poisonous drug, narcotic, powerful drug, antipsychotic drug, therapeutic drug, and the like), composition change, excipient, precautions, type of drug container (ampule or drug container bottle), amount of drug housed per drug container unit (predetermined amount), container shape information of the drug container, and weight of the drug container. The drug master also includes information on an infusion container in which an infusion such as normal saline or glucose is housed. Specifically, the information on the infusion container also includes information such as identification information of the infusion and a specific gravity of the infusion. The drug master may also include information for specifying a combination of drugs for which early administration after drug-mixing is recommended because there is a possibility that a composition change may occur. [Specific Configuration of Drug-mixing Unit]

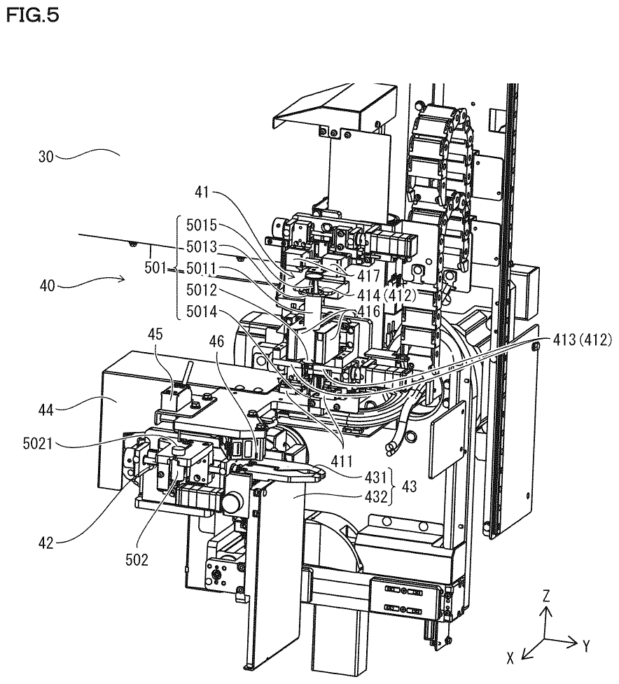

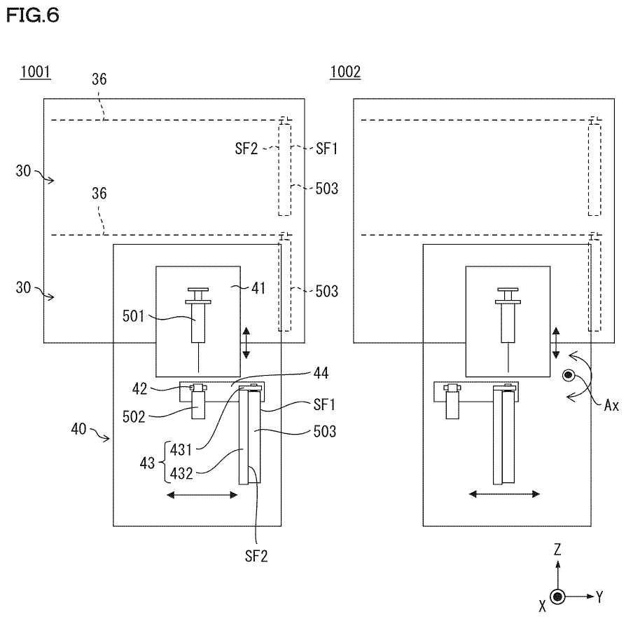

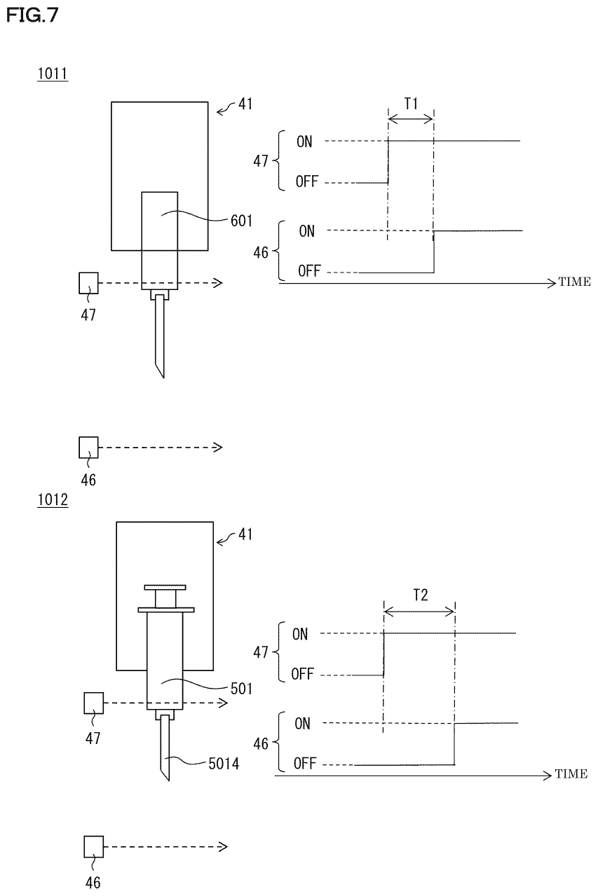

FIG. 5 is a perspective view for illustrating an example of a configuration of the drug-mixing unit 40. FIG. 6 is a front view for illustrating an example of a schematic configuration of the drug-mixing unit 40, and is an explanatory diagram for illustrating an example of an operation of the drug-mixing unit 40. FIG. 7 is an explanatory diagram for illustrating adjustment of a needle tip position of the syringe 501.

As illustrated in FIG. 5, the drug-mixing unit 40 includes a syringe holding unit 41, a drug container holding unit 42, an infusion container holding unit 43, a stopper position detection unit 45, and a first detection unit 46.

The syringe holding unit 41 is a member that holds the syringe 501 (the syringe 501 conveyed by the first conveyance unit 110) for injecting a drug into the infusion container 503. The syringe 501 includes a barrel 5011, a needle 5014, and a plunger 5015. The plunger 5015 is a pusher that moves in and out of the barrel 5011. When the plunger 5015 moves in and out of the barrel 5011, a drug or the like can be drawn into the barrel 5011 or a drug or the like in the barrel 5011 can be discharged. The barrel 5011 includes a needle-side end portion 5012 to which the needle 5014 is attached, and a flange 5013 which is an end portion on the opposite side to the needle-side end portion 5012 and on the side on which the plunger 5015 moves in and out.

The syringe holding unit 41 includes a needle clamping unit 411, a position fixing unit 412, a first barrel holding unit 416, and a plunger clamping unit 417. Herein, a member described as clamping an object is merely an example, and the member may be any member that can hold the object.

The needle clamping unit 411 is a member that clamps the needle 5014. The needle clamping unit 411 clamps the needle 5014 to position a tip of the needle 5014 at a fixed position. As a result, during the drug-mixing processing, even when the needle 5014 is bent, the infusion container 503 can be punctured with the needle 5014 at a desired position (correct position) of a stopper provided on the infusion container 503.

The first barrel holding unit 416 is a member that first holds the syringe 501 conveyed from the syringe shelf 10 by the first conveyance unit 110. The first barrel holding unit 416 clamps a side surface of the barrel 5011 (e.g., a lower part of the barrel 5011) inserted into the first barrel holding unit 416.

The position fixing unit 412 is a member that fixes a position of the syringe 501 in an extending direction of the syringe 501 at the needle-side end portion 5012 and the flange 5013. In one or more embodiments, a relative position between a second barrel holding unit 413 and a third barrel holding unit 414 that form the position fixing unit 412 can be changed along the extending direction of the syringe 501. The second barrel holding unit 413 and the third barrel holding unit 414 are attached such that at least one of the second barrel holding unit 413 or the third barrel holding unit 414 is movable along the extending direction of the syringe 501.

In one or more embodiments, when the syringe 501 is held by the position fixing unit 412, the second barrel holding unit 413 abuts from a lower side of the needle-side end portion 5012, and the third barrel holding unit 414 abuts from an upper side of the flange 5013. As a result, the position fixing unit 412 can clamp the syringe 501 along the extending direction of the syringe 501. The position fixing unit 412 can fix the barrel 5011 so as not to slide in the extending direction of the syringe 501 with a smaller force than in a case in which only a side surface of the barrel 5011 is clamped, by clamping the syringe 501 along the extending direction of the syringe 501. Further, there is no deformation of the barrel 5011 due to clamping of the side surface, and hence a smooth operation of the plunger 5015 is possible. Accordingly, the adjustment accuracy of the aspiration and injection amounts of the syringe 501 is improved.

The plunger clamping unit 417 is a member that clamps the plunger 5015. In one or more embodiments, the plunger clamping unit 417 clamps a tip portion of the plunger 5015. When the plunger clamping unit 417 moves in an up-down direction with respect to the needle clamping unit 411, the position fixing unit 412, and the first barrel holding unit 416, the plunger 5015 can be moved with respect to the barrel 5011.

The drug container holding unit 42 is a member that holds the drug container 502 (the drug container 502 conveyed by the first conveyance unit 110) that houses a drug to be injected into the infusion container 503. In one or more embodiments, the drug container holding unit 42 clamps the neck portion of the drug container 502.

The infusion container holding unit 43 is a member that holds the infusion container 503 (the infusion container 503 conveyed by the second conveyance unit 120). In one or more embodiments, the infusion container holding unit 43 includes an infusion clamping unit 431 that clamps a neck portion of the infusion container 503, and a placement table 432 on which the infusion container 503 is placed when an infusion is withdrawn from the infusion container 503 or when an infusion is injected into the infusion container 503.

As illustrated in FIG. 5 and FIG. 6, the drug-mixing unit 40 is provided on a side wall of the infusion shelf 30. Specifically, in the drug-mixing apparatus 1, the drug-mixing unit 40 is arranged such that the syringe holding unit 41, the drug container holding unit 42, and the infusion container holding unit 43 face a direction of the syringe shelf 10 and the drug container shelf 20 (+X-axis direction).

In addition, as illustrated in FIG. 6, the syringe holding unit 41 is movable in the up-down direction (+Z-axis direction). As a result, the drug container 502 or the infusion container 503 located directly below the syringe 501 held by the syringe holding unit 41 can be punctured with the needle 5014.

The drug container holding unit 42 and the infusion container holding unit 43 are movable in the front-rear direction (±Y-axis direction) of the drug-mixing apparatus 1. In one or more embodiments, the drug container holding unit 42 and the infusion container holding unit 43 are attached to a base 44, and the base 44 moves in the front-rear direction of the drug-mixing apparatus 1. The base 44 functions as a moving unit that moves the drug container holding unit 42 and the infusion container holding unit 43 in a direction (±Y-axis direction) orthogonal to an extending direction (±Z-axis direction) of the needle 5014 of the syringe 501 held by the syringe holding unit 41. The direction orthogonal to the extending direction of the needle 5014 may be simply referred to as “direction orthogonal to the needle 5014.”

With this configuration, the drug container holding unit 42 and the infusion container holding unit 43 can move between a position indicated by reference numeral 1001 of FIG. 6 and a position indicated by reference numeral 1002 of FIG. 6. The position indicated by reference numeral 1001 of FIG. 6 is a first puncture position when the drug container 502 is punctured with the needle 5014, and the position indicated by reference numeral 1002 of FIG. 6 is a second puncture position when the infusion container 503 is punctured with the needle 5014. Therefore, the drug container 502 held by the drug container holding unit 42 or the infusion container 503 held by the infusion container holding unit 43 can be positioned at a puncture position of the needle 5014 of the syringe 501 held by the syringe holding unit 41.

The base 44 is an example of the moving unit, and the moving unit is not limited to the base 44, and may be any member that moves the drug container holding unit 42 and the infusion container holding unit 43 in the direction orthogonal to the needle 5014. The moving unit may be one that moves the syringe holding unit 41 in the direction orthogonal to the needle 5014 with respect to the drug container holding unit 42 and the infusion container holding unit 43. The moving unit may be any member that can move the drug container holding unit 42 and the infusion container holding unit 43 relative to the syringe holding unit 41.

As indicated by reference numeral 1002 of FIG. 6, the drug-mixing unit 40 is provided so as to be rotatable about a rotation axis Ax (with Ax as the rotation axis). The rotation axis Ax is an axis extending in a direction (±X-axis direction) perpendicular to a pedestal on which the syringe holding unit 41, the drug container holding unit 42, and the infusion container holding unit 43 are provided.

At the first puncture position indicated by reference numeral 1001 of FIG. 6, when the drug-mixing unit 40 rotates about the rotation axis Ax, the drug container 502 can be moved to a position above the syringe 501. At the second puncture position indicated by reference numeral 1002 of FIG. 6, when the drug-mixing unit 40 rotates about the rotation axis Ax, the infusion container 503 can be moved to a position above the syringe 501. In those states, the drug-mixing unit 40 can move a drug housed in the drug container 502 or an infusion housed in the infusion container 503 to the barrel 5011 by moving the plunger 5015 in the downward direction.

The infusion housed in the barrel 5011 is injected into the drug container 502 under a state indicated by reference numeral 1001 of FIG. 6 (state in which the drug container 502 is located directly below the syringe 501). Similarly, the drug housed in the barrel 5011 is injected into the infusion container 503 under a state indicated by reference numeral 1002 of FIG. 6 (state in which the infusion container 503 is located directly below the syringe 501).

As illustrated in FIG. 6, the infusion container 503 has a first surface SF1 and a second surface SF2. The first surface SF1 and the second surface SF2 are surfaces on sides opposite to each other in the infusion container 503, and are main surfaces of the infusion container 503. The main surface of the infusion container 503 refers to a surface having a large area among a plurality of surfaces that form the infusion container 503.

In the infusion shelf 30, the infusion container 503 is stored such that the first surface SF1 and the second surface SF2 of the infusion container 503 face a predetermined direction. In one or more embodiments, the infusion container 503 is held by rail portions 36 of the infusion shelf 30 such that the first surface SF1 faces the deep direction of the drug-mixing apparatus 1 and the second surface SF2 faces the near direction of the drug-mixing apparatus 1. Then, the second conveyance unit 120 suctions the first surface SF1 in the infusion shelf 30 to hold the infusion container 503, and conveys and delivers the infusion container 503 to the infusion container holding unit 43 without changing its orientation. After that, in order to withdraw the infusion from the infusion container 503, the drug-mixing unit 40 rotates about the rotation axis Ax. As a result, the infusion container 503 is placed on the placement table 432 under a state in which the second surface SF2 abuts against the placement table 432.

As described above, the placement table 432 rotates about the rotation axis Ax which is orthogonal to the predetermined direction (±Y-axis direction) in a horizontal plane (XY plane). Accordingly, as described above, the infusion container 503 conveyed from the infusion shelf 30 can be placed on the placement table 432 without changing the orientation of the infusion container 503. Therefore, it is not required to provide a mechanism for changing the orientation of the infusion container 503 in the drug-mixing apparatus 1 in order to place the infusion container 503 on the placement table 432.

In addition, a surface of the placement table 432 is substantially parallel to the X-axis direction. Accordingly, by rotating the drug-mixing unit 40 about the rotation axis Ax and adjusting a rotation position of the drug-mixing unit 40, the surface of the placement table 432 can be made to face the predetermined direction in which the first surface SF1 and the second surface SF2 of the infusion container 503 face, even without changing the orientation of the infusion container 503. With the surface of the placement table 432 and the first surface SF1 and the second surface SF2 of the infusion container 503 facing the same direction, it is possible to mitigate the collapse of the shape of the infusion container 503 when the infusion container 503 is caused to abut against the placement table 432. In addition, it is possible to mitigate the movement of a position of a portion in which a liquid is housed in the infusion container 503 (e.g., the barrel portion of the infusion container 503) when the infusion container 503 is caused to abut against the placement table 432.

Referring back to FIG. 5, the stopper position detection unit 45 is a sensor that detects a position of a rubber stopper 5021 of the drug container 502 held by the drug container holding unit 42. The rubber stopper 5021 is a member provided on an upper surface portion of the drug container 502 and to be punctured with the needle 5014. In one or more embodiments, the stopper position detection unit 45 is arranged at a position directly above the drug container holding unit 42 at the second puncture position indicated by reference numeral 1002 of FIG. 6. The stopper position detection unit 45 may be, for example, a distance measuring sensor.

The first detection unit 46 detects a needle tip of the needle 5014 of the syringe 501 held by the syringe holding unit 41. The syringe holding unit 41 moves in the downward direction when the drug container 502 held by the drug container holding unit 42 or the infusion container 503 held by the infusion container holding unit 43 is punctured with the needle 5014. The first detection unit 46 detects the needle tip of the needle 5014 that has moved with this downward movement. The first detection unit 46 may be, for example, an optical sensor including a light receiving unit that receives light reflected by the needle 5014.

Reference distance information indicating a distance between a position at which the stopper position detection unit 45 detects an object and a position at which the first detection unit 46 detects an object in the up-down direction is stored in the storage unit 200 in advance. The drug-mixing unit controller 144 can calculate a distance from a position of the needle 5014 that has passed in front of the first detection unit 46 to the rubber stopper 5021, from a difference between a distance from the stopper position detection unit 45 to the rubber stopper 5021 detected by the stopper position detection unit 45 and the distance indicated by the reference distance information.

As described above, the drug container holding unit 42 moves in the direction (±Y-axis direction) orthogonal to the needle 5014. Accordingly, at the first puncture position indicated by reference numeral 1001 of FIG. 6 and the second puncture position indicated by reference numeral 1002 of FIG. 6, a position of the drug container 502 in the up-down direction is substantially the same. For this reason, the position of the rubber stopper 5021 detected by the stopper position detection unit 45 at the second puncture position can also be applied at the first puncture position. Therefore, the drug-mixing unit controller 144 can puncture the rubber stopper 5021 with only the needle tip of the needle 5014 by moving the needle 5014 that has passed in front of the first detection unit 46 in the downward direction by the calculated distance.

When the drug container 502 is punctured deeply with the needle tip of the needle 5014, not all of the drug housed in the drug container 502 can be aspirated into the syringe 501. When the drug container 502 is punctured with the needle tip with high accuracy as described above, most of the drug housed in the drug container 502 can be aspirated into the syringe 501.

Further, as illustrated in FIG. 7, the drug-mixing unit 40 may include a second detection unit 47. The second detection unit 47 is a sensor that detects the syringe holding unit 41 directly above the first detection unit 46. The second detection unit 47 may be an optical sensor, similarly to the first detection unit 46. Through use of the first detection unit 46 and the second detection unit 47, the drug-mixing unit controller 144 can detect a tip position of the needle 5014 of the syringe 501 held by the syringe holding unit 41.

Specifically, as indicated by reference numeral 1011 of FIG. 7, after a jig 601 (reference syringe) is attached to the syringe holding unit 41, the syringe holding unit 41 is moved in the downward direction at a predetermined speed V. The drug-mixing unit controller 144 measures a first detection time T1 from when the second detection unit 47 detects the syringe holding unit 41 until the first detection unit 46 detects a needle of the jig 601. A person or the like measures a tip position of the needle of the jig 601 at the time when the second detection unit 47 detects the syringe holding unit 41, and stores the measured tip position in the storage unit 200 in advance. A position serving as a reference for measuring the tip position can be freely set.

As indicated by reference numeral 1012 of FIG. 7, with the syringe 501 actually used in the drug-mixing processing attached to the syringe holding unit 41, the syringe holding unit 41 is moved in the downward direction at the predetermined speed V. The drug-mixing unit controller 144 measures a second detection time T2 from when the second detection unit 47 detects the syringe holding unit 41 until the first detection unit 46 detects the needle 5014. As a result, the drug-mixing unit controller 144 can obtain the tip position of the needle 5014 of the syringe 501 actually used in the drug-mixing processing at the time when the syringe holding unit 41 in a state of holding the syringe 501 actually used in the drug-mixing processing is detected by the second detection unit 47, from the expression “((second detection time T2)−(first detection time T1))×(predetermined speed V)” and the tip position of the needle of the jig 601 stored in advance in the storage unit 200.

### [Specific Configuration of Second Conveyance Unit]

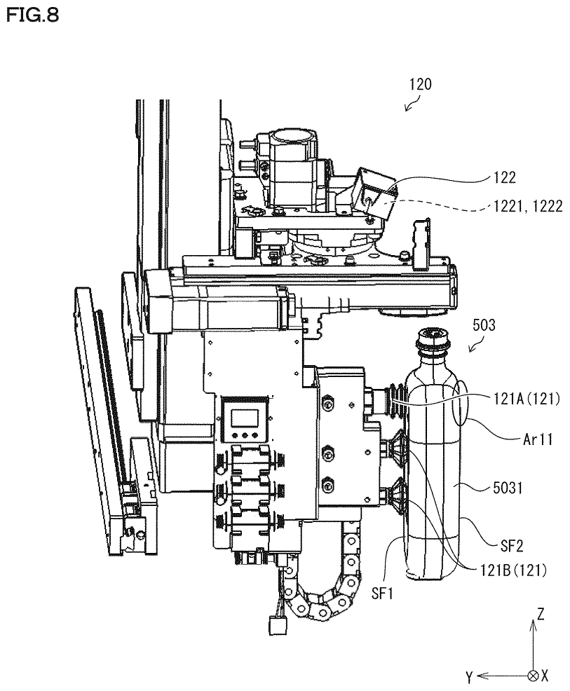

FIG. 8 is a view for illustrating an example of a configuration of the second conveyance unit 120. The second conveyance unit 120 is a member that takes out an infusion container 503 indicated in preparation data from an infusion shelf 30 in order to, for example, inject a drug into the infusion container 503. The second conveyance unit 120 includes suction units 121 and a third reading unit 122 (reading unit).

The suction units 121 are members that suction a barrel portion 5031 of the infusion container 503. The suction units 121 correspond to an example of a holding member that holds the infusion container 503, and as long as the second conveyance unit 120 can hold the infusion container 503, the holding member is not required to be the suction unit 121. The second conveyance controller 145 attaches and detaches the infusion container 503 by controlling air pressures in the suction units 121.

In one or more embodiments, three suction units 121 are provided along the up-down direction at a position facing the infusion container 503 in the second conveyance unit 120. The three suction units 121 include a main suction unit 121A and two sub suction units 121B.

The main suction unit 121A is one that is always used to suction the infusion container 503 when the second conveyance unit 120 holds the infusion container 503. The main suction unit 121A is provided at a position that can face all of a plurality of types of infusion containers 503 of different sizes that can be stored in the drug-mixing apparatus 1. The two sub suction units 121B suction the infusion container 503 together with the main suction unit 121A in accordance with the size of the infusion container 503 in the up-down direction. Therefore, at least any one of the two sub suction units 121B may not suction the infusion container 503 depending on the size of the infusion container 503.

A positional relationship between a suction location of the infusion container 503 (e.g., the infusion shelf 30 and the drug-mixing unit 40) and the second conveyance unit 120 is determined in advance so that the main suction unit 121A is always used when the second conveyance unit 120 holds the infusion container 503.

The controller 140 stores the type of the infusion container 503 being conveyed by the second conveyance unit 120 in a volatile memory. Accordingly, when power of the drug-mixing apparatus 1 is turned off due to a power failure or the like while the second conveyance unit 120 is conveying the infusion container 503, there is a possibility that the controller 140 cannot manage the type of the infusion container 503 held by the second conveyance unit 120. In such a case, in the drug-mixing apparatus 1 after power is turned on, the printing/inspection unit 50 attaches a label on which information indicating that drug-mixing processing using the infusion container 503 may not have been correctly performed is printed, to the infusion container 503 held by the second conveyance unit 120. The information may be an example of the second information different from the first information (described later), and in this case, the label is a label indicating the second information, and similarly to the second label LA12, may be attached at a position that does not overlap with a first label LA11 (see reference numeral 1061 of FIG. 20).

At this time, the label is attached to a region Ar11 facing the main suction unit 121A on the second surface SF2. A positional relationship between the main suction unit 121A and a guide unit 56 (described later) of the printing/inspection unit 50 is determined in advance so that the label can be attached to the region Ar11. A surface opposite to a portion of the second surface SF2 that is suctioned by the suction unit 121 is less likely to move, and a label can be more reliably attached thereto. The region Ar11 is a surface opposite to a portion that is suctioned in any infusion container 503. Accordingly, when the region Ar11 is set as a label attachment position, a label can be more reliably attached regardless of what type of the infusion container 503 is held by the second conveyance unit 120.

The label may be attached by the user. In addition, at least a part of the label may be attached to the region Ar11. The number of suction units 121 is not limited to three, and may be one, or two or more other than three. When a plurality of suction units 121 are provided, it is only required that at least one thereof be the main suction unit 121A.

The third reading unit 122 reads the first information included in the first label LA11 (see reference numeral 1061 of FIG. 20) attached to the barrel portion 5031 of the infusion container 503. The first label LA11 is a label attached in advance to the infusion container 503 by a pharmaceutical manufacturer that provides the infusion container 503, and is also referred to as “infusion label.” The first information read by the third reading unit 122 is, for example, infusion type information indicating the type of infusion.

In one or more embodiments, the third reading unit 122 includes a light receiving unit 1222 that receives light reflected on a surface of the infusion container 503. When the third reading unit 122 includes, for example, a light emitting unit 1221 that emits light toward the surface of the infusion container 503 stored in the infusion shelf 30, the light receiving unit 1222 may receive the reflected light after the light emitted by the light emitting unit 1221 is reflected on the surface of the infusion container 503. The third reading unit 122 reads the first information based on a change in the amount of light received by the light receiving unit 1222. When the first information is included in a barcode, the third reading unit 122 may be achieved by a barcode reader.

In one or more embodiments, the third reading unit 122 also functions as a recognition unit that recognizes an orientation of the first surface SF1 of the infusion container 503. Specifically, the third reading unit 122 recognizes the orientation of the first surface SF1 based on a change in the amount of light received by the light receiving unit 1222. In this case, the third reading unit 122 can recognize the orientation of the first surface SF1 by functioning as an optical member. In one or more embodiments, when the third reading unit 122 has successfully read the first information, the controller 140 recognizes that the orientation of the first surface SF1 is the predetermined direction. In one or more embodiments, the predetermined direction is the deep direction of the drug-mixing apparatus 1 (direction in which the third reading unit 122 is located when viewed from the infusion shelf 30).

The third reading unit 122 reads the first information included in the first label LA11 from the infusion container 503 in a state of being stored in the infusion shelf 30 when the second conveyance unit 120 takes out the infusion container 503 from the infusion shelf 30. In one or more embodiments, the first label LA11 is attached to the first surface SF1. Accordingly, when the second conveyance unit 120 takes out the infusion container 503 from the infusion shelf 30, in a case in which the infusion container 503 is stored in the infusion shelf 30 such that the second conveyance unit 120 and the first label LA11 face each other, the third reading unit 122 can recognize that the orientation of the first surface SF1 is the deep direction of the drug-mixing apparatus 1.

The controller 140 determines whether the type of infusion indicated by the first information is the same as the type of infusion indicated by the preparation data, as a result of the third reading unit 122 reading the first information. When the controller 140 determines that the two types are the same, the controller 140 conveys the infusion container 503 to the drug-mixing unit 40 or the like without reporting an error to the effect that the two types are not the same. In contrast, when the controller 140 determines that the two types are not the same, the controller 140 may report an error, or may place the infusion container 503 in the infusion receiving shelf 60 and take out another infusion container 503 from the infusion shelf 30. [Specific Configuration of Syringe Shelf]

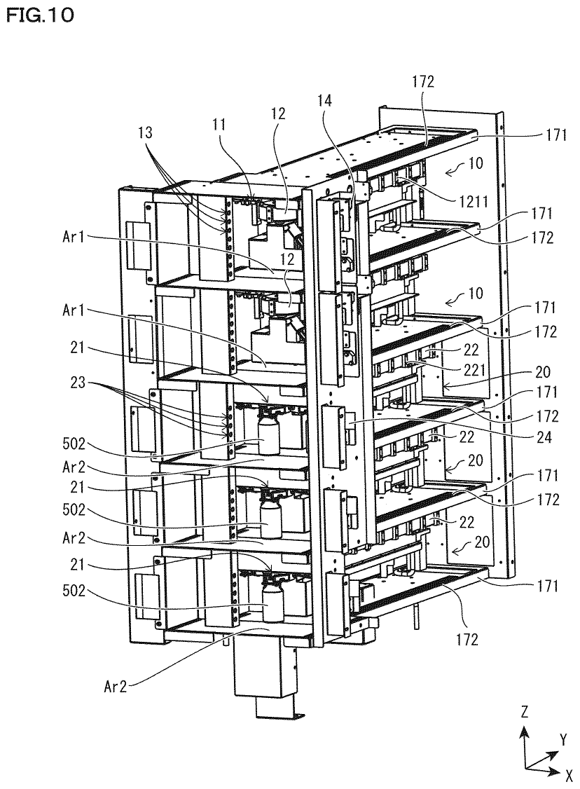

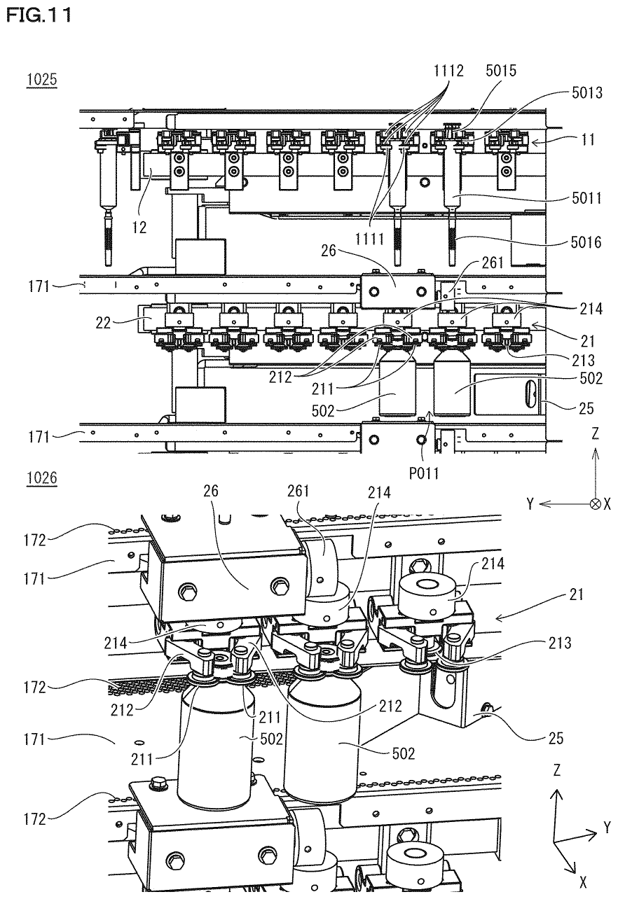

FIG. 10 is a perspective view for illustrating an example of an overall configuration of the syringe shelves 10 and the drug container shelves 20. Reference numeral 1025 of FIG. 11 is a view for illustrating an example of a configuration of one syringe shelf 10 and one drug container shelf 20 when viewed from the first conveyance unit 110 side. Reference numeral 1026 of FIG. 11 is an explanatory view for illustrating the drug container shelf 20.

As illustrated in FIG. 10, the syringe shelf 10 includes a plurality of equipment holding units 11, an equipment conveyance unit 12, object detection units 13, and a syringe detection unit 14. Although an equipment holding unit 11 is also attached to an attachment portion 1211 of the equipment conveyance unit 12 illustrated in FIG. 10, illustration thereof is omitted.

Prior to drug-mixing processing, the syringe shelf 10 is filled with the syringes 501 by the user. The syringe 501 is supplied to the syringe shelf 10 with the needle cap 5016 attached to the needle 5014.

In one or more embodiments, a plurality of holes 172 are formed in a plate-like member 171 that defines each syringe shelf 10. As a result, for example, the air cleaned by the air cleaning units 130 (see FIG. 2) can efficiently flow from the upper part to the bottom part of the drug-mixing apparatus 1.

The plurality of equipment holding units 11 are members capable of holding the syringes 501. In one or more embodiments, one syringe 501 is held in one equipment holding unit 11, but a plurality of syringes 501 may be held in one equipment holding unit 11. In one or more embodiments, as illustrated in FIG. 11, the equipment holding unit 11 includes free rollers 1111 and equipment clamping units 1112.

The equipment clamping units 1112 clamp the syringe 501. In one or more embodiments, the equipment clamping units 1112 clamp the flange 5013 of the syringe 501. The equipment clamping units 1112 are provided at such a height that the syringe 501 does not touch the plate-like member 171 when the syringe 501 is held by the equipment holding unit 11.

A pair of equipment clamping units 1112 are biased in a direction toward each other so as to be able to clamp the syringe 501. In one or more embodiments, the equipment clamping units 1112 are separated from each other to a degree smaller than a width of the flange 5013 under a state in which the flange 5013 is not clamped. When the flange 5013 is inserted between the equipment clamping units 1112, the equipment clamping units 1112 move so as to fit the shape of the flange 5013. As a result, the equipment clamping units 1112 can clamp the syringe 501.

Below a tip portion of each of the equipment clamping units 1112, the free roller 1111 which has a rotation axis extending in the up-down direction and is rotatable on the XY plane is provided. The free roller 1111 holds a vicinity of the flange 5013 of the barrel 5011 clamped by the equipment clamping units 1112.

The equipment conveyance unit 12 is a member that conveys at least one of the plurality of equipment holding units 11 to a work area Ar1. In one or more embodiments, the equipment conveyance unit 12 is an endless rotating member (rotating belt) to which the plurality of equipment holding units 11 are connected. Accordingly, in one or more embodiments, the equipment conveyance unit 12 conveys the equipment holding units 11 one by one to the work area Ar1. However, the equipment conveyance unit 12 may be a conveyance unit that conveys the plurality of equipment holding units 11 to the work area Ar1 at once.

The work area Ar1 is an area in which the user causes at least one of the plurality of equipment holding units 11 to hold the syringe 501. The work area Ar1 is also an area in which the user removes the syringe 501 held by at least one of the plurality of equipment holding units 11. In one or more embodiments, the work area Ar1 is an area in which the user causes one equipment holding unit 11 to hold the syringe 501 and also an area in which the user removes the syringe 501 held by one equipment holding unit 11.

The work area Ar1 may function only as an area in which the user causes at least one of the plurality of equipment holding units 11 to hold the syringe 501. In this case, an area in which the user removes the syringe 501 held by the equipment holding unit 11 may be provided at a position different from the work area Ar1. The work area Ar1 may also function only as an area in which the user removes the syringe 501 held by the equipment holding unit 11. In this case, an area in which the user causes the equipment holding unit 11 to hold the syringe 501 may be provided at a position different from the work area Ar1.

In one or more embodiments, the equipment conveyance unit 12 conveys another equipment holding unit 11 in place of the equipment holding unit 11 located in the work area Ar1, triggered by such detection of a user's action that the object detection units 13 no longer detect an object (e.g., a user's hand) after detecting the object. In this case, when the user's hand is inserted into the work area Ar1, the user causes the equipment holding unit 11 to hold the syringe 501, and then the user's hand is moved away from the work area Ar1, the equipment conveyance unit 12 conveys another equipment holding unit 11 to the work area Ar1. In addition to the detection of the user's action, the equipment conveyance unit 12 may convey another equipment holding unit 11 to the work area Ar1, triggered by the syringe detection unit 14 detecting the syringe 501 held by the equipment holding unit 11, or by the syringe detection unit 14 being unable to detect the syringe 501 held by the equipment holding unit 11.

The equipment conveyance unit 12 may convey another equipment holding unit 11 in place of the equipment holding unit 11 located in the work area Ar1, triggered by a conveyance instruction from the user. In this case, the syringe conveyance controller 141 may receive the conveyance instruction from the user through, for example, the touch panel 80.

The equipment conveyance unit 12 changes the equipment holding unit 11 located in the work area Ar1 by rotating, for example, counterclockwise. With this conveyance operation, another equipment holding unit 11 in which the syringe 501 is not held can be conveyed to the work area Ar1, in place of the equipment holding unit 11 in which the syringe 501 is held in the work area Ar1.

Each of the object detection units 13 is a member that detects an object inserted into the work area Ar1. In one or more embodiments, the object detection units 13 detect a user's hand or arm in a state of being inserted into the work area Ar1. The syringe detection unit 14 is a member that detects the syringe 501 held by the equipment holding unit 11 located in the work area Ar1. In one or more embodiments, when the syringe 501 is held by the equipment holding unit 11, the syringe detection unit 14 detects the barrel 5011.

The storage unit 200 stores syringe inventory information indicating the type and number of syringes 501 housed in the syringe shelf 10. For example, in the syringe inventory information, information for identifying each equipment holding unit 11, information indicating the type of the syringe 501 held by each equipment holding unit 11, and information indicating a conveyance position of each equipment holding unit 11 are stored in association with each other. Then, the controller 140 appropriately updates the syringe inventory information in accordance with filling of the equipment holding unit 11 of the syringe shelf 10 with the syringe 501 and taking out of the syringe 501 from the equipment holding unit 11.

### [Specific Configuration of Drug Container Shelf]

As illustrated in FIG. 10 and indicated by reference numeral 1025 of FIG. 11, the drug container shelf 20 includes a plurality of equipment holding units 21, an equipment conveyance unit 22, object detection units 23, and a drug container detection unit 24. In addition, as indicated by reference numeral 1025 of FIG. 11, the drug container shelf 20 includes a first reading unit 25 (reading unit) and a roller driving unit 26. Although the equipment holding unit 21 is also attached to an attachment portion 221 of the equipment conveyance unit 22 illustrated in FIG. 10, illustration thereof is omitted.

Prior to drug-mixing processing, the drug container shelf 20 is filled with the drug containers 502 by the user. The drug container 502 is provided with the rubber stopper 5021 (see FIG. 5) that closes an opening and a lid that covers the rubber stopper 5021. The drug container 502 is supplied to the drug container shelf 20 with the lid removed. In addition, similarly to the syringe shelf 10, a plurality of holes 172 are formed in a plate-like member 171 that defines each drug container shelf 20.

The equipment holding units 21 are members capable of holding the drug container 502. In one or more embodiments, one drug container 502 is held in one equipment holding unit 21, but a plurality of drug containers 502 may be held in one equipment holding unit 21.

In one or more embodiments, as illustrated in FIG. 11, the equipment holding unit 21 includes free rollers 211, equipment clamping units 212, a drive roller 213, and a first magnet gear 214.

The equipment clamping units 212 clamp the drug container 502. In one or more embodiments, the equipment clamping units 212 clamp the neck portion of the drug container 502. The equipment clamping units 212 are provided at such a height that the drug container 502 does not touch the plate-like member 171 when the drug container 502 is held by the equipment holding unit 21.

A pair of equipment clamping units 212 are biased in a direction toward each other so as to be able to clamp the drug container 502. In one or more embodiments, the equipment clamping units 212 are separated from each other to a degree smaller than a width of the neck portion of the drug container 502 under a state in which the neck portion is not clamped. When the neck portion is inserted between the equipment clamping units 212, the equipment clamping units 212 move so as to fit the shape of the neck portion. As a result, the equipment clamping units 212 can clamp the drug container 502.

At a tip portion of each of the equipment clamping units 212, the free roller 211 which has a rotation axis extending in the up-down direction and is rotatable on the XY plane is provided. As indicated by reference numeral 1026 of FIG. 11, the free rollers 211 hold the drug container 502 by supporting the neck portion of the drug container 502 at three points, together with the drive roller 213 provided on a side on which the equipment clamping units 212 are axially supported and at a position facing a central portion of the free rollers 211. When the drive roller 213 rotates under a state in which the drug container 502 is held, the drug container 502 also rotates. With this rotation, the free rollers 211 also rotate.

The first magnet gear 214 is provided above the drive roller 213. The drive roller 213 and the first magnet gear 214 are connected to a common rotation axis extending in the up-down direction, and are rotatable on the XY plane. The drive roller 213 also rotates when the first magnet gear 214 rotates in conjunction with the rotation of a second magnet gear 261 included in the roller driving unit 26.

The equipment conveyance unit 22 is a member that conveys at least one of the plurality of equipment holding units 21 to a work area Ar2. In one or more embodiments, the equipment conveyance unit 22 is an endless rotating member to which the plurality of equipment holding units 21 are connected. Accordingly, in one or more embodiments, the equipment conveyance unit 22 conveys the equipment holding units 21 one by one to the work area Ar2. However, the equipment conveyance unit 22 may be a conveyance unit that conveys the plurality of equipment holding units 21 to the work area Ar2 at once.

Similarly to the work area Ar1, the work area Ar2 is an area in which the user causes at least one of the plurality of equipment holding units 21 to hold the drug container 502. The work area Ar2 is also an area in which the user removes the drug container 502 held by at least one of the plurality of equipment holding units 21. In addition, similarly to the work area Ar1, the work area Ar2 may be an area that functions only as an area for holding the drug container 502, or an area that functions only as an area for removing the drug container 502.

In one or more embodiments, the equipment conveyance unit 22 has the same function as that of the equipment conveyance unit 12. Specifically, the equipment conveyance unit 22 conveys another equipment holding unit 21 in place of the equipment holding unit 21 located in the work area Ar2, triggered by such detection of a user's action that the object detection units 23 no longer detect an object (e.g., a user's hand) after detecting the object. In addition to the detection of the user's action, the equipment conveyance unit 12 may convey another equipment holding unit 21 to the work area Ar2, triggered by the drug container detection unit 24 detecting the drug container 502 held by the equipment holding unit 21, or by the drug container detection unit 24 being unable to detect the drug container 502 held by the equipment holding unit 21. The equipment conveyance unit 12 changes the equipment holding unit 21 located in the work area Ar2 by rotating, for example, counterclockwise.

Similarly to the syringe conveyance controller 141, the drug container conveyance controller 142 may convey another equipment holding unit 21 in place of the equipment holding unit 21 located in the work area Ar2, triggered by, for example, a conveyance instruction from the user.

Each of the object detection units 23 is a member that detects an object inserted into the work area Ar2. In one or more embodiments, the object detection units 23 detect a user's hand or arm in a state of being inserted into the work area Ar2. The drug container detection unit 24 detects the drug container 502 held by the equipment holding unit 21 located in the work area Ar2.

The first reading unit 25 is a member that reads drug identification information indicating the type of the drug housed in the drug container 502, which is shown on a surface of the drug container 502, in a part of a conveyance path on which the equipment conveyance unit 22 conveys the plurality of equipment holding units 21. Specifically, the drug container 502 is provided with a barcode in which the drug identification information is recorded, and the first reading unit 25 in one or more embodiments is a barcode reader. As indicated by reference numeral 1025 of FIG. 11, the first reading unit 25 is arranged at a position at which the first reading unit 25 can read a barcode from the drug container 502 conveyed to a take-out position PO11. The take-out position PO11 is a position at which the first conveyance unit 110 takes out the drug container 502.

The roller driving unit 26 is a motor that rotates the second magnet gear 261 attached to the roller driving unit 26 in order to rotate the drive roller 213 of the equipment holding unit 21. A rotation axis of the roller driving unit 26 extends in the Y-axis direction, and the second magnet gear 261 is attached to the rotation axis. When the drug container conveyance controller 142 drives the roller driving unit 26, the second magnet gear 261 also rotates. The first magnet gear 214 rotates in conjunction with the rotation of the second magnet gear 261. The drug container 502 which abuts against the drive roller 213 rotates when the drive roller 213 connected to a common rotation axis with the first magnet gear 214 rotates in conjunction with the rotation of the first magnet gear 214. When the drug container 502 rotates in this manner, the first reading unit 25 can read the barcode regardless of the position on the surface of the drug container 502 at which the barcode is attached. [Conveyance Processing for Equipment Holding Unit]

The drug container conveyance controller 142 controls the equipment conveyance unit 22 to sequentially convey the equipment holding units 21 holding the drug container 502 to be taken out to the take-out position PO11.

The storage unit 200 stores drug inventory information in which, for example, information for identifying each equipment holding unit 21, information indicating the type of the drug housed in the drug container 502 held by each equipment holding unit 21, and information indicating a conveyance position of each equipment holding unit 21 are associated. Then, the controller 140 appropriately updates the drug inventory information in accordance with filling of the equipment holding unit 21 of the drug container shelf 20 with the drug container 502 and taking out of the drug container 502 from the equipment holding unit 21. For example, after one or a plurality of equipment holding units 21 of the drug container shelf 20 are filled with the drug containers 502, the controller 140 conveys each of the drug containers 502 to the take-out position PO11 at any timing, reads the type of the drug housed in the drug container 502 from the barcode of the drug container 502 by the first reading unit 25, and stores the read type of the drug in the drug inventory information. As a result, the controller 140 can determine the position of each of the drug containers 502 in which various types of drugs are housed in the drug container shelf 20 based on the drug inventory information.

Then, the drug container conveyance controller 142 refers to the drug inventory information stored in the storage unit 200 to specify a drug container 502 to be taken out which is required for drug-mixing processing based on preparation data, and controls the equipment conveyance unit 22 based on a conveyance position of the drug container 502 to convey the drug container 502 to the take-out position PO11. For example, the drug container conveyance controller 142 causes the drug container 502 to be conveyed to the take-out position PO11 by moving the equipment holding unit 21 corresponding to the drug container 502 to be taken out to the take-out position PO11. Specifically, when receiving issuance of preparation data after the first

conveyance unit 110 has taken out the drug container 502 from the equipment holding unit 21, the drug container conveyance controller 142 conveys the equipment holding unit 21 holding the drug container 502 to be used in the next drug-mixing processing to the take-out position PO11. However, the drug container conveyance controller 142 may convey, after the first conveyance unit 110 has taken out the drug container 502, the equipment holding unit 21 holding the drug container 502 housing the same type of drug as that of the taken-out drug container 502 to the take-out position PO11, even without receiving issuance of preparation data.

For example, the drug container conveyance controller 142 refers to the drug inventory information stored in the storage unit 200 to determine whether there is an equipment holding unit 21 holding the drug container 502 housing the same type of drug as that of the drug container 502 to be taken out by the first conveyance unit 110. When the drug container conveyance controller 142 determines that there is an equipment holding unit 21 holding the drug container 502, the drug container conveyance controller 142 conveys the equipment holding unit 21 to the take-out position PO11 regardless of whether issuance of preparation data has been received.

As a result, when receiving issuance of preparation data, the first conveyance controller 143 can take out the drug container 502 from the take-out position PO11 without waiting for the conveyance of the drug container 502 to the take-out position PO11. Accordingly, the controller 140 can quickly start drug-mixing processing based on preparation data to be sent to the drug-mixing apparatus 1 in the future, and hence the total time required for the drug-mixing processing can be shortened. The drug-mixing apparatus 1 may execute such processing when the drug-mixing apparatus 1 allows consecutive drug-mixing processing using the same type of drug by reusing a syringe 501 in order to save the number of syringes 501 used.

### [Collection Processing for Drug Container]

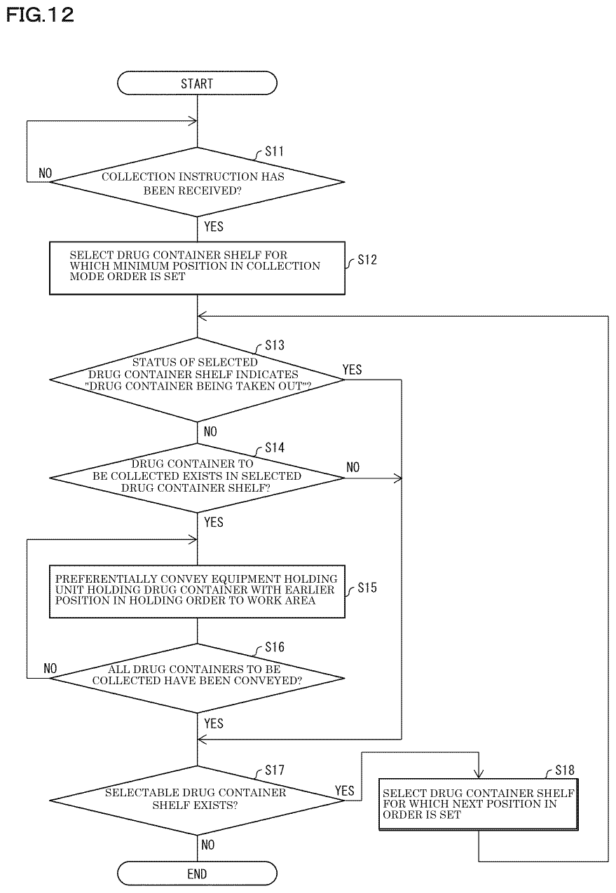

FIG. 12 is a flowchart for illustrating an example of a flow of processing of the controller 140 performed when the controller 140 receives an instruction to collect the drug container 502. The collection processing described below may be executed in order to collect other equipment such as the syringe 501 or the infusion container 503.

Triggered by the instruction to collect the drug container 502, the equipment conveyance unit 22 may convey the equipment holding unit 21 holding the drug container 502 designated as a collection target to the work area Ar2. As a result, the user can easily collect the drug container 502 stored in the drug container shelf 20.

In one or more embodiments, it is assumed for description that a position in the order for entering a collection mode for collecting the drug container 502 held by the equipment holding unit 21 is preset for each of the plurality of drug container shelves 20. Information indicating the position in the order is stored in the storage unit 200 in association with each drug container shelf 20. Information on which drug container 502 is designated as a collection target is also stored in the storage unit 200.

The controller 140 designates a drug container 502 as a collection target when, for example, the first reading unit 25 has failed to read drug identification information from the drug container 502. In this case, when receiving the collection instruction, the equipment conveyance unit 22 conveys the equipment holding unit 21 holding the drug container 502 from which the drug identification information has failed to be read to the work area Ar2. The drug-mixing apparatus 1 cannot use a drug housed in the drug container 502 from which the drug identification information has failed to be read, in drug-mixing processing. Accordingly, with the conveyance of the drug container 502 based on the above-mentioned designation, the user can collect the drug container 502 that cannot be used in the drug-mixing processing.

The controller 140 also designates the drug container 502 specified by the user through, for example, the touch panel 80 as a collection target. In this case, when receiving the collection instruction, the equipment conveyance unit 22 conveys the equipment holding unit 21 holding the drug container 502 specified by the user to the work area Ar2. Therefore, the user can collect the drug container 502 specified by the user. The collection instruction may include information on the drug container 502 designated as the collection target by the user.

As illustrated in FIG. 12, the drug container conveyance controller 142 determines whether the collection instruction has been received through, for example, the touch panel 80 (Step S11). The drug container conveyance controller 142 waits for reception of the collection instruction until the collection instruction is received (NO in Step S11).

When determining that the collection instruction has been received (YES in Step S11), the drug container conveyance controller 142 refers to the storage unit 200 to select a drug container shelf 20 for which the minimum position in the collection mode order is set (Step S12). The drug container conveyance controller 142 determines whether a status of the selected drug container shelf 20 indicates that the first conveyance unit 110 (take-out unit) is taking out the drug container 502 (the drug container 502 being taken out) (Step S13).

The status is managed for each drug container shelf 20 in the storage unit 200. When the drug container 502 held in a drug container shelf 20 becomes a take-out target, the controller 140 sets the status of the drug container shelf 20 to “drug container 502 being taken out.” Meanwhile, when determining that the first conveyance unit 110 has taken out the drug container 502 from a drug container shelf 20, the controller 140 sets the status of the drug container shelf 20 to “drug container 502 not being taken out.” The controller 140 sets the status of the drug container shelf 20 to “drug container 502 not being taken out” when determining, for example, that the first conveyance unit 110 has held the drug container 502 and moved a certain distance from the drug container shelf 20.

When determining that the status of the drug container shelf 20 does not indicate “drug container 502 being taken out” (NO in Step S13), the drug container conveyance controller 142 sets the selected drug container shelf 20 to a collection mode. Then, the drug container conveyance controller 142 refers to the storage unit 200 to determine whether there is a drug container 502 to be collected in the selected drug container shelf 20 (Step S14).

When determining that there is a drug container 502 to be collected in the selected drug container shelf 20 (YES in Step S14), the drug container conveyance controller 142 controls the equipment conveyance unit 22 to convey the drug container 502 to be collected from the drug container shelf 20 to the work area Ar2. At this time, the drug container conveyance controller 142 determines whether each of the plurality of equipment holding units 21 holds the drug container 502 to be collected. When determining that the drug container 502 to be collected is held, the drug container conveyance controller 142 controls the equipment conveyance unit 22 to preferentially convey an equipment holding unit 21 holding a drug container 502 with an earlier position in the order of holding the drug containers 502 in the equipment holding unit 21 to the work area Ar2 (Step S15). Information indicating the position in the order of holding the drug containers 502 is stored in the storage unit 200 in association with the position of the equipment holding unit 21.

A drug container 502 with an earlier position in the holding order is more likely to reach its expiration date sooner. Therefore, when a drug container 502 with an earlier position in the holding order is preferentially conveyed to the work area Ar2, the user can preferentially collect a drug container 502 that is more likely to have an earlier expiration date.

For example, a case in which the user specifies the number of drug containers 502 to be collected in the collection instruction and the drug container shelf 20 stores more than that number of drug containers 502 housing the drug is considered. In this case, the controller 140 preferentially designates, as drug containers 502 to be collected, as many drug containers 502 as the number specified by the user, starting from a drug container 502 with an earlier position in the holding order (earlier position in the order of being supplied to the drug container shelf 20). Then, in Step S15, the drug container conveyance controller 142 controls the equipment conveyance unit 22 to convey the specified number of drug containers 502 to the work area Ar2. As a result, the user can preferentially collect the desired number of drug containers 502, starting from the drug container 502 with the earlier position in the holding order.

The drug containers 502 for which the user specifies the number thereof to be collected may be drug containers 502 housing the same type of drug. When the selected drug container shelf 20 does not have drug containers 502 that satisfy the specified number, the drug container conveyance controller 142 may take out the remaining drug containers 502 from another drug container shelf 20. When the number is not specified, the drug container conveyance controller 142 may cause all of the drug containers 502 to be collected to be conveyed to the work area Ar2 in any order, regardless of the earliness of the position in the holding order. Further, as another embodiment, the drug container conveyance controller 142 may be configured to be able to collect from a drug container 502 with a later position in the holding order by preferentially conveying the drug container 502 with the later position in the holding order to the work area Ar2. The drug container conveyance controller 142 may receive a selection operation through the touch panel 80 as to whether to collect from a drug container 502 with a later position in the holding order or a drug container 502 with an earlier position in the holding order, and execute control for collecting from the drug container 502 with the later or earlier position in the holding order in accordance with the selection operation.

The drug container conveyance controller 142 determines whether the equipment conveyance unit 22 has conveyed all of the drug containers 502 to be collected to the work area Ar2 in the selected drug container shelf 20 (Step S16). When determining that the conveyance of all of the drug containers 502 to be collected is not completed (NO in Step S16), the drug container conveyance controller 142 executes the processing step of Step S15. In Step S15 and Step S16, when a drug container 502 conveyed to the work area Ar2 can no longer be detected by the drug container detection unit 24, the drug container conveyance controller 142 determines that the collection of the drug container 502 is completed, and repeatedly executes processing of conveying the next drug container 502 to be collected to the work area Ar2. As a result, the user can collect all of the drug containers 502 to be collected. In contrast, when determining that the conveyance of all of the drug containers 502 to be collected is completed (YES in Step S16), the drug container conveyance controller 142 determines whether there is another drug container shelf 20 that can be selected (Step S17). When the position in the collection mode order set for the drug container shelf 20 selected in Step S12 is not the last position, the drug container conveyance controller 142 determines that there is another drug container shelf 20 that can be selected.

When determining that there is another drug container shelf 20 that can be selected (YES in Step S17), the drug container conveyance controller 142 selects a drug container shelf 20 for which the position in the order next to the position in the order set for the drug container shelf 20 selected in Step S12 is set (Step S18), and executes the processing step of Step S13. In contrast, when determining that there is no other drug container shelf 20 that can be selected (NO in Step S17), the drug container conveyance controller 142 ends the processing flow of FIG. 12, assuming that the collection operation for the drug containers 502 for all of the drug container shelves 20 is completed.

In this manner, triggered by the collection instruction, the drug container conveyance controller 142 conveys the equipment holding unit 21 holding the drug container 502 designated as the collection target to the work area Ar2, in the drug container shelf 20 for which the position in the order for entering the collection mode is set to a freely-set position in the order. After the conveyance of the equipment holding unit 21 is completed, the drug container conveyance controller 142 starts the conveyance to the work area Ar2 of the equipment holding unit 21 holding the drug container 502 designated as the collection target, in the drug container shelf 20 for which the position in the order next to the freely-set position in the order is set. As a result, the collection operation for the drug containers 502 can be executed for each drug container shelf 20, and hence the user can efficiently collect the drug containers 502.

When determining that the status of the selected drug container shelf 20 indicates “drug container 502 being taken out” (YES in Step S13), the drug container conveyance controller 142 executes the processing step of Step S17. Therefore, when it becomes the turn for the drug container shelf 20 from which the drug container 502 is being taken out to be set to the collection mode, the drug container conveyance controller 142 does not set the drug container shelf 20 to the collection mode, and sets a drug container shelf 20 for which the position in the order next to the relevant position in the order is set to the collection mode. Accordingly, the user can collect a drug container 502 from the drug container shelf 20 for which the next position in the order is set, without waiting for the take-out of the drug container 502 by the first conveyance unit 110. For the drug container shelf 20 that has not been set to the collection mode, the drug container conveyance controller 142 assigns, as the position in the order for entering the collection mode, the position in the order next to the drug container shelf 20 that has been set to the collection mode instead, or the last position in the order.

The drug container conveyance controller 142 also executes the processing step of Step S17 when determining that there is no drug container 502 to be collected in the selected drug container shelf 20 (NO in Step S14).

Incidentally, after changing the operation mode of the drug-mixing apparatus 1 to the collection mode based on the collection instruction from the user, the drug container conveyance controller 142 may also require a user operation when ending the collection mode before the collection operation is executed for all of the drug containers 502 designated as collection targets. Meanwhile, after changing the operation mode of the drug-mixing apparatus 1 to the collection mode based on the collection instruction from the user, the drug container conveyance controller 142 may end the collection mode when the drug container side door 27 of the drug container shelf 20 in which the drug container 502 to be collected is housed is closed after being opened. As a result, the trouble of an operation for ending the collection mode can be omitted. Specifically, after changing the operation mode of the drug-mixing apparatus 1 to the collection mode based on the collection instruction from the user, the drug container conveyance controller 142 may end the collection mode when the drug container side door 27 of the drug container shelf 20 in which the drug container 502 to be collected is housed is closed after being opened, and collection is completed for all of the drug containers 502 designated as collection targets.

### [Configuration of Infusion Shelf]

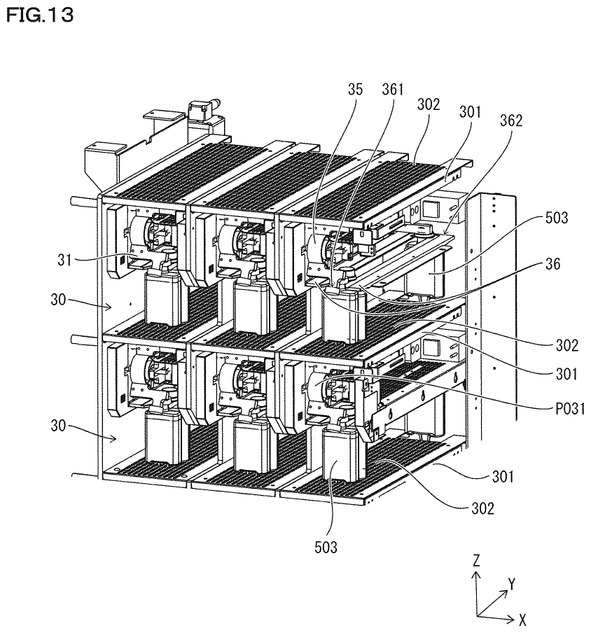

FIG. 13 is a perspective view for illustrating an example of a configuration of the infusion shelf 30. As illustrated in FIG. 13, the infusion shelf 30 includes a pushing-in unit 31, a pushing-in conveyance unit 35, and the rail portions 36 (hanging holding unit). As illustrated in FIG. 3, the infusion shelf 30 also includes a shutter 37.

Prior to drug-mixing processing, the infusion shelf 30 is filled with the infusion containers 503 by the user. In addition, similarly to the syringe shelf 10 and the drug container shelf 20, a plurality of holes 302 are formed in a plate-like member 301 that defines each infusion shelf 30.

The rail portions 36 are members provided inside the infusion shelf 30 and extending from the infusion side door 34 (see FIG. 1) side toward the deep direction of the drug-mixing apparatus 1 (that is, the ±Y-axis direction). In the rail portions 36, an end portion located on the infusion side door 34 side may be referred to as “door-side end portion 361,” and an end portion located on the deep side of the drug-mixing apparatus 1 may be referred to as “deep-side end portion 362.” The infusion containers 503 are supplied to the rail portions 36 from the door-side end portion 361, and are taken out by the second conveyance unit 120 from the deep-side end portion 362. At least one infusion container 503 can be hung on the rail portions 36. In one or more embodiments, the neck portion of the infusion container 503 can be hung between a pair of rail portions 36. Specifically, a flange 5034, which is a part of a neck portion 5033 of the infusion container 503, can be hung between the pair of rail portions 36.

In FIG. 13, for convenience of illustration, each infusion shelf 30 is provided with three pairs of rail portions 36 corresponding to three lanes. However, the number of pairs of rail portions 36 provided in each infusion shelf 30 is not limited to three. Specifically, as illustrated in FIG. 2, in the drug-mixing apparatus 1 in one or more embodiments, the infusion containers 503 are held in an array of five lanes in the left-right direction in the upper infusion shelf 30, and the infusion containers 503 are held in an array of four lanes in the left-right direction in the lower infusion shelf 30. Accordingly, the upper infusion shelf 30 is provided with pairs of rail portions 36 corresponding to five lanes in the left-right direction, and the lower infusion shelf 30 is provided with pairs of rail portions 36 corresponding to four lanes in the left-right direction. In one or more embodiments, each of the pairs of rail portions 36 is filled with the same type of the infusion container 503 (infusion container in which the type of infusion housed in the infusion container 503 and the size of the infusion container 503 are the same). The infusion container 503 to be supplied is determined for each infusion shelf 30. However, different types of infusion containers 503 may be supplied to the respective pairs of rail portions 36.

The pushing-in unit 31 is a member that is movable along the rail portions 36 and pushes in the infusion container 503 hung on the rail portions 36 from the door-side end portion 361 to the deep-side end portion 362. In one or more embodiments, the pushing-in unit 31 is connected to the pushing-in conveyance unit 35. The pushing-in conveyance unit 35 is provided along the rail portions 36. The pushing-in conveyance unit 35 can move the pushing-in unit 31 along the rail portions 36 by operating under the control of the pushing-in controller 147. The pushing-in conveyance unit 35 may be, for example, an endless rotating member. A size of the pushing-in unit 31 and a positional relationship between the rail portions 36 and the pushing-in conveyance unit 35 are defined so that the infusion container 503 hung on the rail portions 36 can be pushed in by the movement of the pushing-in unit 31.

When the infusion side door 34 is in an unlocked state or an open state, the pushing-in unit 31 is located at a position PO31 on the door-side end portion 361 side which does not interfere with the supply of the infusion container 503 (hanging on the rail portions 36). The pushing-in controller 147 may move the pushing-in unit 31 to the position PO31 by controlling the pushing-in conveyance unit 35 when, for example, an operation unit corresponding to the upper infusion shelf 30 is pressed (when the infusion side door 34 is unlocked).

Triggered by the infusion side door 34 becoming locked, the pushing-in unit 31 pushes in the infusion container 503 hung on the rail portions 36 from the door-side end portion 361 to the deep-side end portion 362. In one or more embodiments, when the infusion side door 34 becomes locked after being in a closed state, the pushing-in controller 147 controls the pushing-in conveyance unit 35 to move the pushing-in unit 31 from the position PO31 to the deep-side end portion 362. At the deep-side end portion 362 of a wall portion that forms the infusion shelf 30, a detection unit (not shown) that detects the infusion container 503 existing at the deep-side end portion 362 is provided. The pushing-in controller 147 moves the pushing-in unit 31 toward the deep-side end portion 362 side until the detection unit detects the infusion container 503.

A case in which, under a state in which a plurality of infusion containers 503 are hung on the rail portions 36, the second conveyance unit 120 has taken out an infusion container 503 located at the deep-side end portion 362 is considered. After the second conveyance unit 120 has taken out the infusion container 503, the pushing-in unit 31 pushes in the remaining infusion containers 503 hung on the rail portions 36 from the door-side end portion 361 to the deep-side end portion 362. In one or more embodiments, when the second conveyance unit 120 has taken out the infusion container 503 located at the deep-side end portion 362, the pushing-in controller 147 controls the pushing-in conveyance unit 35 to further move the pushing-in unit 31 to the deep-side end portion 362.

The shutter 37 prevents movement of the infusion container 503 located at the deep-side end portion 362 in the deep direction (±Y-axis direction). The shutter 37 is controlled by the controller 140 to be movable in the up-down direction. The shutter 37 is controlled by the controller 140 to be located, for example, on the deep side of the infusion shelf 30 corresponding to the infusion side door 34 when the infusion side door 34 is closed. In addition, when the second conveyance unit 120 takes out an infusion container 503, the shutter 37 moves to an infusion shelf 30 other than the infusion shelf 30 in which the infusion container 503 is stored.

### [Specific Configuration of Pushing-in Unit]

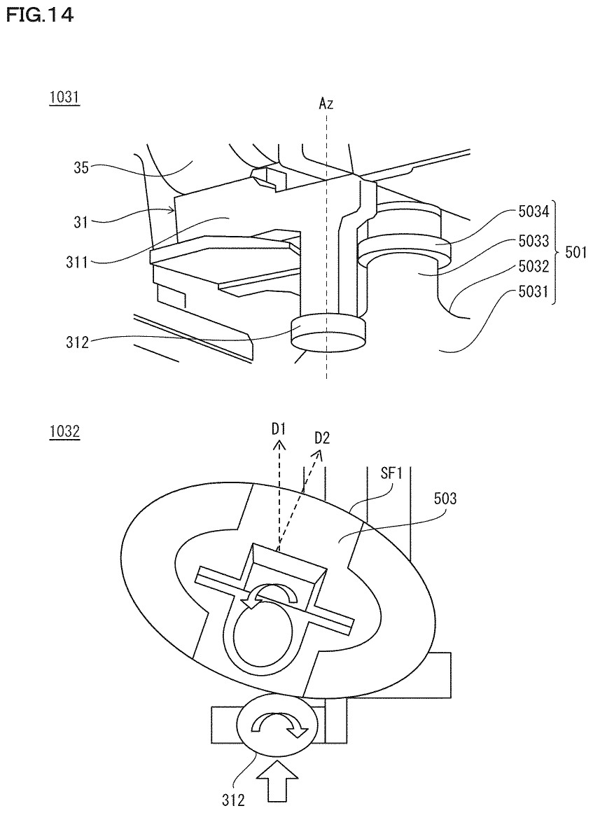

FIG. 14 is a view for illustrating an example of a specific configuration of the pushing-in unit 31, in which reference numeral 1031 is a perspective view of the pushing-in unit 31, and reference numeral 1032 is a view for illustrating a positional relationship between the pushing-in unit 31 and the infusion container 503. Reference numeral 1032 of FIG. 14 is a view seen from the downward direction.

In one or more embodiments, as indicated by reference numeral 1031 of FIG. 14, the pushing-in unit 31 includes a connecting portion 311 connected to the pushing-in conveyance unit 35, and a contact portion 312 attached to the connecting portion 311 to contact the barrel portion 5031 of the infusion container 503. The contact portion 312 is a rotating member rotatable about a rotation axis Az extending in the up-down direction. The contact portion 312 rotates when the contact portion 312 comes into contact with the infusion container 503 due to the movement of the pushing-in unit 31.

As indicated by reference numeral 1032 of FIG. 14, a case in which a deep direction (predetermined direction) D1 of the drug-mixing apparatus 1 and a direction D2 in which the first surface SF1 of the infusion container 503 faces are different is considered. In this case, when the pushing-in unit 31 moves in the deep direction D1 with the contact portion 312 in contact with the infusion container 503, the infusion container 503 rotates in a direction opposite to a rotation direction of the contact portion 312, with an axis line in the up-down direction passing through the neck portion 5033 as a rotation axis, due to the rotation of the contact portion 312. As a result, the infusion container 503 is in a state of being hung on the rail portions 36 with the direction D2 in which the first surface SF1 faces substantially matching the deep direction D1.

Therefore, with the inclusion of the contact portion 312, in conjunction with a pushing-in operation by the pushing-in unit 31, the rail portions 36 can hold the infusion container 503 with the orientation of the infusion container 503 directed in the predetermined direction. Accordingly, it is possible to reduce the possibility of a failure in taking out the infusion container 503 by the second conveyance unit 120 (suctioning of the infusion container 503) and a failure in reading the first information by the third reading unit 122 at the deep-side end portion 362.

The contact portion 312 is not required to have a rotating function. It is only required that the pushing-in unit 31 have a portion that contacts the barrel portion 5031 when pushing in the infusion container 503, and may have, for example, a flat plate shape. Even in this case, the orientation of the infusion container 503 can be changed so that the direction D2 in which the first surface SF1 faces substantially matches the deep direction D1.

Therefore, as long as the pushing-in unit 31 is configured to push in the infusion container 503 by contacting the barrel portion 5031 of the infusion container 503 hung on the rail portions 36, the infusion container 503 can be hung on the rail portions 36 with the orientation of the infusion container 503 directed in the predetermined direction. In order to achieve this effect, it is only required that a position at which the pushing-in unit 31 contacts the infusion container 503 (position for pushing in the infusion container 503) be a portion lower than a portion supported by the rail portions 36, and be, for example, a position lower than a shoulder portion 5032 of the infusion container 503.

[Dropping Prevention Unit]

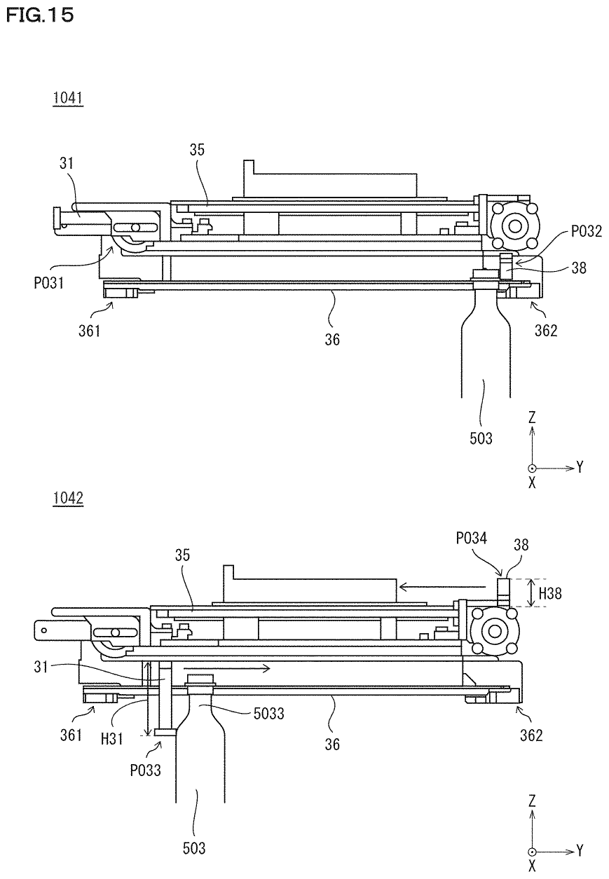

FIG. 15 is a side view for illustrating an example of the pushing-in conveyance unit 35. The pushing-in conveyance unit 35 includes a dropping prevention unit 38 that prevents the infusion container 503 from dropping from the deep-side end portion 362. In one or more embodiments, the pushing-in conveyance unit 35 is an endless rotating member. Accordingly, the pushing-in unit 31 and the dropping prevention unit 38 move in conjunction with each other.

As indicated by reference numeral 1041 of FIG. 15, when the pushing-in unit 31 is located at the position PO31, the dropping prevention unit 38 is located at a position PO32 directly above the rail portions 36 at the deep-side end portion 362. In this state, the user can fill the infusion shelf 30 with the infusion container 503. Therefore, when the dropping prevention unit 38 is located at the position PO32 during the supply of the infusion container 503, dropping of the infusion container 503 from the deep-side end portion 362 can be prevented.

As indicated by reference numeral 1042 of FIG. 15, when the pushing-in unit 31 is located at a position PO33 at which the pushing-in unit 31 can start pushing in the infusion container 503, the dropping prevention unit 38 is located at a position PO34 opposite to the position PO32 across the pushing-in conveyance unit 35 at the deep-side end portion 362. Accordingly, when the pushing-in unit 31 moves in the front-rear direction (±Y-axis direction) along the rail portions 36, the dropping prevention unit 38 moves in a space above the pushing-in conveyance unit 35.

It is only required that the dropping prevention unit 38 have a size that allows the dropping prevention unit 38 to contact the infusion container 503 hung on the rail portions 36 when located on the rail portion 36 side. In one or more embodiments, the dropping prevention unit 38 has such a size that, when located on the rail portion 36 side, the dropping prevention unit 38 does not contact the rail portions 36 but contacts a part of the neck portion 5033 of the infusion container 503 hung on the rail portions 36 (head portion of the infusion container 503).

As described above, a dimension H38 of the dropping prevention unit 38 in the up-down direction is shorter than a dimension H31 of the pushing-in unit 31 in the up-down direction. As a result, even when the dropping prevention unit 38 is provided, a space above the pushing-in conveyance unit 35 in which the dropping prevention unit 38 moves can be designed to be relatively small.

The storage unit 200 stores a dimension between the first surface SF1 and the second surface SF2 per infusion container 503. In addition, the controller 140 can acquire a position of the pushing-in unit 31 in a movement range from the position PO31 to the position PO32 by a publicly-known technology. Therefore, the controller 140 can calculate the number of infusion containers 503 hung on the rail portions 36 based on the dimension and the position. As a result, the controller 140 can manage the number of infusion containers 503 held by each pair of rail portions 36 in the infusion shelf 30 as infusion inventory information.

### [Specific Configuration of Printing/Inspection Unit]

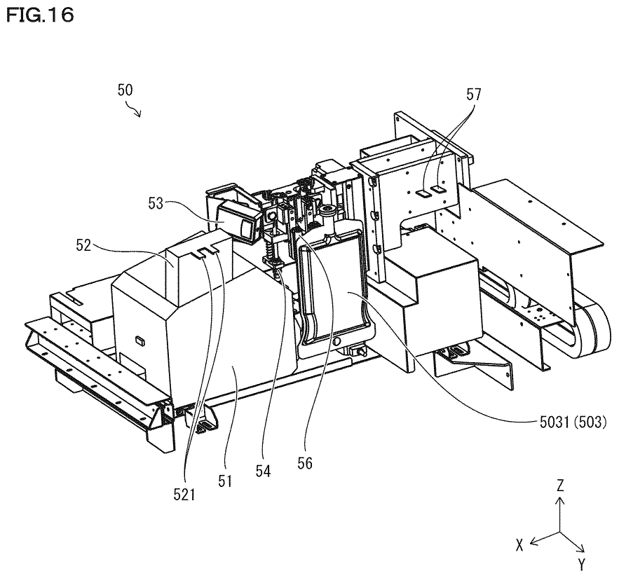

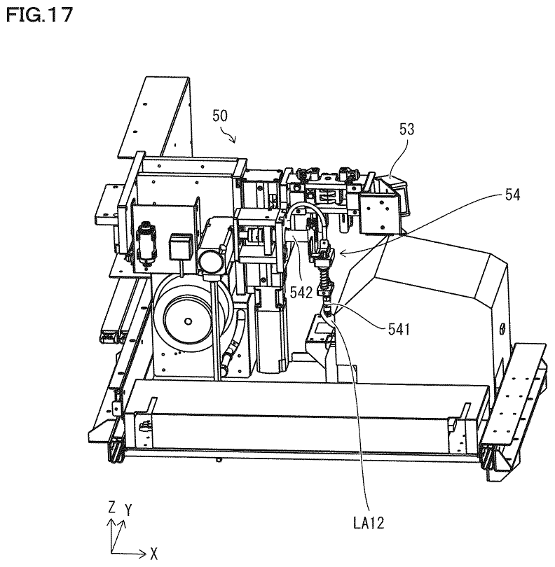

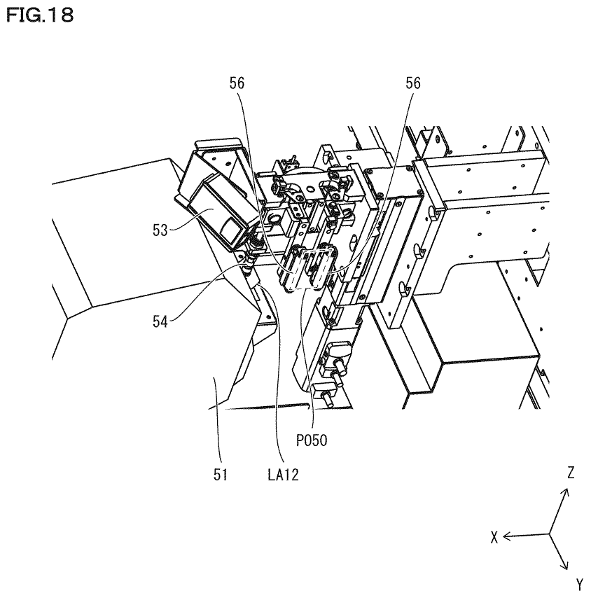

FIG. 16 is a perspective view for illustrating an example of an overall configuration of the printing/inspection unit 50. FIG. 17 is a perspective view of the printing/inspection unit 50 when viewed from the rear. FIG. 18 is a perspective view for illustrating an example of an internal configuration of the printing/inspection unit 50. In FIG. 17 and FIG. 18, illustration of a weighing unit 52 is omitted. In addition, FIG. 16 shows an example of a state in which the infusion container 503 is located at the printing/inspection unit 50 by suction of the second conveyance unit 120.

As illustrated in FIG. 16 to FIG. 18, the printing/inspection unit 50 includes a printing unit 51, the weighing unit 52, a second reading unit 53, an attaching unit 54, and a guide unit 56.

The printing unit 51 is a member, such as a label printer, that dispenses the second label LA12 on which the second information different from the first information, which is infusion type information, is printed. For example, the second information includes information indicating the type of the drug to be injected into the infusion container 503. The type of the drug indicated by the second information is a drug indicated in preparation data, and is a drug housed in the drug container 502 conveyed from the drug container shelf 20 to the drug-mixing unit 40 by the first conveyance unit 110 in accordance with the preparation data. The second information also includes identification information such as an order number and an Rp number corresponding to the preparation data. Further, on the second label LA12, code information such as a one-dimensional code or a two-dimensional code in which the second information is encoded is also printed. When the second label LA12 is printed by a third recording unit 206, a second recorder 704, or a second recorder 804, for example, which is described later, similar second information is also printed on the second label LA. The printing unit 51 may also dispense an unsuitability information label on which unsuitability information is printed.

The printing/inspection unit controller 148 performs an inspection on the infusion container 503 after drug injection. The inspection in one or more embodiments includes determining whether an injection amount of a drug into the infusion container 503 corresponds to a prescribed amount indicated in the preparation data, or whether a withdrawal amount of an infusion from the infusion container 503 corresponds to a withdrawal amount indicated in the preparation data.

In addition, the printing/inspection unit controller 148 determines whether an appropriate second label LA12 is attached to the infusion container 503 after drug injection, based on a reading result obtained by the second reading unit 53. The printing/inspection unit controller 148 determines whether a drug indicated by the second information read from the second label LA12 by the second reading unit 53 is a drug injected into the infusion container 503 from which the second information has been read (whether the drug is a drug indicated in the preparation data as a drug to be injected into the infusion container 503).

When an inspection result is determined to be suitable by the printing/inspection unit controller 148, the second conveyance unit 120 dispenses the infusion container 503 to which the second label LA12 is attached to the infusion receiving shelf 60. In contrast, when the inspection result is determined to be unsuitable by the printing/inspection unit controller 148, the printing unit 51 dispenses an unsuitability information label. The unsuitability information may be information indicating that a weight measured by the weighing unit 52 is unsuitable, and/or information indicating that a reading result obtained by the second reading unit 53 is not a drug indicated in the preparation data. The second conveyance unit 120 dispenses the infusion container 503 to which the unsuitability information label is attached in addition to the second label LA12, to the infusion receiving shelf 60. The unsuitability information may be an example of the second information different from the first information.

The second information may also include information such as an administration time included in the preparation data. For example, when the information on the administration time included in the preparation data is “XX o'clock,” the second information may include a message such as “Please administer by XX o'clock.” In addition, when the drug indicated in the preparation data is a drug for which early administration after drug-mixing is recommended because there is a fear of a composition change, information to that effect may be included in the second information. For example, the second information may include a message such as “Please administer as soon as possible after the drug-mixing.”

Further, when occurrence of liquid leakage in the infusion container 503 after execution of the drug-mixing processing is detected, information to that effect may be included in the second information. For example, when occurrence of liquid leakage is detected, the second information may include a message recommending cleaning of the infusion container 503, such as “Please clean the mouth of the infusion container.” It is conceivable that the printing/inspection unit controller 148 detects the occurrence of liquid leakage in the infusion container 503 by image analysis of a captured image of the infusion container 503 after the drug-mixing processing, which is captured by a capturing device (not shown) provided in the drug-mixing apparatus 1. In addition, the printing/inspection unit controller 148 may detect the occurrence of liquid leakage in the infusion container 503 through use of an optical sensor (not shown) that detects the occurrence of liquid leakage in the infusion container 503 after the drug-mixing processing.

Further, when the drug-mixing processing is interrupted for some reason, information indicating up to which step has been executed in the drug-mixing processing may be included in the second information. In addition, when a patient whose patient identification information such as a patient name and a patient ID is similar exists in a group which is a unit of a plurality of pieces of preparation data transmitted from the host system 2 to the drug-mixing apparatus 1 in data output processing described later, information to that effect may be included in the second information. For example, the second information may include a message such as “There is a patient with a similar name, so please be careful not to make a mistake.”

The weighing unit 52 weighs the infusion container 503 before and after drug injection. In one or more embodiments, as illustrated in FIG. 16, the weighing unit 52 includes first locking portions 521 that lock the neck portion of the infusion container 503. The weighing unit 52 can weigh the infusion container 503 when the second conveyance unit 120 locks the neck portion of the infusion container 503 with the first locking portions 521. The weighing unit 52 is, for example, a load cell. A pair of first locking portions 521 are biased in a direction toward each other by a spring (not shown) so as to be able to clamp the neck portion of the infusion container 503. A distance at which the pair of first locking portions 521 are closest to each other is defined as a distance at which the neck portion of the thinnest infusion container 503 can be locked.

When a drug housed in the drug container 502 is a liquid, the weighing unit 52 weighs the infusion container 503 before drug injection and the infusion container 503 after drug injection.

In this case, first, the second conveyance unit 120 takes out an infusion container 503 from the infusion shelf 30 and conveys the infusion container 503 to the weighing unit 52. After the weighing unit 52 weighs the infusion container 503 (after a first weighing), the second conveyance unit 120 conveys the infusion container 503 to the drug-mixing unit 40. After drug-mixing processing by the drug-mixing unit 40, the second conveyance unit 120 conveys the infusion container 503 to the weighing unit 52. After the weighing unit 52 weighs the infusion container 503 (after a second weighing), the infusion container 503 is conveyed to an attachment position PO50 (see FIG. 18) at which the second label LA12 is attached, or the second label LA12 and the unsuitability information label are attached. Then, the printing/inspection unit 50 attaches the second label LA12, or the second label LA12 and the unsuitability information label to the infusion container 503 in accordance with a measurement result obtained by the weighing unit 52. The printing/inspection unit controller 148 inspects whether an injection amount of a drug into the infusion container 503 corresponds to a prescribed amount indicated in the preparation data, based on a difference between measurement results of the first and second weighings.

Through attachment of a label to the infusion container 503 after weighing, the weighing unit 52 can perform both the first weighing and the second weighing under a state in which no label is attached. For example, when the weighing unit 52 performs the second weighing after a label is attached to the infusion container 503, the weight of the infusion container 503 increases by the weight of the label at the time of the second weighing. Accordingly, there is a fear that the printing/inspection unit controller 148 cannot perform an accurate inspection. With two weighings performed under the state in which no label is attached as described above, the printing/inspection unit controller 148 can perform an accurate inspection.

However, when a label that is relatively light in weight and does not significantly affect an inspection result is used, the label may be attached to the infusion container 503 before the second weighing. The printing/inspection unit controller 148 may perform printing on the second label LA12 at any timing. For example, printing may be performed on the second label LA12 before the infusion container 503 is taken out from the infusion shelf 30.

When a drug housed in the drug container 502 is in a solid state, first, the second conveyance unit 120 takes out an infusion container 503 from the infusion shelf 30 and conveys the infusion container 503 to the weighing unit 52. After the weighing unit 52 weighs the infusion container 503 (after a first weighing), the second conveyance unit 120 conveys the infusion container 503 to the drug-mixing unit 40. The drug-mixing unit 40 withdraws a certain amount of the infusion from the infusion container 503 and injects the infusion into the drug container 502 in order to dissolve the solid drug. The second conveyance unit 120 conveys the infusion container 503 from which the certain amount of the infusion has been withdrawn to the weighing unit 52. After the weighing unit 52 weighs the infusion container 503 (after a second weighing), the second conveyance unit 120 conveys the infusion container 503 to the drug-mixing unit 40.

After the drug-mixing unit 40 injects the drug that has become liquid into the infusion container 503, the second conveyance unit 120 conveys the infusion container 503 to the weighing unit 52. After the weighing unit 52 weighs the infusion container 503 (after a third weighing), the infusion container 503 is conveyed to the attachment position PO50 at which the second label LA12 is attached, or the second label LA12 and the unsuitability information label are attached. Then, the printing/inspection unit 50 attaches the second label LA12, or the second label LA12 and the unsuitability information label to the infusion container 503 in accordance with a measurement result obtained by the weighing unit 52.

Through attachment of a label to the infusion container 503 after the weighing, the weighing unit 52 can perform the first to third weighings under a state in which no label is attached. Accordingly, similarly to the case in which the drug is a liquid, the printing/inspection unit controller 148 can perform an accurate inspection.

The printing/inspection unit controller 148 inspects whether a withdrawal amount of an infusion from the infusion container 503 corresponds to a withdrawal amount indicated in the preparation data, based on a difference between the first weighing and the second weighing. In addition, the printing/inspection unit controller 148 inspects whether an injection amount of a drug into the infusion container 503 (injection amount of the drug that has become liquid) corresponds to a prescribed amount indicated in the preparation data, based on a difference between the second weighing and the third weighing.

Now, a specific example of an inspection method based on a weighing result of the weighing unit 52 obtained by the printing/inspection unit controller 148 is described. It is assumed here that preparation data indicates that a prescribed amount of a drug is 0.5 g and a withdrawal amount of an infusion is 10 ml, and an injection amount of the drug into an infusion container 503 is 5 ml. It is also assumed that a drug housed in a drug container 502 to be used is 1.0 g and a specific gravity of the infusion is 1.1. In this case, when drug-mixing processing is accurately executed based on the preparation data, 10 ml of the infusion is aspirated from the infusion container 503, the 10 ml of the infusion is injected into the drug container 502, and then only 5 ml of a mixed liquid in which the drug and the infusion are mixed is aspirated from the drug container 502 and injected into the infusion container 503. Although a permissible error is taken into consideration in an actual inspection, the permissible error is ignored in the description for convenience of description.

First, the printing/inspection unit controller 148 executes first inspection processing of determining whether a difference between the first weighing and the second weighing matches a weight corresponding to a withdrawal amount of the infusion container 503 indicated in the preparation data. At this time, in this specific example, the specific gravity of the infusion is 1.1 and not 1.0, and hence the printing/inspection unit controller 148 specifies that a weight of the infusion to be withdrawn from the infusion container 503 is 11.0 g, which is calculated by multiplying 10 ml, which is the amount of the infusion withdrawn from the infusion container 503, by the specific gravity of 1.1. Then, the printing/inspection unit controller 148 determines whether the specified weight of the infusion, which is 11.0 g, matches the difference between the first weighing and the second weighing. When the specific gravity of the infusion is 1.0, the printing/inspection unit controller 148 specifies that the weight of the infusion to be withdrawn from the infusion container 503 is 10.0 g, which is calculated by multiplying 10 ml, which is the amount of the infusion, by the specific gravity of 1.0, and determines whether the specified weight of 10.0 g matches the difference between the first weighing and the second weighing. That is, the printing/inspection unit controller 148 determines that a result of the first inspection processing is suitable when the difference between the first weighing and the second weighing matches the weight of the infusion withdrawn from the infusion container 503.

Next, the printing/inspection unit controller 148 executes second inspection processing of determining whether a difference between the second weighing and the third weighing matches a weight corresponding to an injection amount of a drug (drug that has become liquid) from the drug container 502 to the infusion container 503. At this time, in this specific example, the specific gravity of the infusion is 1.1 and not 1.0, and hence the printing/inspection unit controller 148 specifies that a weight of a mixed liquid of the drug to be injected into the infusion container 503 is 6.0 g, which is obtained by adding 5.5 g, which is calculated by multiplying 5 ml, which is the amount of the infusion withdrawn from the infusion container 503, by the specific gravity of 1.1, and 0.5 g, which is the weight of the drug. Then, the printing/inspection unit controller 148 determines whether the specified weight of the mixed liquid of the drug, which is 6.0 g, matches the difference between the second weighing and the third weighing. When the specific gravity of the infusion is 1.0, the printing/inspection unit controller 148 specifies that the weight of the mixed liquid of the drug to be injected into the infusion container 503 is 5.5 g, which is the weight of the mixed liquid of the drug calculated as a sum of a weight of the infusion of 5.0 g and a weight of the drug of 0.5 g, and determines whether the specified weight of 5.5 g matches the difference between the second weighing and the third weighing. That is, the printing/inspection unit controller 148 determines that a result of the second inspection processing is suitable when the difference between the second weighing and the third weighing matches the weight of the drug injected into the infusion container 503.

Then, the printing/inspection unit controller 148 determines that an inspection result of the drug-mixing processing based on the preparation data is suitable when both the first inspection processing and the second inspection processing are suitable.

In one or more embodiments, a second locking portion 57 is provided at a position opposite to the weighing unit 52 with the guide unit 56 interposed therebetween. The second locking portion 57 functions as a buffer that temporarily holds an infusion container 503 taken out from the infusion shelf 30 by the second conveyance unit 120. While an infusion container 503 after weighing (referred to as “first infusion container”) is being conveyed to the drug-mixing unit 40, an infusion container 503 to be used in the next drug-mixing processing (referred to as “second infusion container”) is taken out from the infusion shelf 30, and the second infusion container is weighed by the weighing unit 52. After that, the second infusion container is locked by the second locking portion 57. After drug injection into the first infusion container is completed and the weighing unit 52 weighs the first infusion container, the second infusion container is conveyed from the second locking portion 57 to the drug-mixing unit 40. As a result, the drug-mixing apparatus 1 can efficiently execute the drug-mixing processing.

The second reading unit 53 reads the second label LA12 attached to the infusion container 503 after drug injection. The second reading unit 53 is, for example, a barcode reader.

The attaching unit 54 attaches the second label LA12 to the infusion container 503 after drug injection. The attaching unit 54 may attach the second label LA12 to the infusion container 503 after drug injection, for example, before the printing/inspection unit controller 148 outputs an inspection result (preferably, after the final weighing of the infusion container 503 and before the output of the inspection result). After that, when the inspection result obtained by the printing/inspection unit controller 148 is unsuitable, the attaching unit 54 attaches an unsuitability information label to the infusion container 503 after drug injection.

In one or more embodiments, the attaching unit 54 includes a suction mechanism 541 and a moving mechanism 542, as illustrated in FIG. 17. The attaching unit 54 can hold the second label LA12 or the unsuitability information label when the suction mechanism 541 suctions the second label LA12 and the unsuitability information label dispensed by the printing unit 51. The moving mechanism 542 moves the suction mechanism 541 between a position at which the second label LA12 or the unsuitability information label dispensed from the printing unit 51 is suctioned, and the attachment position PO50 at which the second label LA12 or the unsuitability information label is attached to the infusion container 503 after drug injection.

In addition, the guide unit 56 illustrated in FIG. 18 guides movement of the second label LA12 or the unsuitability information label to the infusion container 503 after drug injection when the attaching unit 54 attaches the second label LA12 or the unsuitability information label to the infusion container 503 after drug injection.

In a state in which the suction mechanism 541 has moved the second label LA12 or the unsuitability information label to the attachment position PO50, the second conveyance unit 120 presses the infusion container 503 after drug injection against the guide unit 56 at the attachment position PO50. In this state, the suction mechanism 541 releases the suction of the second label LA12 or the unsuitability information label. As a result, the second label LA12 or the unsuitability information label is attached to the infusion container 503 after drug injection. Therefore, in one or more embodiments, the second conveyance unit 120, the attaching unit 54, and the guide unit 56 function as an attachment unit that attaches the second information to the surface of the infusion container 503.

Through attachment of the second label LA12 to the infusion container 503, information indicating the type of the drug to be injected into the infusion container 503 can be displayed on the infusion container 503 into which the drug is injected, as the second information different from the first information originally attached to the surface of the infusion container 503. Accordingly, the drug-mixing apparatus 1 and the user can determine at least what type of drug has been injected into the infusion container 503.

The second conveyance unit 120, the attaching unit 54, and the guide unit 56 may attach the second label LA12 to the infusion container 503 before drug injection. In this case, the drug-mixing apparatus 1 and the user can determine at least what type of drug is to be injected into the infusion container 503. The second conveyance unit 120, the attaching unit 54, and the guide unit 56 may attach the second label LA12, for example, before the first weighing. In this case, the weighing unit 52 can perform the first to third weighings with the second label LA12 attached to the infusion container 503, and hence the weight of the label does not affect the inspection by the printing/inspection unit controller 148.

After the second label LA12 is attached to the infusion container 503, the second conveyance unit 120 does not deliver the infusion container 503 to the infusion receiving shelf 60 until the printing/inspection unit controller 148 outputs an inspection result. When an inspection result obtained by the printing/inspection unit controller 148 is suitable (after an inspection result of “suitable” is output), the second conveyance unit 120 delivers the infusion container 503 to the infusion receiving shelf 60. In contrast, when the inspection result obtained by the printing/inspection unit controller 148 is unsuitable (after an inspection result of “unsuitable” is output), an unsuitability information label is attached to the infusion container 503. After that, the second conveyance unit 120 delivers the infusion container 503 to which the unsuitability information label is attached to the infusion receiving shelf 60.

### Example of Operation from Reading of First Information to Attachment of Second Label

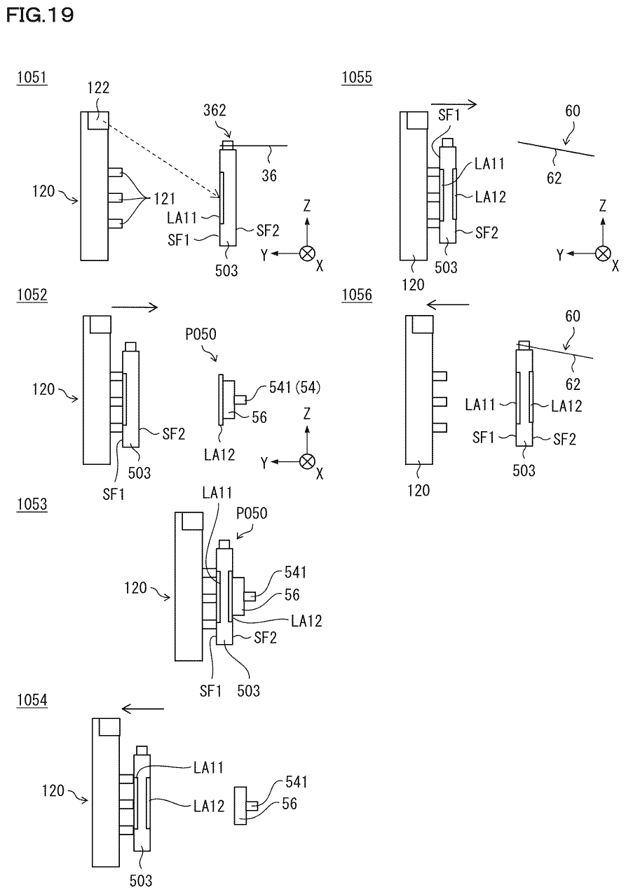

FIG. 19 is a view for illustrating an example of an operation from reading of the first information to delivery of the infusion container 503 after drug injection to the infusion receiving shelf 60. Reference numerals 1051 to 1054 of FIG. 19 are explanatory views for illustrating an example of an operation from reading of the first information to attachment of the second label LA12.

As indicated by reference numeral 1051 of FIG. 19, when the second conveyance unit 120 takes out the infusion container 503 hung on the rail portions 36 at the deep-side end portion 362, the third reading unit 122 reads the first information from the first label LA11. In one or more embodiments, when the third reading unit 122 has successfully read the first information, the third reading unit 122 recognizes that the first surface SF1 of the infusion container 503, to which the first label LA11 is attached, faces the deep direction (±Y-axis direction) (predetermined direction).

When the first information has successfully been read by the third reading unit 122, injection of a drug into the infusion container 503 is executed in the drug-mixing unit 40, assuming that the first surface SF1 faces the deep direction. When a drug housed in the drug container 502 is in a solid state, withdrawal of the drug from the infusion container 503 is executed in the drug-mixing unit 40 when the first information has successfully been read by the third reading unit 122.

After a drug is injected into the infusion container 503 in the drug-mixing unit 40, the second conveyance unit 120 conveys the infusion container 503 after drug injection to the weighing unit 52. After the weighing unit 52 weighs the infusion container 503, as indicated by reference numeral 1052 of FIG. 19, the second conveyance unit 120 conveys the infusion container 503 to a position facing the guide unit 56 (attachment position PO50). By the time the infusion container 503 is conveyed to this position, the printing unit 51 has dispensed the second label LA12, and the suction mechanism 541 has conveyed the second label LA12 to the attachment position PO50. However, the second label LA12 may be conveyed to the attachment position PO50 after the infusion container 503 is conveyed to the above-mentioned position.

As indicated by reference numeral 1052 of FIG. 19, in a state in which the second label LA12 is located at the attachment position PO50, the second conveyance unit 120 moves in a direction of the attachment position PO50 (−Y-axis direction). Then, as indicated by reference numeral 1053 of FIG. 19, at the attachment position PO50, the second conveyance unit 120 is pressed against the guide unit 56, and the suction mechanism 541 releases suction. In this manner, the second conveyance unit 120, the printing unit 51, and the guide unit 56 attach the second label LA12 to the second surface SF2 of the infusion container 503, which is on the opposite side to the first surface SF1.

After that, as indicated by reference numeral 1054 of FIG. 19, the second conveyance unit 120 moves to a position before the attachment of the second label LA12, to thereby bring the infusion container 503 into a state in which the infusion container 503 can be conveyed to the infusion receiving shelf 60. Operations after the infusion container 503 to which the second label LA12 has been attached to the infusion receiving shelf 60 is conveyed, as indicated by reference numerals 1055 and 1056 of FIG. 19, are described later.

In the state of reference numeral 1051 of FIG. 19, when the third reading unit 122 has failed to read the first information, the controller 140 may determine that a storage state of the infusion container 503 is not a state in which the second label LA12 can be attached. In this case, the touch panel controller 149 may provide a notification of information indicating that the first information cannot be read from the infusion container 503, or information indicating a place to store the infusion container 503. In addition, the third reading unit 122 may continue operation of the drug-mixing apparatus 1 by performing reading of first information from an infusion container 503 stored in another place.

In addition, it is not always required for the third reading unit 122 to recognize whether the first surface SF1 faces the predetermined direction based on a reading result of the first information (light receiving result of the light receiving unit 1222). A member different from the third reading unit 122 may be provided in the drug-mixing apparatus 1 as a recognition unit that recognizes whether the first surface SF1 faces the predetermined direction. In addition, the recognition unit may be any member that can recognize the orientation of the first surface SF1, and is not necessarily required to be achieved by an optical member.

### [Effects of Operation Example Described Above]

As described above, the attachment unit attaches the second label LA12 to a position on the surface of the infusion container 503 that does not overlap with the first information. As a result, even when the second information different from the first information originally attached to the surface of the infusion container 503 is attached to the surface of the infusion container 503, the drug-mixing apparatus 1 can prevent the first information from overlapping with the second information. Accordingly, the drug-mixing apparatus 1 may avoid the occurrence of a reading failure of the first information due to the attachment of the second information. In addition, even when the second information is attached to the surface of the infusion container 503, the user can also read the first information.

The attachment unit can attach the second information to the surface of the infusion container 503 so as not to overlap with the first information, by attaching the second label LA12 to a surface different from the first surface SF1 of the infusion container 503 to which the first information is attached. As described above, in one or more embodiments, the attachment unit attaches the second label LA12 to the second surface SF2 on the opposite side of the first surface SF1, and hence the attachment unit can attach the second information to the surface of the infusion container 503 so as not to overlap with the first information even more.

The attachment unit attaches the second label LA12 to a surface different from the first surface SF1 (e.g., the second surface SF2) based on a recognition result of the orientation of the first surface SF1 obtained by the recognition unit. Accordingly, the second information can be attached to the surface of the infusion container 503 so as not to overlap with the first information. Specifically, when the recognition unit recognizes that the first surface SF1 faces a predetermined direction (e.g., the deep direction), the attachment unit attaches the second label LA12 to a surface facing a direction other than the predetermined direction (e.g., the second surface SF2). As a result, the drug-mixing apparatus 1 can attach the second information to the second surface without changing the orientation of the infusion container 503.

In one or more embodiments, the third reading unit 122 executes reading of the first information attached to the first surface SF1 from a position facing the deep-side end portion 362. Then, when the third reading unit 122 has successfully read the first information, the printing/inspection unit 50 located below the infusion shelf 30 attaches the second label LA12 to the second surface SF2. Therefore, as indicated by reference numerals 1051 to 1053 of FIG. 19, the second conveyance unit 120 can attach the second label LA12 to the second surface SF2 facing a direction other than the predetermined direction, without changing the orientation of the infusion container 503.

In addition, the attachment unit attaches the second label LA12 to the surface of the infusion container 503 after the third reading unit 122 reads the first information. As a result, the drug-mixing apparatus 1 can read the first information from the infusion container 503 before attaching the second information different from the first information originally attached to the surface of the infusion container 503 to the surface of the infusion container 503. Accordingly, the drug-mixing apparatus 1 can avoid the occurrence of a reading failure of the first information due to the attachment of the second information. The first information may be directly attached to the surface of the infusion container 503.

### [Specific Configuration of Infusion Receiving Shelf]

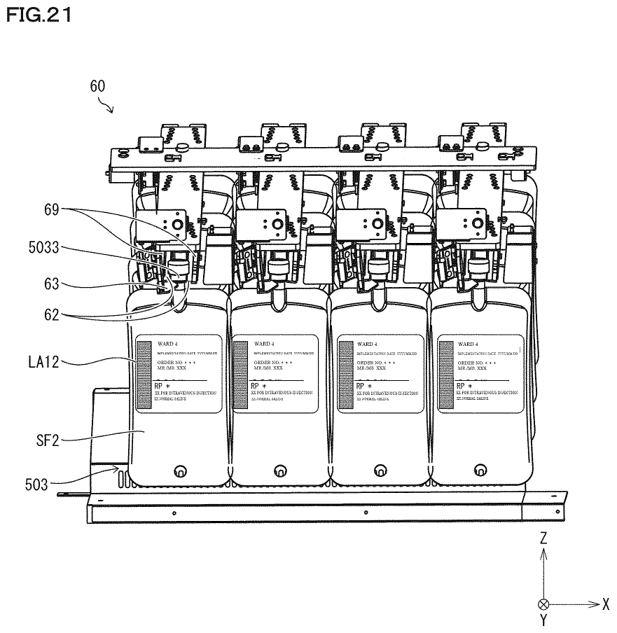

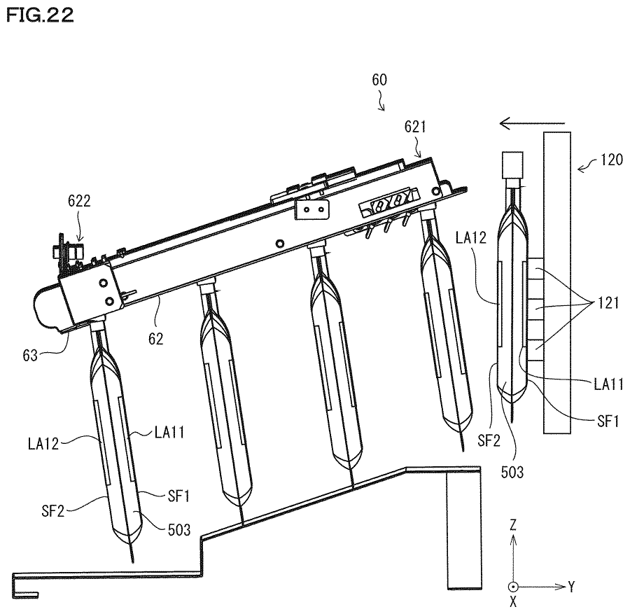

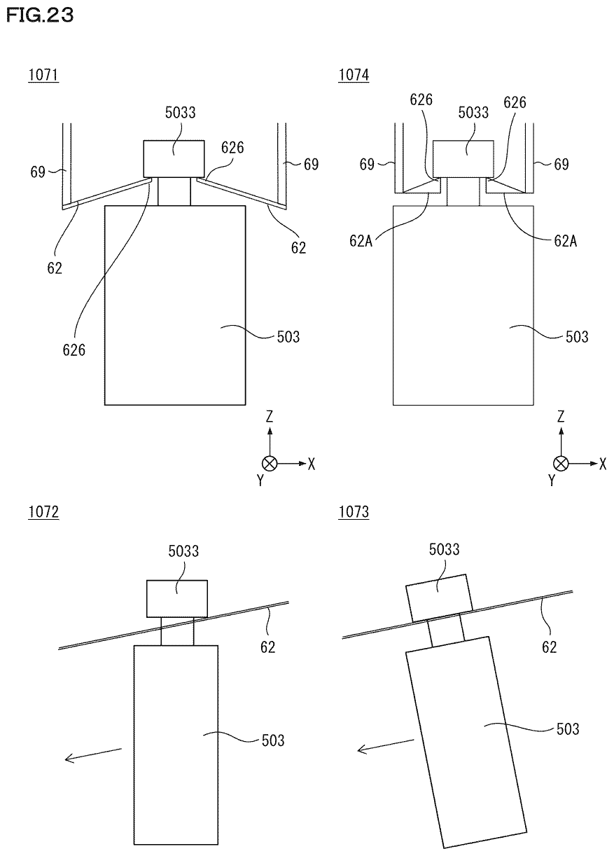

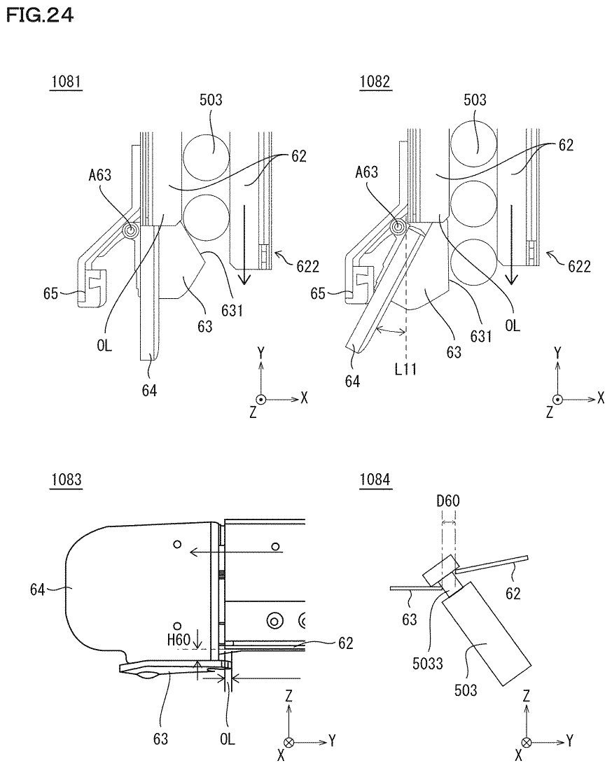

FIG. 21 is a front view for illustrating an example of the infusion receiving shelf 60. FIG. 22 is a side view for illustrating an example of the infusion receiving shelf 60. FIG. 23 is a view for illustrating an example of a shape of rail portions 62. FIG. 24 is an explanatory view for illustrating a shutter 63.

As illustrated in FIG. 21, the infusion receiving shelf 60 includes a pair of rail portions 62 capable of hanging and holding the infusion container 503 into which a drug has been injected by the drug-mixing unit 40. The rail portions 62 hang and hold a part of the neck portion 5033 of the infusion container 503 (head portion of the infusion container 503). The rail portions 62 correspond to an example of a hanging holding unit capable of hanging and holding the infusion container 503. The infusion receiving shelf 60 may be provided with one or a plurality of pairs of rail portions 62, and in one or more embodiments, four pairs of rail portions 62 are provided.

The infusion receiving shelf 60 includes the rail portions 62, and hence the infusion receiving shelf 60 can hang and hold the infusion container 503 after drug injection. Accordingly, even an infusion container 503 that is difficult to stand on its own can be held in an aligned state. The rail portions 62 can hold the infusion containers 503 in an aligned state, and hence the infusion containers 503 can be held so as to be easily taken out by the user. In addition, unlike a case in which a plurality of infusion containers 503 after drug injection are put into a tray (not shown), the rail portions 62 can hold the infusion containers 503 with a good appearance and can reduce the risk of damage to the infusion containers 503 due to collision between the infusion containers 503.

As illustrated in FIG. 22, the rail portions 62 extend in the front-rear direction (±Y-axis direction) of the drug-mixing apparatus 1, and include a first portion 621 to which an infusion container 503 is delivered by the second conveyance unit 120, and a second portion 622 from which an infusion container 503 held by the rail portions 62 is taken out.

The second conveyance unit 120 delivers the infusion container 503 into which the drug has been injected by the drug-mixing unit 40 to the rail portions 62 at the first portion 621. Specifically, the second conveyance unit 120 delivers the infusion container 503 after drug injection, on which the second label LA12 is attached to the second surface SF2 by the printing/inspection unit 50, to the rail portions 62. The second conveyance unit 120 sequentially delivers the infusion containers 503 after drug injection to the rail portions 62, and thus the rail portions 62 hold a plurality of infusion containers 503 in a line.

The second conveyance unit 120 delivers the infusion container 503 to the rail portions 62 with the second surface SF2 of the infusion container 503, to which the second label LA12 is attached, facing a direction viewed from the first portion 621 to the second portion 622 (−Y-axis direction).

Specifically, as indicated by reference numerals 1052 to 1054 of FIG. 19, the second conveyance unit 120 causes the second label LA12 to be attached to the second surface SF2, which is on the opposite side to the first surface SF1, under a state in which the first surface SF1 of the infusion container 503, to which the first label LA11 is attached, is suctioned. After that, the second conveyance unit 120 moves the infusion container 503 to a position facing the infusion receiving shelf 60 under a state in which the first surface SF1 is suctioned, without changing the orientation of the infusion container 503. After that, as indicated by reference numeral 1055 of FIG. 19 and FIG. 22, the second conveyance unit 120 moves to the infusion receiving shelf 60 side (forward direction of the drug-mixing apparatus 1; −Y-axis direction). As a result, as indicated by reference numeral 1056 of FIG. 19, the second conveyance unit 120 delivers the infusion container 503 to the rail portions 62 such that the second surface SF2 to which the second label LA12 is attached faces the forward direction of the drug-mixing apparatus 1.

When the infusion container 503 is delivered to the rail portions 62 in this manner, as illustrated in FIG. 21 and FIG. 22, the infusion container 503 can be held in the infusion receiving shelf 60 such that the second label LA12 faces the forward direction. Then, the user can easily recognize information shown on the second label LA12 (information related to the infusion container 503 after drug injection) when, for example, the infusion container 503 is taken out from the infusion receiving shelf 60.

As illustrated in FIG. 22, the rail portions 62 are provided in the infusion receiving shelf 60 so as to be inclined such that a position of the second portion 622 is lower than a position of the first portion 621 when viewed from the left-right direction (±X-axis direction) of the drug-mixing apparatus 1. As a result, the rail portions 62 can cause the infusion container 503 held at the first portion 621 to move from the first portion 621 side to the second portion 622 side by its own weight. That is, by being provided so as to be inclined as described above, the rail portions 62 function as a moving unit that moves the held infusion container 503 from the first portion 621 to the second portion 622.

As illustrated in FIG. 21 and indicated by reference numeral 1071 of FIG. 23, the infusion receiving shelf 60 includes a rail holding portion 69 that holds each of the pair of rail portions 62. The pair of rail portions 62 extend inward of the rail holding portions 69 (in a direction in which the pair of rail portions 62 approach each other from the rail holding portions 69). In addition, as indicated by reference numeral 1071 of FIG. 23, the rail portions 62 include support portions 626 that support the neck portion 5033 of the infusion container 503.

In one or more embodiments, a shape of a cross-section of the rail portions 62 perpendicular to an extending direction of the rail portions 62 is a shape that satisfies the following two conditions.—The support portions 626 of the pair of rail portions 62 are close to each other by the distance smaller than a dimension of the neck portion 5033 of the infusion container 503.—The pair of rail portions 62 are inclined downward as a distance from the support portion 626 increases in each of the pair of rail portions 62. That is, the shape of the cross-section of the pair of rail portions 62 is a flared shape centered on the support portions 626.

When the rail portions 62 have the above-mentioned shape, contact between the rail portions 62 and the neck portion 5033 is not a surface contact, but is a point contact in a holding state of the infusion container 503 as indicated by reference numeral 1072 of FIG. 23. In addition, in a holding state of the infusion container 503 as indicated by reference numeral 1073 of FIG. 23, contact between the rail portions 62 and the neck portion 5033 is a line contact. Accordingly, slidability of the infusion container 503 hung on the rail portions 62 is improved.

However, the shape of the cross-section of the pair of rail portions 62 is not limited to the above-mentioned flared shape, and may be any shape as long as the pair of rail portions 62 are in point contact or line contact with the infusion container 503.

For example, as indicated by reference numeral 1074 of FIG. 23, the infusion receiving shelf 60 may include a pair of rail portions 62A instead of the pair of rail portions 62. The pair of rail portions 62A are held by the rail holding portions 69 similarly to the pair of rail portions 62. The pair of rail portions 62A are not plate-like members like the pair of rail portions 62, but are members in which the support portion 626 that supports the infusion container 503 has a protruding shape. When the support portion 626 has a protruding shape, similarly to the rail portions 62, it is possible to make contact with the infusion container 503 not over the entire rail portion 62A but only at a part thereof, and to reduce a contact area with the infusion container 503. Accordingly, even with the rail portions 62A, the above-mentioned point contact or line contact with the infusion container 503 can be achieved, and the slidability of the infusion container 503 can be improved.

In addition, the pair of rail portions are not required to be plate-like members or members having a protruding shape, and may be linear members that support the infusion container 503 by point contact or line contact. That is, in the pair of rail portions, it is only required that a shape of a portion at which the pair of rail portions contact the infusion container 503 when the infusion container 503 is hung on the pair of rail portions be linear.

As illustrated in FIG. 21 and FIG. 22, the shutter 63 (stopper) that prevents movement of the infusion container 503 held by the rail portions 62 is provided at the second portion 622 of the rail portions 62. The shutter 63 is biased in a closing direction of the shutter 63. The shutter 63 is biased by, for example, a spring (not shown). As a result, the shutter 63 is in a closed state in a normal state, and hence the possibility that the infusion container 503 held by the rail portions 62 drops from the second portion 622 can be reduced. In addition, the user can bring the shutter 63 into an open state in accordance with the number of infusion containers 503 to be taken out.

Reference numeral 1081 of FIG. 24 is a view for illustrating a closed state of the shutter 63, and reference numeral 1082 of FIG. 24 is a view for illustrating an open state of the shutter 63. In reference numerals 1081 and 1082 of FIG. 24 and reference numeral 1083 of FIG. 24 described later, the arrow pointing in the −Y-axis direction is a take-out direction of the infusion container 503 held by the rail portions 62.

As indicated by reference numerals 1081 and 1082 of FIG. 24, in one or more embodiments, the shutter 63 is provided at one end of the pair of rail portions 62 so as to be pivotable about a rotation axis A63 whose axis line is the up-down direction. The shutter 63 opens and closes the second portion 622 by pivoting about the rotation axis A63. Specifically, the support portion 64 that supports the shutter 63 is connected to the rotation axis A63. In addition, an abutting portion 65 against which the support portion 64 abuts extends from an end of the rail portion 62. As indicated by reference numeral 1082 of FIG. 24, the support portion 64 pivots between a reference line L11 and the abutting portion 65. It is only required that the abutting portion 65 be provided at a position at which the infusion container 503 can be taken out when the shutter 63 is most opened.

As indicated by reference numeral 1081 of FIG. 24, in a closed state, the shutter 63 prevents movement of the infusion container 503 held by the rail portions 62 in a take-out direction by abutting against the infusion container 503. From this state, the user grips a leading infusion container 503 and pulls the infusion container 503 in the take-out direction with a force greater than a biasing force of the spring (not shown). With this pulling, the user can take out the infusion container 503 because the infusion container 503 opens the shutter 63 while abutting against the shutter 63. When the infusion container 503 is taken out, the shutter 63 returns to the closed state by the biasing force of the spring. As a result, movement of a subsequent infusion container 503 in the take-out direction is prevented. Therefore, the user can take out the leading infusion container 503 without performing any operation other than pulling the infusion container 503.

When the user wants to take out a plurality of infusion containers 503 (e.g., all of the plurality of infusion containers 503 held by the rail portions 62) at once, the user grips the support portion 64 to pivot the support portion 64 toward the abutting portion 65 to maintain the open state of the shutter 63. When the user has taken out a desired number of infusion containers 503, the user releases the support portion 64, and thus the shutter 63 returns to the closed state by the biasing force of the spring. Therefore, the user can take out a desired number of infusion containers 503 by simply operating the support portion 64. When taking out one infusion container 503, the user may also operate the support portion 64.

As described above, the shutter 63 is biased in the closing direction, and hence the possibility that the infusion container 503 drops from the rail portions 62 is reduced, and the user can take out a desired number of infusion containers 503, whether one or two or more, with a simple operation.

As indicated by reference numeral 1081 of FIG. 24, an abutting surface 631 of the shutter 63 with the infusion container 503 held by the rail portions 62 is inclined with respect to a take-out direction (movement direction) of the infusion container 503 in a closed state of the shutter 63. Specifically, when viewed from above, in the closed state of the shutter 63, the abutting surface 631 is inclined with respect to the take-out direction such that a distance between the shutter 63 and the rail portion 62 on which the shutter 63 is not provided becomes shorter toward the take-out direction.

The abutting surface 631 is inclined with respect to the take-out direction, and hence an operation angle for opening the shutter 63 can be made smaller as compared with a case in which the abutting surface 631 is not inclined (case in which the abutting surface 631 is perpendicular to the extending direction of the rail portions 62 in the closed state of the shutter 63). Accordingly, operability of an opening/closing operation of the shutter 63 can be improved. In addition, the operation angle can be made smaller, and hence the shutter 63 can be brought into the closed state immediately after the infusion container 503 is taken out. Accordingly, the possibility that an infusion container 503 subsequent to the taken-out infusion container 503 is dispensed together with the taken-out infusion container 503 can be reduced.

Reference numeral 1083 of FIG. 24 is a view for illustrating an example of a positional relationship between the rail portion 62 and the shutter 63 in the up-down direction, and reference numeral 1084 of FIG. 24 is a view for illustrating an example of the positional relationship as a comparative example. Reference numeral 1083 of FIG. 24 is a view when the shutter 63 is in an open state.

As indicated by reference numeral 1083 of FIG. 24, in one or more embodiments, the shutter 63 is located below a plane including a lowermost part of the rail portion 62. This means that a distance (height) H60 between the plane and an upper surface of the shutter 63 is greater than 0. Accordingly, as indicated by reference numerals 1081 to 1083 of FIG. 24, the rail portion 62 and the shutter 63 can be made to overlap so that the rail portion 62 and the shutter 63 do not contact (interfere with) each other. Reference symbol OL of reference numerals 1081 to 1083 of FIG. 24 indicates an overlap position between the rail portion 62 and the shutter 63.

As indicated by reference numerals 1082 and 1083 of FIG. 24, even in an open state of the shutter 63, the shutter 63 is located below the rail portion 62, and hence, as indicated by reference numeral 1084 of FIG. 24, a gap D60 is not formed between the rail portion 62 and the shutter 63 even when the shutter 63 opens. As indicated by reference numeral 1084 of FIG. 24, when the gap D60 exists, the neck portion 5033 of the infusion container 503 that has moved along the rail portion 62 in the take-out direction gets caught on the shutter 63. When the positional relationship between the shutter 63 and the rail portion 62 is defined such that a part of the shutter 63 overlaps with the rail portion 62 even in the open state, the possibility that the infusion container 503 gets caught on the shutter 63 can be reduced.

In one or more embodiments, the printing/inspection unit 50 and the infusion receiving shelf 60 are positioned so that the second conveyance unit 120 can store the infusion container 503 to which the second label LA12 is attached in the infusion receiving shelf 60 with the second surface SF2 facing the take-out direction, without changing the orientation of the infusion container 503. However, the printing/inspection unit 50 and the infusion receiving shelf 60 are not always required to be positioned in this manner. In this case, for example, the second conveyance unit 120 may change the orientation of the held infusion container 503 so that the infusion container 503 is stored in the infusion receiving shelf 60 with the second surface SF2 facing the take-out direction.

In one or more embodiments, the pair of rail portions 62 are fixed to the infusion receiving shelf 60, but may be detachable from the infusion receiving shelf 60. In this case, the user can remove the pair of rail portions 62 from the infusion receiving shelf 60 under a state in which the infusion container 503 is held, and take the pair of rail portions 62 out of a housing of the drug-mixing apparatus 1. Accordingly, the infusion container 503 can be removed from the rail portions 62 outside the housing of the drug-mixing apparatus 1.

### [Configuration of Drug-mixing System 100]

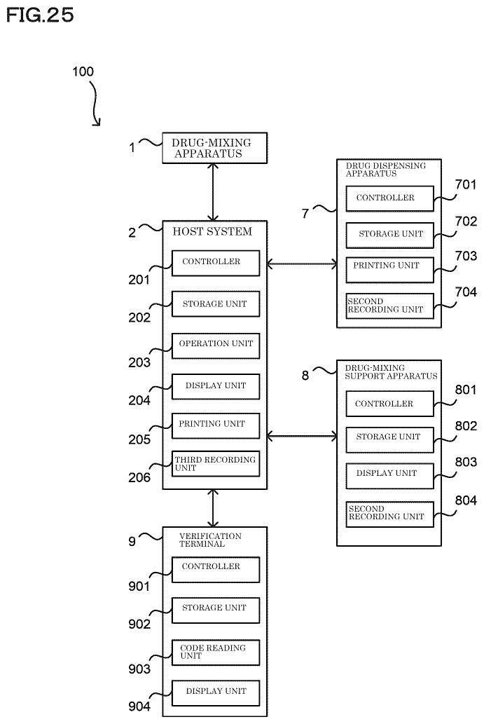

The above-mentioned drug-mixing apparatus 1 is used, for example, in a drug-mixing system 100 illustrated in FIG. 25. FIG. 25 is a block diagram for illustrating an example of an overall configuration of the drug-mixing system 100 according to one or more embodiments. As illustrated in FIG. 25, the drug-mixing system 100 includes the drug-mixing apparatus 1, the host system 2, a drug dispensing apparatus 7, a drug-mixing support apparatus 8, a verification terminal 9, and the like. In the drug-mixing system 100, the host system 2 is communicably connected to the drug-mixing apparatus 1, the drug dispensing apparatus 7, the drug-mixing support apparatus 8, and the verification terminal 9 wirelessly or by wire. The drug-mixing apparatus 1, the drug dispensing apparatus 7, the drug-mixing support apparatus 8, and the verification terminal 9 may be allowed to communicate with each other. Further, the drug-mixing system 100 may be provided with a plurality of components as any one or more of the drug-mixing apparatus 1, the drug dispensing apparatus 7, the drug-mixing support apparatus 8, and the verification terminal 9. In addition, an entity that executes various types of processing in the drug-mixing system 100 described below is merely an example, and the entity that executes the various types of processing in the drug-mixing system 100 can be changed.

### [Configuration of Host System 2]

As illustrated in FIG. 25, the host system 2 is a computer including a controller 201, a storage unit 202, an operation unit 203, a display unit 204, a printing unit 205, the third recording unit 206, and the like.

The controller 201 includes a processor that executes various types of programs, a memory, and the like. The storage unit 202 is storage means such as a hard disk drive that stores various types of programs for causing the controller 201 to execute various types of processing. The storage unit 202 also stores prescription data, preparation data, and the like. The operation unit 203 is operation means such as a keyboard or a mouse for receiving an instruction including user operations. The display unit 204 is output means such as a liquid crystal display or an organic EL display for presenting information to the user. The printing unit 205 is a printer or the like that prints various types of information on a sheet based on the preparation data, and is used by being connected to the host system 2. The third recording unit 206 is a label printer or the like that prints various types of information on a recording medium such as a label, and is used by being connected to the host system 2. The third recording unit 206 may be one that records various types of information on another type of recording medium such as an IC tag in addition to a recording medium like a label.

In addition, for preparation data assigned to the drug-mixing apparatus 1, the controller 201 transmits, to the drug-mixing apparatus 1, an instruction to execute the drug-mixing processing and an instruction to execute recording processing of recording the second information on the second label LA12. Here, for the preparation data assigned to the drug-mixing apparatus 1, the controller 201 does not cause the second information to be recorded on the second label LA12 by the second recorder 704, the second recorder 804, or the like provided separately from the drug-mixing apparatus 1. That is, when transmitting the instruction to execute the drug-mixing processing to the drug-mixing apparatus 1, the controller 201 does not transmit an instruction to execute the recording processing for the preparation data corresponding to the drug-mixing processing to the drug dispensing apparatus 7 or the drug-mixing support apparatus 8, which is another apparatus. Meanwhile, for preparation data for which the drug-mixing processing in the drug-mixing apparatus 1 has been canceled after being assigned to the drug-mixing apparatus 1, the controller 201 causes the second information to be recorded on the second label LA12 by the second recorder 704 or the second recorder 804. For example, the recording processing is executed by the second recorder 704 or the second recorder 804 when the controller 201 transmits the instruction to execute the recording processing to the drug dispensing apparatus 7 or the drug-mixing support apparatus 8. As a result, even when the drug-mixing processing based on the preparation data in the drug-mixing apparatus 1 is canceled and the second label LA12 is no longer printed by the drug-mixing apparatus 1, the user can obtain the second label LA12 corresponding to the preparation data. When the drug-mixing processing based on the preparation data in the drug-mixing apparatus 1 is canceled, the controller 201 may automatically execute processing of changing an entity that executes the recording processing for the second label LA12 from the printing/inspection unit 50 of the drug-mixing apparatus 1 to another recording unit such as the second recorder 704 or the second recorder 804, but may also execute the processing when a confirmation operation is performed by the user.

As another embodiment, it is also conceivable that the controller 201 causes the second information to be printed on the second label LA12 by the third recording unit 206 only for preparation data for which the drug-mixing processing in the drug-mixing apparatus 1 has been canceled. That is, the third recording unit 206 may be used only at the time of printing the second label LA12 corresponding to preparation data for which the drug-mixing processing in the drug-mixing apparatus 1 has been canceled. As a result, the user can easily grasp that the drug-mixing processing based on the preparation data in the drug-mixing apparatus 1 has been canceled, by the fact that the second label LA12 has been printed from the third recording unit 206. [Configuration of Drug Dispensing Apparatus 7]

The drug dispensing apparatus 7 includes a plurality of housing units corresponding to a plurality of types of drugs used as injection drugs, and is capable of dispensing a drug container from the housing units in a state of being placed on a conveyance tray TR based on preparation data to be processed. The drug container is an ampule, a vial, an injection kit, a PTP sheet, or the like in which a drug is housed. The conveyance tray TR is also used for placing an infusion container after a drug has been mixed by drug-mixing processing based on preparation data and conveying the infusion container to a ward or a place of drug administration. An example of the drug dispensing apparatus 7 is disclosed in, for example, Japanese Patent Application Laid-open No. 2015-013177 or WO 2019/093413 A1, and hence a detailed description of the drug dispensing apparatus 7 is omitted here and only an outline thereof is described.

As illustrated in FIG. 25, the drug dispensing apparatus 7 includes a controller 701, a storage unit 702, a printing unit 703, the second recorder 704, and the like. The controller 701 includes a processor that executes various types of programs, a memory, and the like. The storage unit 702 is storage means such as a hard disk drive that stores various types of programs for causing the controller 701 to execute various types of processing, and also stores association information described later and the like. The printing unit 703 is a printer that prints various types of information such as the type and number of drugs and infusions indicated in the preparation data on a sheet and outputs the sheet as an injection prescription sheet (example of a printed sheet). The second recorder 704 is a label printer or the like that prints various types of information on the second label LA12 to be attached to an infusion container. When another type of recording medium such as an IC tag is attached to the infusion container in addition to a recording medium like a label, the second recorder 704 may record various types of information on the another type of recording medium.

In addition, in the drug dispensing apparatus 7, the injection prescription sheet printed by the printing unit 703 and the second label LA12 printed by the second recorder 704 are dispensed in a state of being placed on a conveyance tray TR1 together with a drug container. Specifically, in the drug dispensing apparatus 7, the conveyance tray TR1 is conveyed by conveyance means such as a belt conveyor to a discharge port for the second label LA12 printed by the second recorder 704, a discharge port for the injection prescription sheet printed by the printing unit 703, and a discharge port for the drug container dispensed from the drug dispensing apparatus 7 in the stated order, and thus the second label LA12, the injection prescription sheet, and the drug container are placed on the conveyance tray TR1 in the stated order. The drug dispensing apparatus 7 may also be configured to be able to dispense an infusion container in which an infusion is housed, and the infusion container is placed on the conveyance tray TR1 in the same manner as that for the drug container.

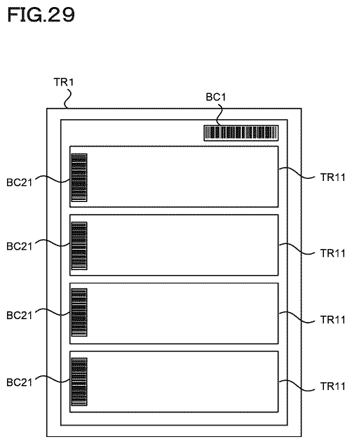

In particular, as illustrated in FIG. 29, a plurality of divided regions TR11 may be provided on the conveyance tray TR1, and the drug container, the second label LA12, and the injection prescription sheet corresponding to one piece of preparation data may be placed in one divided region TR11 (see, for example, Japanese Patent Application Laid-open No. 2015-013177). As a result, on one conveyance tray TR1 dispensed from the drug dispensing apparatus 7, drug containers, second labels LA12, and injection prescription sheets corresponding to a plurality of pieces of preparation data are placed in corresponding divided regions TR11 for the respective pieces of preparation data. Accordingly, for example, drug containers, second labels LA12, and injection prescription sheets corresponding to a plurality of pieces of preparation data for a plurality of patients may be placed in one conveyance tray TR1. The plurality of pieces of preparation data assigned to one conveyance tray TR1 are preset by the host system 2. For example, in the host system 2, a plurality of pieces of preparation data having the same preset group such as the same hospital room or ward are assigned to the divided regions TR11 of one conveyance tray TR1. As a result, the user can collectively convey the conveyance tray TR1 on which drug containers and the like for patients in the same group such as a hospital room or ward are placed, to that hospital room or ward.

When the drug dispensing apparatus 7 does not have a function of dispensing an infusion container, the user is to prepare the infusion container manually. In addition, for a type of drug that is not mounted in the drug dispensing apparatus 7, the user is to prepare the drug container manually. Further, the user may manually perform drug-mixing processing of injecting a drug housed in a drug container housed in the conveyance tray TR1 into an infusion container.

### [Configuration of Drug-mixing Support Apparatus 8]

The drug-mixing support apparatus 8 executes various types of processing for supporting drug-mixing processing performed manually by the user such as a pharmacist. Specifically, the drug-mixing support apparatus 8 is a personal computer or the like including a controller 801, a storage unit 802, a display unit 803, the second recorder 804, and the like. The controller 801 includes a processor that executes various types of programs, a memory, and the like. The storage unit 802 is storage means such as a hard disk drive that stores various types of programs for causing the controller 801 to execute various types of processing. The display unit 803 is output means such as a liquid crystal display or an organic EL display for presenting information to the user. The second recorder 804 is a label printer or the like that prints various types of information on the second label LA12 to be attached to a drug container, and is used by being connected to the drug-mixing support apparatus 8. The second recorder 804 may be one that records various types of information on another type of recording medium such as an IC tag in addition to a recording medium like a label.

In addition, the controller 801 sequentially displays, on the display unit 803, information for supporting the user who manually performs drug-mixing processing based on preparation data input from the host system 2 as a processing target. For example, the controller 801 executes drug-mixing support processing of displaying the types of a drug container, an infusion container, and a syringe used in the drug-mixing processing based on the preparation data, and sequentially displaying one or a plurality of work steps for injecting a drug housed in the drug container into the infusion container by the syringe. In addition, in the drug-mixing support processing, the controller 801 causes various types of information based on the preparation data that has become a processing target in the drug-mixing support apparatus 8 to be printed on the second label LA12 by the second recorder 804. [Configuration of Verification Terminal 9]

The verification terminal 9 is an information terminal including a controller 901, a storage unit 902, a code reading unit 903, a display unit 904, and the like. For example, the verification terminal 9 is a portable terminal that the user can carry, such as a smartphone or a personal digital assistant (PDA). The controller 901 includes a processor that executes various types of programs, a memory, and the like. The storage unit 902 is storage means such as a hard disk drive that stores various types of programs for causing the controller 901 to execute various types of processing, and also stores association information described later and the like. The code reading unit 903 is a barcode reader or the like that reads information from a code such as a one-dimensional code and a two-dimensional code. The display unit 904 is output means such as a liquid crystal display or an organic EL display for presenting information to the user. A barcode reader or the like such as the code reading unit 903 may be connected to the host system 2, and the host system 2 may have the function of the verification terminal 9.

### [Processing of Drug-mixing System 100]

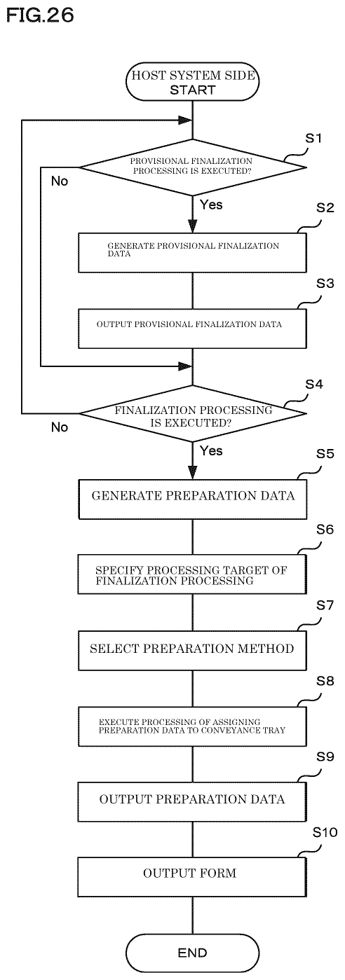

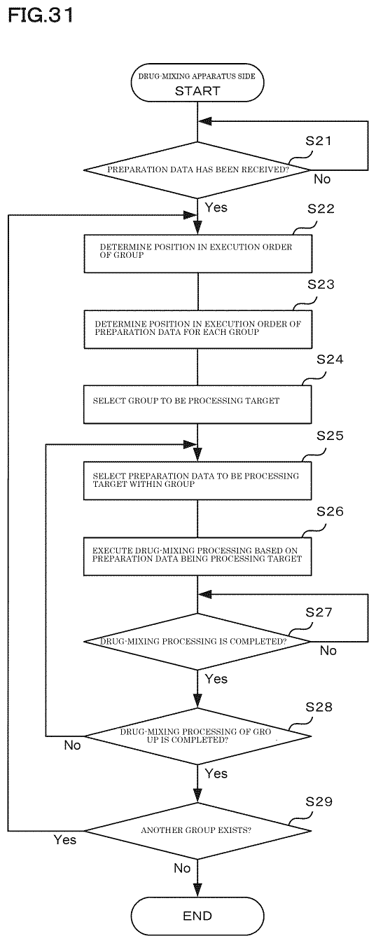

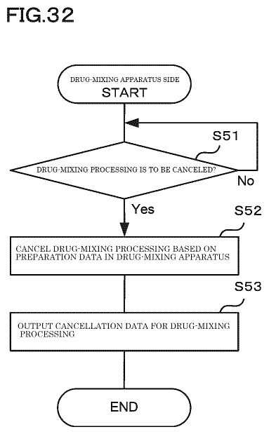

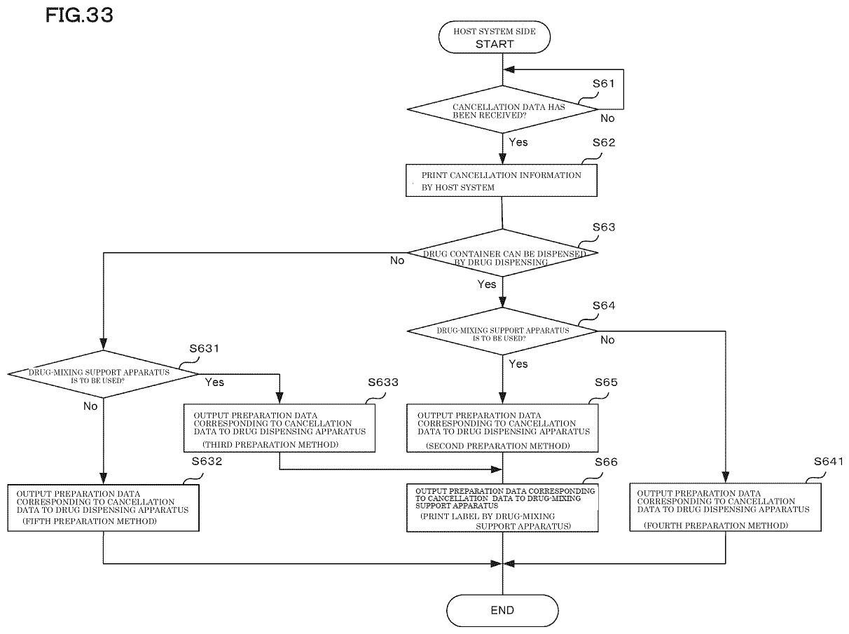

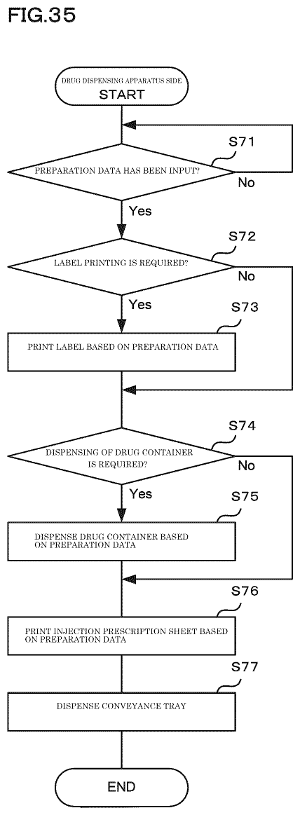

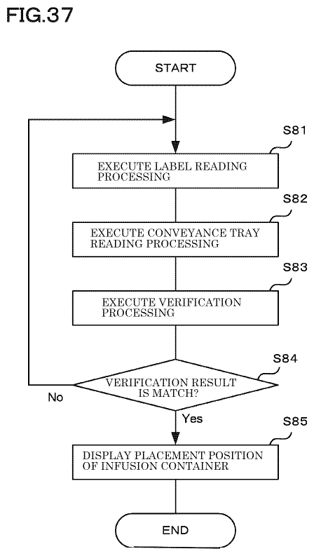

Now, various types of processing executed by the drug-mixing apparatus 1, the host system 2, the drug dispensing apparatus 7, the verification terminal 9, and the like in the drug-mixing system 100 are described. Specifically, in the following, data output processing of the host system 2 (see FIG. 26), drug-mixing control processing of the drug-mixing apparatus 1 (see FIG. 31), drug-mixing cancellation processing of the drug-mixing apparatus 1 (see FIG. 32), switching control processing of the host system 2 (see FIG. 33), drug dispensing processing of the drug dispensing apparatus 7 (see FIG. 35), and tray verification processing of the verification terminal 9 (see FIG. 37) are described in order.

### [Data Output Processing]

The controller 201 of the host system 2 executes the data output processing (see FIG. 26) of assigning preparation data to be a processing target of drug-mixing processing to the drug-mixing apparatus 1, the drug dispensing apparatus 7, the drug-mixing support apparatus 8, and the like by selecting and outputting the preparation data to the drug-mixing apparatus 1, the drug dispensing apparatus 7, the drug-mixing support apparatus 8, and the like. Then, the drug-mixing apparatus 1, the drug dispensing apparatus 7, and the drug-mixing support apparatus 8 execute various types of processing with the preparation data assigned to their own apparatus set as processing targets in a predetermined order. The controller 201 when executing the data output processing is an example of a data output processor according to one or more embodiments. In one or more embodiments, assignment of preparation data is performed by output of the preparation data, but the technical scope is not limited to this. For example, the controller 201 may assign each piece of preparation data to the drug-mixing apparatus 1, the drug dispensing apparatus 7, the drug-mixing support apparatus 8, and the like, store the assignment result in the storage unit 202, and notify the drug-mixing apparatus 1, the drug dispensing apparatus 7, the drug-mixing support apparatus 8, and the like of the assignment result. In this case, the drug-mixing apparatus 1, the drug dispensing apparatus 7, the drug-mixing support apparatus 8, and the like acquire the preparation data assigned to their own apparatus by reading out the preparation data from the storage unit 202 of the host system 2 as required.

### <Step S1>

As illustrated in FIG. 26, in Step S1, the controller 201 determines whether to execute provisional finalization processing including Step S2 and Step S3 described later. For example, the controller 201 determines to execute the provisional finalization processing when a provisional finalization operation for executing the provisional finalization processing has been performed on the operation unit 203. The controller 201 may also determine to automatically execute the provisional finalization processing when a specific timing such as a preset time arrives. Then, when it is determined that the provisional finalization processing is to be executed (Yes in Step S1), the process proceeds to Step S2, and when it is determined that the provisional finalization processing is not to be executed (No in Step S1), the process proceeds to Step S4.

### <Step S2>

In Step S2, the controller 201 executes processing for generating provisional finalization data to be transmitted to the drug-mixing apparatus 1. Specifically, the controller 201 extracts provisional target prescription data to be a target of provisional finalization from a plurality of pieces of prescription data stored in the storage unit 202 based on a preset extraction condition, and generates provisional finalization data based on each piece of provisional target prescription data. The controller 201 may also cause the display unit 204 to display a list of the plurality of pieces of prescription data stored in the storage unit 202, and select provisional target prescription data to be a target of provisional finalization from the plurality of pieces of prescription data in response to an instruction including a user operation on the operation unit 203. The provisional finalization data includes at least information on the type and number of pieces of equipment such as syringes, drug containers, and infusion containers required for executing drug-mixing processing in the drug-mixing apparatus 1 based on the plurality of pieces of provisional target prescription data. The provisional finalization data also includes an order number, an administration time, patient identification information, and the like corresponding to each piece of prescription data.

### <Step S3>

In Step S3, the controller 201 executes provisional finalization data output processing of outputting the provisional finalization data generated in Step S2. Specifically, the controller 201 stores the provisional finalization data in the storage unit 202, and transmits the provisional finalization data to the drug-mixing apparatus 1. Step S1 to Step S3 are processing steps executed to specify the type and number of pieces of equipment required for the drug-mixing processing executed in the drug-mixing apparatus 1 before preparation data is transmitted from the host system 2 to the drug-mixing apparatus 1, but in another embodiment, Step S1 to Step S3 may be omitted.

Then, in the drug-mixing apparatus 1, the controller 140 determines whether drug-mixing processing using a type of equipment included in the provisional finalization data received from the host system 2 can be executed in the drug-mixing apparatus 1, and notifies the host system 2 of a result of the determination. For example, in the drug-mixing apparatus 1, conditions such as the type of equipment or a combination of equipment with which drug-mixing processing can be executed in the drug-mixing apparatus 1 are preset, and based on the conditions, it is determined whether the drug-mixing processing using the type of equipment included in the provisional finalization data can be executed in the drug-mixing apparatus 1. Specifically, the controller 140 determines that drug-mixing processing is not executable in the drug-mixing apparatus 1 for provisional target prescription data for which equipment such as a syringe, a drug container, or an infusion container that is set as unusable in the drug-mixing apparatus 1 (not set as usable) is required in the drug-mixing processing, among the pieces of provisional target prescription data included in the provisional finalization data. For example, it is conceivable that the controller 140 determines that the drug-mixing processing in the drug-mixing apparatus 1 is not executable when a size of a syringe or an infusion container required in the drug-mixing processing is larger than a preset size. In addition, the controller 140 may determine that the drug-mixing processing in the drug-mixing apparatus 1 is not executable when the number of needle punctures into a drug container in the drug-mixing processing is two or more. Further, when one piece of provisional target prescription data includes a plurality of drugs, and at least one of the drugs is a drug preset as a drug that cannot be used in the drug-mixing apparatus 1, the controller 140 may determine that the drug-mixing processing is not executable in the drug-mixing apparatus 1 for the provisional target prescription data. Then, the controller 140 notifies the controller 201 of the host system 2 of a determination result of executability of the drug-mixing processing in the drug-mixing apparatus 1 for each piece of provisional target prescription data included in the provisional finalization data. In addition, the controller 201 of the host system 2 may determine the executability of the drug-mixing processing in the drug-mixing apparatus 1 for each piece of provisional target prescription data included in the provisional finalization data. Further, when the provisional target prescription data includes a plurality of Rps, the controller 201 may determine the executability of the drug-mixing processing in the drug-mixing apparatus 1 for each Rp.

Further, in the drug-mixing apparatus 1, the controller 140 may generate a list of pieces of equipment that are required to be supplied to the drug-mixing apparatus 1 based on the provisional finalization data received from the host system 2, and output the list by a method such as displaying or printing. As a result, the user can grasp the equipment that is to be supplied to the drug-mixing apparatus 1 at the timing when the drug-mixing apparatus 1 receives the provisional finalization data, and can supply the equipment to the drug-mixing apparatus 1 before the drug-mixing apparatus 1 receives preparation data generated based on prescription data corresponding to the provisional finalization data. In particular, when an extraction condition in Step S2 and an extraction condition in Step S5 described later are set to the same condition, it is possible to prepare the equipment required for the drug-mixing processing executed by the drug-mixing apparatus 1 based on preparation data generated in Step S5 described later and transmitted to the drug-mixing apparatus 1, at the timing when the provisional finalization processing is executed. For example, in Step S5 described later, the controller 140 may display a list of pieces of provisional finalization data already generated in Step S2 together with, for example, the extraction condition of the provisional finalization data or an execution date and time of the provisional finalization processing to receive a selection of provisional finalization data, and execute extraction of target prescription data with the extraction condition corresponding to the selected provisional finalization data.

### <Step S4>

In Step S4, the controller 201 determines whether to execute finalization processing of Step S5 and the subsequent steps described later. For example, the controller 201 determines to execute the finalization processing when a finalization operation for executing the finalization processing is performed on the operation unit 203. The controller 201 may also determine to automatically execute the finalization processing when a specific timing such as a preset time arrives. Then, when it is determined that the finalization processing is to be executed (Yes in Step S4), the process proceeds to Step S5, and when it is determined that the finalization processing is not to be executed (No in Step S4), the process proceeds to Step S1. Each of the provisional finalization processing and the finalization processing may be executed only once a day, or may be executed at a plurality of timings.

### <Step S5>

In Step S5, the controller 201 executes processing of generating one or a plurality of pieces of preparation data based on each piece of prescription data for which preparation data has not been generated among the pieces of prescription data stored in the storage unit 202. The preparation data includes information on the type and number of pieces of equipment such as syringes, drug containers, and infusion containers required for executing drug-mixing processing based on the preparation data. The preparation data also includes an order number, an Rp number, an administration time (administration date and administration time), and the like corresponding to the preparation data. Further, the preparation data also includes information such as a patient's ward and patient identification information included in prescription data corresponding to the preparation data.

In this case, when prescription data includes data of a plurality of Rps (application data), the controller 201 generates preparation data corresponding to the data of each Rp. Specifically, when prescription data includes data of a plurality of Rps, the controller 201 decomposes the prescription data into pieces of prescription data in units of Rps (units of application), and generates preparation data corresponding to each of the pieces of prescription data. As a result, the controller 201 can select preparation data corresponding to a plurality of Rps included in one piece of prescription data as an output target in finalization processing in Step S6 described later, not in units of prescription data but in units of Rps. That is, when one piece of prescription data includes a plurality of Rps, the user can select the timing to set preparation data as a processing target of the finalization processing in units of preparation data corresponding to each Rp. A timing of generation of preparation data by the controller 201 is not limited to the execution timing of Step S5, and for example, the controller 201 may generate preparation data based on prescription data when receiving the prescription data, and in this case, Step S5 may be omitted. The controller 201 may also generate preparation data at a preset time, or may generate preparation data at a preset interval. Further, after generating each piece of preparation data, the controller 201 may determine, for each piece of preparation data, whether drug-mixing processing based on the piece of preparation data can be executed in the drug-mixing apparatus 1. As described above, the determination of whether the drug-mixing processing based on the preparation data in the drug-mixing apparatus 1 is possible may be performed by the controller 140 of the drug-mixing apparatus 1, and a result of the determination may be notified to the controller 201.

In addition, the controller 201 groups the preparation data based on a preset group condition, and includes group identification information for identifying a group to which the preparation data belongs in the preparation data. Specifically, the controller 201 groups the preparation data for each prescription classification, and then further groups the preparation data belonging to the same group for each ward. The group for each prescription classification may be hereinafter referred to as “first group,” and the group for each ward may be hereinafter referred to as “second group.”

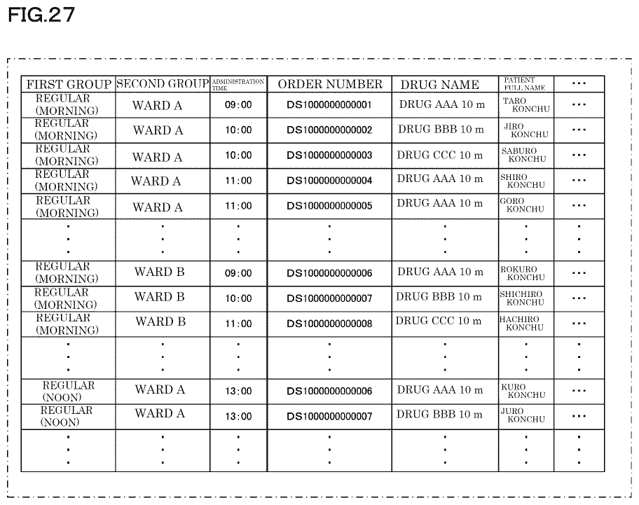

In particular, when classifying the preparation data into the first group, the controller 201 subdivides a prescription classification included in the prescription detail information, and then classifies the preparation data based on the subdivided prescription classification. For example, the controller 201 subdivides “regular,” which is one of the prescription classifications, into a plurality of prescription classifications based on an administration time. Specifically, in one or more embodiments, the controller 201 subdivides “regular” of the prescription classification into prescription classifications of “regular (morning)” when the administration time is from 9:00 to 12:00, “regular (noon)” when the administration time is from 12:00 to 15:00, and “regular (evening)” when the administration time is from 15:00 to 17:00. FIG. 27 shows an example of grouping of preparation data. In the example shown in FIG. 27, each piece of preparation data is classified in the first group based on a prescription classification such as “regular (morning)” and “regular (noon),” and is classified in the second group based on a ward such as “ward A” and “ward B.” The second group is not limited to a group into which the preparation data is classified based on a ward, and the preparation data may be classified based on other information included in the preparation data, such as a hospital room, a person in charge, an administration time, and a department. In this manner, the controller 201 can subdivide the prescription classification based on the administration time and classify the preparation data, and hence, in selection processing for preparation data to be a processing target of finalization processing in Step S6 described later, the user can select preparation data as a target of the finalization processing in units of prescription classifications subdivided based on the administration time, instead of in units of the prescription classification shown in the prescription data.

### <Step S6>

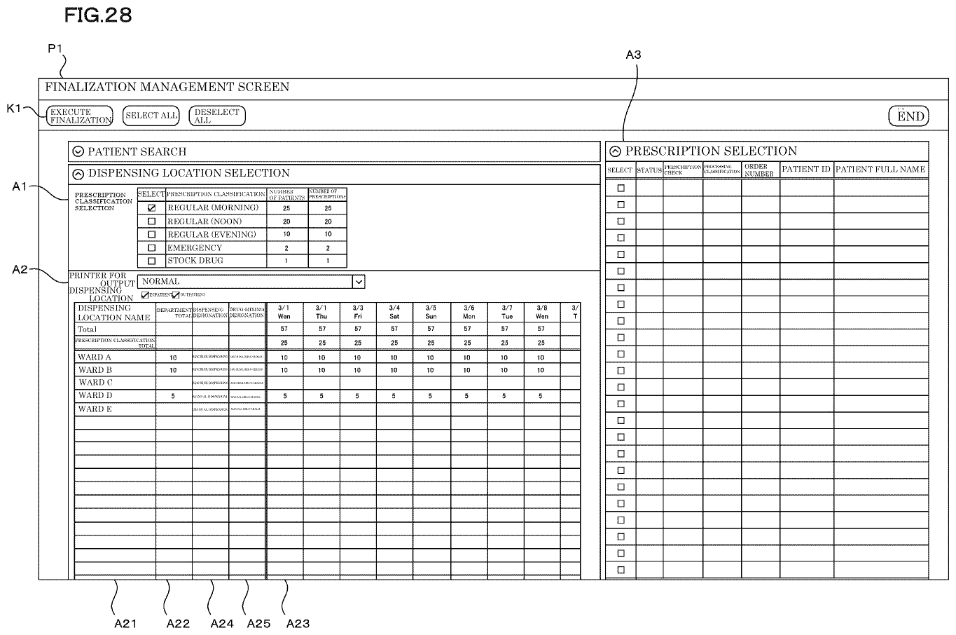

In Step S6, the controller 201 specifies preparation data to be a processing target of finalization processing in response to an instruction including a user operation. Specifically, the controller 201 causes the display unit 204 to display a display screen P1 for selecting preparation data to be a processing target of the finalization processing. FIG. 28 is a view for illustrating an example of the display screen P1. In the display screen P1 illustrated in FIG. 28, regions A1 to A3 and an operation section K1 are displayed.

The region A1 displays the number of patients and the number of prescriptions for each prescription classification for unprocessed preparation data, and also displays an operation section such as a check box for receiving a selection of one or a plurality of the prescription classifications. Here, the prescription classification in the region A1 is not a prescription classification shown in prescription data, but a prescription classification after being subdivided in Step S5 described above, and in the region A1, a finalization target can be selected in units of the first group. Then, in the region A1, the operation section such as a check box for switching whether to select a prescription classification is displayed, and the controller 201 narrows down selection candidate preparation data based on a prescription classification selected by an instruction including a user operation in the region A1.

In one or more embodiments, each piece of preparation data is generated based on prescription data decomposed in units of Rps, and hence the number of prescriptions displayed in the region A1 is the number of pieces of preparation data generated based on the prescription data in units of Rps. Accordingly, the number of prescriptions displayed in the region A1 may not match the number of pieces of prescription data input to the host system 2. Meanwhile, as another embodiment, for example, when prescription data input to the host system 2 has only data of one Rp, the prescription data is not required to be decomposed in units of Rps, and the number of prescriptions displayed in the region A1 matches the number of pieces of prescription data input to the host system 2.

A region A2 includes regions A21 to A25. The region A21 displays group identification information (for example, a ward name, a department name, or an administration time) of one or a plurality of the second groups corresponding to one or a plurality of pieces of preparation data belonging to a prescription classification selected in the region A1. In one or more embodiments, the second group is a group into which the preparation data is classified based on a ward, and hence a ward name is displayed in the region A2. The region A22 displays the number of prescriptions belonging to the prescription classification selected in the region A1 for each of the second groups (wards). The region A23 displays the number of prescriptions belonging to the prescription classification selected in the region A1 for each combination of the second group and an administration date.

The region A24 is an operation display section for selecting a dispensing method used at the time of dispensing a drug container, for preparation data belonging to a prescription classification selected in the region A1, for each of the second groups.

Specifically, in one or more embodiments, the dispensing method includes machine dispensing in which a drug container is dispensed through use of the drug dispensing apparatus 7, and manual dispensing in which the user prepares a drug container manually. Then, the controller 201 selects one of “machine dispensing” and “manual dispensing” in response to an instruction including a user operation in the region A24, and displays the selected one in the region A24. In addition, when the drug-mixing system 100 includes a plurality of drug dispensing apparatus 7, it is also possible to select one of the plurality of drug dispensing apparatus 7 in the region A24. For example, it is conceivable that the controller 201 can select apparatus identification information such as an apparatus number of the drug dispensing apparatus 7 in response to an instruction including a user operation in the region A24. A pull-down menu, for example, is used for selecting items in the region A24 and the region A25.

The region A25 is an operation display section for selecting a drug-mixing method used at the time of performing drug-mixing processing, for preparation data belonging to a prescription classification selected in the region A1, for each of the second groups. Specifically, in one or more embodiments, the drug-mixing method includes machine drug-mixing in which drug-mixing processing is executed by the drug-mixing apparatus 1, and manual drug-mixing in which the user executes drug-mixing processing manually. Then, the controller 201 selects one of “machine drug-mixing” and “manual drug-mixing” in response to an instruction including a user operation in the region A25, and displays the selected one in the region A25. In addition, when the drug-mixing system 100 includes a plurality of drug-mixing apparatus 1, it is also possible to select one of the plurality of drug-mixing apparatus 1 in the region A25. For example, it is conceivable that the controller 201 can select apparatus identification information such as an apparatus number of the drug-mixing apparatus 1 in response to an instruction including a user operation in the region A25.

Further, although not shown in FIG. 28, when executability of drug-mixing processing based on each piece of preparation data in the drug-mixing apparatus 1 has been determined as described above, the controller 201 may display a determination result of the executability of the drug-mixing processing based on each piece of preparation data in the drug-mixing apparatus 1 as reference information on the display screen P1. For example, on the display screen P1, as the reference information, the executability of the drug-mixing processing in the drug-mixing apparatus 1 may be displayed for each piece of preparation data, the number or ratio of pieces of preparation data for which the drug-mixing processing in the drug-mixing apparatus 1 can be executed may be displayed for each of the first groups, and the number or ratio of pieces of preparation data for which the drug-mixing processing in the drug-mixing apparatus 1 can be executed may be displayed for each of the second groups. When the determination of the executability of the drug-mixing processing in the drug-mixing apparatus 1 is performed for provisional target prescription data included in provisional finalization data or Rp included in the provisional target prescription data, similarly, reference information related to the determination result of the executability may be displayed for each piece of provisional target prescription data, for each Rp, for each of the first groups, or for each of the second groups.

The region A3 displays a list of contents of preparation data corresponding to a combination corresponding to an individual region when the individual region corresponding to any one of combinations of the second group and the administration date is selected in the region A23 of the region A2. In addition, in the region A3, an operation section such as a check box for receiving an operation for selecting one or a plurality of the pieces of preparation data displayed in the region A3 as a processing target of finalization processing is displayed. For example, when preparation data is displayed in the region A3, the controller 201 sets all of the preparation data to a selected state (or a deselected state), and switches a selected state of one or a plurality of the pieces of preparation data to a deselected state (or a selected state) in response to an instruction including a user operation. That is, the controller 201 can select whether to assign preparation data to the drug-mixing apparatus 1 in units of the second group in response to an instruction including a user operation in the region A1, but can also select whether to assign preparation data to the drug-mixing apparatus 1 in units of preparation data in response to an instruction including a user operation in the region A3.

The operation section K1 is an operation key for receiving an instruction including a user operation for executing finalization processing for preparation data selected as a processing target of the finalization processing on the display screen P1. Specifically, in response to an operation on the operation section K1, the controller 201 specifies preparation data selected on the display screen P1 as a processing target of the finalization processing, and also specifies a dispensing method and a drug-mixing method for each of the second groups selected on the display screen P1 as a dispensing method and a drug-mixing method for each piece of preparation data belonging to the second group, and advances the process to Step S7.

### <Step S7>

In Step S7, the controller 201 selects a preparation method for preparation data selected as a processing target of finalization processing in Step S6, based on the dispensing method and the drug-mixing method selected in Step S6.

Specifically, the controller 201 selects a first preparation method as a preparation method for preparation data belonging to the second group for which the dispensing method selected in Step S6 is “machine dispensing” and the drug-mixing method selected in Step S6 is “machine drug-mixing.” The first preparation method is a method in which the drug-mixing apparatus 1 executes drug-mixing processing based on preparation data, and the drug dispensing apparatus 7 does not execute dispensing of a drug container and printing of the second label LA12, but prints an injection prescription sheet, places the injection prescription sheet on the conveyance tray TR1, and dispenses the injection prescription sheet. In this case, the second label LA12 is printed not by the drug dispensing apparatus 7 but by the drug-mixing apparatus 1 and attached to an infusion container. That is, when the preparation method is the first preparation method, the controller 201 assigns the preparation data as one for which drug-mixing processing is to be executed by the drug-mixing apparatus 1, and also assigns the preparation data as one for which the drug dispensing processing is to be executed by the drug dispensing apparatus 7.

Even for preparation data belonging to the second group for which the dispensing method selected in Step S6 is “machine dispensing” and the drug-mixing method selected in Step S6 is “machine drug-mixing,” when the preparation data is preparation data for which it has been determined that drug-mixing processing in the drug-mixing apparatus 1 is not executable, the controller 201 selects another preparation method such as a second preparation method to a fourth preparation method described later, instead of the first preparation method. That is, when drug-mixing processing based on preparation data assigned to the drug-mixing apparatus 1 by an instruction including a user operation is not executable by the drug-mixing apparatus 1, the controller 201 does not assign the preparation data to the drug-mixing apparatus 1. Accordingly, even for preparation data belonging to the same second group, the preparation method may be different.

In addition, for preparation data belonging to the second group for which the dispensing method selected in Step S6 is “machine dispensing” and the drug-mixing method selected in Step S6 is “manual drug-mixing,” the controller 201 selects the second preparation method as a preparation method. The second preparation method is a method in which the drug dispensing apparatus 7 executes dispensing of a drug container and printing of an injection prescription sheet, places the drug container and the injection prescription sheet on the conveyance tray TR1 and dispenses the drug container and the injection prescription sheet, and the user manually executes drug-mixing processing with support from the drug-mixing support apparatus 8. In this case, the second label LA12 is printed not by the drug-mixing apparatus 1 and the drug dispensing apparatus 7 but by the drug-mixing support apparatus 8, and is attached to an infusion container by the user. That is, when the preparation method is the second preparation method, the controller 201 assigns the preparation data as one for which the drug dispensing processing is to be executed by the drug dispensing apparatus 7, and also assigns the preparation data as one for which drug-mixing support processing including printing processing for the second label LA12 is to be executed by the drug-mixing support apparatus 8.

In addition, for preparation data belonging to the second group for which the dispensing method selected in Step S6 is “manual dispensing” and the drug-mixing method selected in Step S6 is “manual drug-mixing,” the controller 201 selects the third preparation method as a preparation method. The third preparation method is a method in which the drug dispensing apparatus 7 does not execute dispensing of a drug container and printing of the second label LA12, but prints an injection prescription sheet, places the injection prescription sheet on the conveyance tray TR1 and dispenses the injection prescription sheet, and the user manually executes preparation of a drug container and also manually executes drug-mixing processing with support from the drug-mixing support apparatus 8. In this case, the second label LA12 is printed not by the drug-mixing apparatus 1 and the drug dispensing apparatus 7 but by the drug-mixing support apparatus 8, and is attached to an infusion container by the user. That is, when the preparation method is the third preparation method, the controller 201 assigns the preparation data as one for which drug-mixing support processing including printing processing for the second label LA12 is to be executed by the drug-mixing support apparatus 8.

Incidentally, in a medical institution in which the drug-mixing system 100 is used, when the drug-mixing method is “manual drug-mixing” and the user manually executes drug-mixing processing in a ward or the like, the user may execute the drug-mixing processing without receiving support from the drug-mixing support apparatus 8. In this case, the second label LA12 is not printed by the drug-mixing support apparatus 8.

Accordingly, even in a situation in which the second preparation method is selected in Step S7, when the user executes drug-mixing processing without receiving support from the drug-mixing support apparatus 8, the controller 201 selects the fourth preparation method instead of the second preparation method. Specifically, in the host system 2, whether the user executes drug-mixing processing without receiving support from the drug-mixing support apparatus 8 is preset for each of the second groups (wards), and it is conceivable that the controller 201 selects the second preparation method or the fourth preparation method for each of the second groups. The fourth preparation method is a method in which the drug dispensing apparatus 7 executes dispensing of a drug container, printing of the second label LA12, and printing of an injection prescription sheet, places the drug container, the second label LA12, and the injection prescription sheet on the conveyance tray TR1 and dispenses the drug container, the second label LA12, and the injection prescription sheet, and the user manually executes drug-mixing processing without receiving support from the drug-mixing support apparatus 8. In this case, the second label LA12 is printed by the drug dispensing apparatus 7, and is attached to an infusion container by the user. That is, when the preparation method is the fourth preparation method, the controller 201 assigns the preparation data as one for which drug dispensing processing and printing processing for the second label LA12 are to be executed by the drug dispensing apparatus 7.

Similarly, even in a situation in which the third preparation method is selected in Step S7, when the user executes drug-mixing processing without receiving support from the drug-mixing support apparatus 8, the controller 201 selects the fifth preparation method instead of the third preparation method. Specifically, in the host system 2, whether the user executes drug-mixing processing without receiving support from the drug-mixing support apparatus 8 is preset for each of the second groups (wards), and it is conceivable that the controller 201 selects the third preparation method or the fifth preparation method for each of the second groups. The fifth preparation method is a method in which the drug dispensing apparatus 7 executes printing of the second label LA12 and printing of an injection prescription sheet, places the second label LA12 and the injection prescription sheet on the conveyance tray TR1 and dispenses the second label LA12 and the injection prescription sheet, and the user manually executes preparation of a drug container and also manually executes drug-mixing processing without receiving support from the drug-mixing support apparatus 8. In this case, the second label LA12 is printed by the drug dispensing apparatus 7, and is attached to an infusion container by the user. That is, when the preparation method is the fifth preparation method, the controller 201 does not assign the preparation data as one for which drug dispensing processing is to be executed by the drug dispensing apparatus 7, but assigns the preparation data as one for which printing processing for the second label LA12 is to be executed by the drug dispensing apparatus 7.

In this manner, the controller 201 when executing processing for assigning preparation data to the drug-mixing apparatus 1, the drug dispensing apparatus 7, the drug-mixing support apparatus 8, or the like is an example of an assignment processor. In the drug-mixing system 100, selection candidates for a preparation method by the controller 201 are not required to be all of the first preparation method to the fifth preparation method, and only a configuration in which a selection is made from the first preparation method and at least one or more preparation methods from the second preparation method to the fifth preparation method is required.

### <Step S8>

In Step S8, the controller 201 executes assignment processing of assigning preparation data that is a processing target of finalization processing to the conveyance tray TR1. In one or more embodiments, a case in which four divided regions TR11 are provided on the conveyance tray TR1 as illustrated in FIG. 29 is taken as an example for description. For example, each of the divided regions TR11 may be a small tray detachable from the conveyance tray TR1, or may be a partial region formed on the conveyance tray TR1. The conveyance tray TR1 is provided with a code BC1 including tray identification information capable of identifying the conveyance tray TR1, and each of the divided regions TR11 is provided with a code BC21 including region identification information capable of identifying the divided region TR11. Then, for preparation data that is a processing target of finalization processing, the controller 201 sequentially assigns four pieces of preparation data in the same second group to the divided regions TR11 of the conveyance tray TR1. That is, preparation data assigned to the same conveyance tray TR1 belongs to the same second group. In this case, for example, not only preparation data for one patient but also preparation data for a plurality of patients may be assigned to a plurality of divided regions TR11 in the conveyance tray TR1. At this time, the controller 201 generates association information in which identification information such as patient identification information, an order number, and an Rp number capable of identifying the preparation data, tray identification information of the conveyance tray TR1 to which the preparation data is assigned, and region identification information of the divided region TR11 to which the preparation data is assigned are associated, and stores the association information in the storage unit 202 and outputs the association information to the drug dispensing apparatus 7 and the verification terminal 9. The controller 201 when executing Step S8 is an example of an association processor according to one or more embodiments.

### <Step S9>

In Step S9, the controller 201 executes processing of assigning preparation data belonging to each of the second groups that are processing targets of finalization processing to the drug-mixing apparatus 1, the drug dispensing apparatus 7, or the drug-mixing support apparatus 8 by an output method that follows the preparation method selected in Step S7, and outputting the preparation data to the drug-mixing apparatus 1, the drug dispensing apparatus 7, the drug-mixing support apparatus 8, or the like.

Specifically, for preparation data for which the preparation method selected in Step S7 is the first preparation method, the controller 201 outputs the preparation data to the drug-mixing apparatus 1, and outputs a first dispensing instruction indicating that drug dispensing and label printing are not required and the preparation data to the drug dispensing apparatus 7. That is, the controller 201 outputs the preparation data to the drug-mixing apparatus 1 as an assignment result of Step S7. As a result, in the drug-mixing apparatus 1, drug-mixing processing is executed based on the input preparation data, and an infusion container to which the second label LA12 is attached is dispensed. In one or more embodiments, a case in which output of preparation data to the drug-mixing apparatus 1 serves as both an instruction to execute the drug-mixing processing and an instruction to execute the recording processing is taken as an example for description, but when the preparation data is output to the drug-mixing apparatus 1, the controller 201 may transmit, to the drug-mixing apparatus 1, a drug-mixing instruction including an instruction to execute the drug-mixing processing based on the preparation data and a recording instruction to execute recording processing for the second label LA12 for the preparation data. Meanwhile, in the drug dispensing apparatus 7, a drug container and the second label LA12 are not placed in each divided region TR11 of the conveyance tray TR1 corresponding to each piece of input preparation data, but an injection prescription sheet is placed therein, and the conveyance tray TR1 is dispensed. That is, for preparation data assigned to the drug-mixing apparatus 1, the controller 201 does not cause the second information to be recorded on the second label LA12 by the second recorder 704 or the second recorder 804 provided separately from the drug-mixing apparatus 1, by outputting the first dispensing instruction together with the preparation data to the drug dispensing apparatus 7. In addition, for preparation data assigned to the drug-mixing apparatus 1, the controller 201 does not cause dispensing of a drug container by the drug dispensing apparatus 7 to be executed.

In addition, for preparation data for which the preparation method selected in Step S7 is the second preparation method, the controller 201 does not output the preparation data to the drug-mixing apparatus 1, but outputs a second dispensing instruction indicating that drug dispensing is required and label printing is not required and the preparation data to the drug dispensing apparatus 7, and also outputs the preparation data to the drug-mixing support apparatus 8. That is, the controller 201 outputs the second dispensing instruction or preparation data or the like to the drug dispensing apparatus 7 or the drug-mixing support apparatus 8 as an assignment result of Step S7. As a result, in the drug dispensing apparatus 7, the second label LA12 is not placed in each divided region TR11 of the conveyance tray TR1 corresponding to each piece of input preparation data, but a drug container and an injection prescription sheet are placed therein, and the conveyance tray TR1 is dispensed. In addition, in the drug-mixing support apparatus 8, drug-mixing support processing for supporting drug-mixing processing performed manually by the user based on the preparation data is executed, and the second label LA12 is printed for the preparation data. In one or more embodiments, a case in which output of preparation data to the drug-mixing support apparatus 8 serves as both an instruction to execute the drug-mixing support processing and an instruction to execute the recording processing is taken as an example for description, but when the preparation data is output to the drug-mixing support apparatus 8, the controller 201 may transmit, to the drug-mixing support apparatus 8, a drug-mixing instruction including an instruction to execute the drug-mixing support processing based on the preparation data and a recording instruction to execute recording processing for the second label LA12 for the preparation data.

In addition, for preparation data for which the preparation method selected in Step S7 is the third preparation method, the controller 201 does not output the preparation data to the drug-mixing apparatus 1, but outputs a third dispensing instruction indicating that drug dispensing and label printing are not required and the preparation data to the drug dispensing apparatus 7, and also outputs the preparation data to the drug-mixing support apparatus 8. That is, the controller 201 outputs the preparation data to the drug-mixing support apparatus 8 as an assignment result of Step S7. As a result, in the drug dispensing apparatus 7, a drug container and the second label LA12 are not placed in each divided region TR11 of the conveyance tray TR1 corresponding to each piece of input preparation data, but an injection prescription sheet is placed therein, and the conveyance tray TR1 is dispensed. In addition, in the drug-mixing support apparatus 8, drug-mixing support processing for supporting drug-mixing processing performed manually by the user based on the preparation data is executed, and the second label LA12 is printed for the preparation data.

In addition, for preparation data for which the preparation method selected in Step S7 is the fourth preparation method, the controller 201 does not output the preparation data to the drug-mixing apparatus 1 and the drug-mixing support apparatus 8, but outputs a fourth dispensing instruction indicating that drug dispensing and label printing are required and the preparation data to the drug dispensing apparatus 7. That is, the controller 201 outputs the fourth dispensing instruction and the preparation data to the drug dispensing apparatus 7 as an assignment result of Step S7. The fourth dispensing instruction is an example of the recording instruction described above. As a result, in the drug dispensing apparatus 7, a drug container, the second label LA12, and an injection prescription sheet are placed in each divided region TR11 of the conveyance tray TR1 corresponding to each piece of input preparation data, and the conveyance tray TR1 is dispensed.

In addition, for preparation data for which the preparation method selected in Step S7 is the fifth preparation method, the controller 201 does not output the preparation data to the drug-mixing apparatus 1 and the drug-mixing support apparatus 8, but outputs a fifth dispensing instruction indicating that label printing is required and drug dispensing is not required and the preparation data to the drug dispensing apparatus 7. That is, the controller 201 outputs the fifth dispensing instruction and the preparation data to the drug dispensing apparatus 7 as an assignment result of Step S7. The fifth dispensing instruction is an example of the recording instruction described above. As a result, in the drug dispensing apparatus 7, the second label LA12 and an injection prescription sheet are placed in each divided region TR11 of the conveyance tray TR1 corresponding to each piece of input preparation data, and the conveyance tray TR1 is dispensed.

### <Step S10>

In Step S10, the controller 201 causes the printing unit 205 to print (output) a form such as a preset patient list and summary table based on preparation data that is a processing target of finalization processing, and returns the process to Step S1. The form such as a patient list and a summary table may be printed by the drug-mixing apparatus 1, the drug dispensing apparatus 7, the drug-mixing support apparatus 8, or the like. In this manner, the controller 201 when outputting a patient list is an example of an output processor according to one or more embodiments.

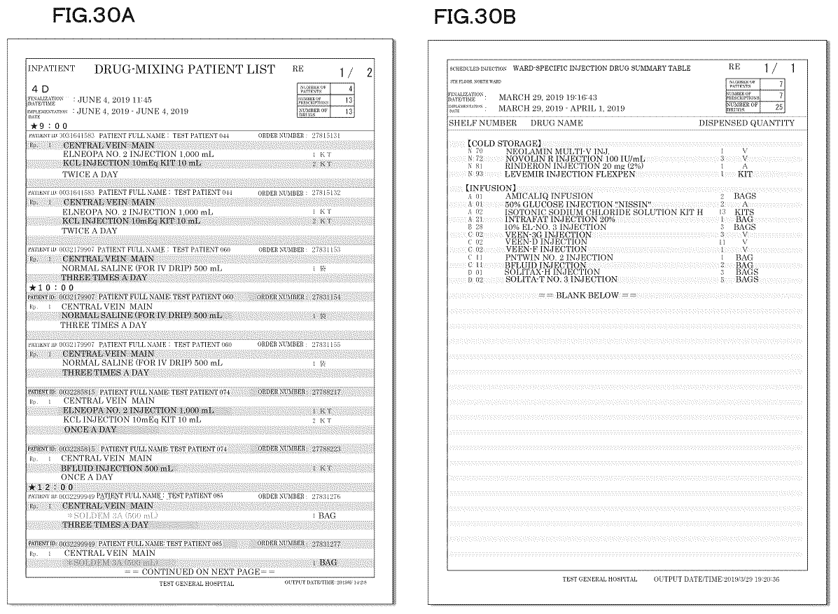

In the patient list, various types of information including one or both of the number of infusion containers corresponding to preparation data in the same second group and the types of the infusion containers are listed. For example, as illustrated in FIG. 30A, on the patient list, information such as an execution time of finalization processing of preparation data, an implementation date and implementation time of drug administration based on the preparation data (administration date and administration time), patient identification information shown in the preparation data, an Rp number corresponding to the preparation data, the type and number of each of drug containers and infusion containers, and an order number of prescription data corresponding to the preparation data is printed. In the patient list, information on each patient is arranged in accordance with a preset priority based on, for example, an implementation date or implementation time of drug administration based on the preparation data. In addition, when receiving a notification from the drug-mixing apparatus 1 to the effect that drug-mixing processing based on preparation data of the same group has been executed, the controller 201 may print the patient list for the group. The patient list is not limited to being output in units of the second group, and may be output in any other units such as units of the first group or units of finalization processing.

The summary table is one in which drug containers and infusion containers that the user is required to prepare manually for drug-mixing processing based on preparation data in the same second group are listed. For example, as illustrated in FIG. 30B, on the summary table, information such as an execution time of finalization processing of preparation data, an implementation date of drug administration based on the preparation data (administration date), the type and number of drug containers, and the type and number of infusion containers is printed.

[Drug-mixing Control Processing of Drug-mixing Apparatus 1] In the drug-mixing apparatus 1, the drug-mixing control processing (see FIG. 31) for executing drug-mixing processing based on preparation data is executed by the controller 140.

### <Step S21>

As illustrated in FIG. 31, in Step S21, the controller 140 determines whether preparation data has been received. Then, when preparation data has been received (Yes in Step S21), the process proceeds to Step S22, and until preparation data is received (No in Step S21), the process waits in Step S21. Preparation data received from the host system 2 is stored in the storage unit 200. As described above, the preparation data is grouped based on a group condition determined in advance, and the preparation data includes group identification information.

In one or more embodiments, a case in which, when the controller 140 receives preparation data from the host system 2, the controller 140 determines that the preparation data has been issued and executes drug-mixing processing based on the preparation data is described. For example, when the controller 140 receives a plurality of pieces of preparation data from the host system 2, the controller 140 issues the plurality of pieces of preparation data as processing targets of drug-mixing processing. Meanwhile, as another embodiment, among pieces of preparation data received from the host system 2, preparation data for which an issuing operation by the user has been performed may be issued as a processing target of drug-mixing processing. Among pieces of unprocessed preparation data received from the host system 2 and stored in the storage unit 200, only issued preparation data becomes a processing target of drug-mixing processing, and unissued preparation data does not become a processing target of drug-mixing processing until the relevant preparation data is issued.

### <Step S22>

In Step S22, the controller 140 determines a position in an execution order of drug-mixing processing for a group to which each piece of unprocessed preparation data currently stored in the storage unit 200 belongs. Specifically, when preparation data is grouped by administration time, the controller 140 determines a position in the execution order of the drug-mixing processing for each group so that the administration time of the groups is in ascending order. In addition, when preparation data is grouped by a combination of administration time and ward or person in charge, the controller 140 determines a position in the execution order of the drug-mixing processing for each group so that the administration time is in ascending order, and when there are a plurality of groups with the same administration time, determines a position in the execution order of the drug-mixing processing for each group in Japanese syllabary order, alphabetical order, or numerical order for the ward or person in charge. A priority can be set for each group in the host system 2, and the controller 140 may determine a position in the execution order of the drug-mixing processing for each of the groups based on the priority.

### <Step S23>

In Step S23, the controller 140 determines a position in an execution order of drug-mixing processing based on unprocessed preparation data currently stored in the storage unit 200 for each group. Specifically, the controller 140 determines a position in the execution order of drug-mixing processing based on preparation data in the same group, based on contents of one or a plurality of preset items such as an order number, a patient name, a ward, a person in charge, or a drug name. For example, when a position in the execution order of drug-mixing processing is determined based on an order number, the position in the execution order of the drug-mixing processing is determined so that preparation data with a smaller order number (an earlier order) has an earlier position in the execution order. In addition, when a position in the execution order of drug-mixing processing is determined based on a patient name, the position in the execution order of the drug-mixing processing is determined so that preparation data is in Japanese syllabary order. A priority can be set for each piece of preparation data in the host system 2, and the controller 140 may determine a position in the execution order of drug-mixing processing based on preparation data in the group based on the priority. In addition, a position in the execution order of preparation data in the same group may be one determined by the host system 2.

### <Step S24>

In Step S24, the controller 140 selects a group with the earliest position in the execution order as a group to be a processing target of drug-mixing processing, in accordance with the positions in the execution order of drug-mixing processing for groups determined in Step S22.

### <Step S25>

In Step S25, the controller 140 selects preparation data with the earliest position in the execution order in the group being the processing target as preparation data to be a processing target of drug-mixing processing, in accordance with the positions in the execution order of drug-mixing processing based on preparation data determined in Step S23.

### <Step S26>

In Step S26, the controller 140 executes drug-mixing processing based on the preparation data selected as the processing target in Step S25. For preparation data for which drug-mixing processing is completed, the controller 140 stores the preparation data in the storage unit 200 as processed preparation data in association with a result of the drug-mixing processing, a result of an inspection, and the like.

### <Step S27>

In Step S27, the controller 140 determines whether the drug-mixing processing based on one piece of preparation data is completed. Then, when the drug-mixing processing is completed (Yes in Step S27), the controller 140 advances the process to Step S28, and until the drug-mixing processing is completed (No in Step S27), the process waits in Step S27.

Specifically, in Step S27 in one or more embodiments, the controller 140 determines that the drug-mixing processing is completed when an injection step in which a drug solution is injected into an infusion container is completed. In this case, the processing can be advanced regardless of the content of a result of an inspection executed after completion of the injection step in the drug-mixing apparatus 1, and it is also possible to start drug-mixing processing based on other preparation data, and hence drug-mixing processing based on a plurality of pieces of preparation data can be efficiently performed.

Meanwhile, as another embodiment, in Step S27, the controller 140 may determine that the drug-mixing processing is completed when one of the conditions of completion of the injection step in which a drug solution is injected into an infusion container and occurrence of a shortage of equipment required for execution of the drug-mixing processing is satisfied. As a result, the processing can be advanced not only when the injection step is completed but also when a shortage of equipment occurs, and it is also possible to start drug-mixing processing based on other preparation data for which equipment is not in short supply, and hence drug-mixing processing based on a plurality of pieces of preparation data can be efficiently performed. In addition, even when drug-mixing processing based on preparation data in which a shortage of required equipment has occurred is skipped and drug-mixing processing based on other preparation data is executed in this manner, the controller 140 executes the drug-mixing processing based on the preparation data in units of groups. That is, when a shortage of equipment occurs in drug-mixing processing based on preparation data being the processing target, the controller 140 executes drug-mixing processing based on other preparation data belonging to the same group as that of the preparation data, but does not execute drug-mixing processing based on other preparation data belonging to another group until drug-mixing processing based on all preparation data belonging to the group is normally completed. The controller 140 may execute drug-mixing processing based on other preparation data belonging to another group when a condition such as an instruction including a user operation or elapse of a preset period is satisfied.

Further, as another embodiment, in Step S27, the controller 140 may determine that the drug-mixing processing is completed when the injection step in which a drug solution is injected into an infusion container is completed, and a result of an inspection executed after the injection step is determined to be normal. In addition, as another embodiment, in Step S27, the controller 140 may determine that the drug-mixing processing is completed when one of the conditions of completion of the injection step in which a drug solution is injected into an infusion container and determination that a result of an inspection executed after the injection step is normal, and occurrence of a shortage of equipment required for execution of the drug-mixing processing is satisfied.

### <Step S28>

In Step S28, the controller 140 determines whether the drug-mixing processing based on all preparation data of the current processing target group is completed. Then, when the drug-mixing processing based on all preparation data of the current processing target group is completed (Yes in Step S28), the process proceeds to Step S29, and when the drug-mixing processing is not completed (No in Step S28), the process proceeds to Step S25. As a result, in Step S25 to Step S28, the controller 140 sequentially selects each piece of preparation data as a processing target of drug-mixing processing in accordance with the positions in the execution order, and sequentially executes drug-mixing processing based on each of the pieces of preparation data. In addition, when the drug-mixing processing based on all preparation data of the current processing target group is completed, the controller 140 notifies the user of this fact by displaying the fact on the touch panel 80 of the drug-mixing apparatus 1, the verification terminal 9, or the like.

### <Step S29>

In Step S29, the controller 140 determines whether there is preparation data of an unprocessed group other than the group that has been the processing target. When there is preparation data of another group (Yes in Step S29), the process proceeds to Step S22, and when there is no preparation data of another group (No in Step S29), the series of steps of the drug-mixing control processing is ended, and the process returns to Step S21. As a result, in Step S22 to Step S29, the controller 140 sequentially selects preparation data to be a processing target of drug-mixing processing in units of groups in accordance with the position in the execution order of each group, and causes the drug-mixing apparatus 1 to execute drug-mixing processing based on the preparation data in units of the group. That is, in the drug-mixing apparatus 1, after drug-mixing processing based on all preparation data belonging to one group is completed, drug-mixing processing based on preparation data belonging to the next group is started. [Drug-mixing Cancellation Processing of Drug-mixing Apparatus 1]

Further, in the drug-mixing apparatus 1, the drug-mixing cancellation processing (see FIG. 32) for canceling drug-mixing processing based on preparation data in the drug-mixing apparatus 1 after the preparation data for which drug-mixing processing is to be executed by the drug-mixing apparatus 1 has been assigned to the drug-mixing apparatus 1 is executed by the controller 140. The drug-mixing cancellation processing is processing executed by the controller 201 substantially in parallel with the drug-mixing control processing and the like.

### <Step S51>

As illustrated in FIG. 32, in Step S51, the controller 140 determines whether an event for canceling drug-mixing processing in the drug-mixing apparatus 1 has occurred for any of the preparation data assigned as preparation data for which drug-mixing processing is to be executed by the drug-mixing apparatus 1 from the host system 2. For example, the controller 140 determines that an event for canceling drug-mixing processing based on preparation data in the drug-mixing apparatus 1 has occurred when some error occurs in the drug-mixing processing during execution of the drug-mixing processing based on the preparation data in the drug-mixing apparatus 1, and the drug-mixing processing can no longer be normally completed. When the error occurs, the controller 140 may provide a notification for inquiring of the user whether to cancel the drug-mixing processing based on the preparation data in the drug-mixing apparatus 1, and may determine that an event for canceling the drug-mixing processing based on the preparation data in the drug-mixing apparatus 1 has occurred in response to an instruction including a user operation. In addition, the controller 140 may determine that an event for canceling drug-mixing processing based on preparation data in the drug-mixing apparatus 1 has occurred when a specific instruction including user operation for canceling the drug-mixing processing based on the preparation data in the drug-mixing apparatus 1 is performed for preparation data freely selected by an instruction including a user operation. That is, cancellation of drug-mixing processing based on preparation data in the drug-mixing apparatus 1 can occur both before and after the start of the drug-mixing processing based on the preparation data. Then, until it is determined that an event for canceling drug-mixing processing based on preparation data in the drug-mixing apparatus 1 has occurred (No in Step S51), the process waits in Step S51, and when it is determined that an event for canceling drug-mixing processing based on preparation data in the drug-mixing apparatus 1 has occurred (Yes in Step S51), the process proceeds to Step S52.

### <Step S52>

In Step S52, the controller 140 cancels the drug-mixing processing based on preparation data in the drug-mixing apparatus 1 by deleting the preparation data for which it has been determined in Step S51 that an event for canceling drug-mixing processing in the drug-mixing apparatus 1 has occurred, from unprocessed preparation data stored in the storage unit 200. The controller 140 may leave the preparation data for which it has been determined in Step S51 that an event for canceling assignment to the drug-mixing apparatus 1 has occurred in the storage unit 200 as a processing history without deleting the preparation data.

### <Step S53>

In Step S53, the controller 140 outputs cancellation data for notifying of cancellation of the drug-mixing processing based on cancellation of the preparation data for which it has been determined in Step S51 that an event for canceling drug-mixing processing in the drug-mixing apparatus 1 has occurred, to the host system 2, and returns the process to Step S51. The cancellation data includes, for example, identification information such as patient identification information, an order number, and an Rp number for identifying the preparation data for which the drug-mixing processing in the drug-mixing apparatus 1 has been canceled.

Transmission of cancellation data to the host system 2 in Step S53 may be performed each time drug-mixing processing based on preparation data in the drug-mixing apparatus 1 is canceled, but the controller 140 may collectively transmit cancellation data for one or a plurality of pieces of preparation data to the host system 2 as a processing target at a preset time or at a preset interval. In addition, transmission of cancellation data to the host system 2 in Step S53 may be performed each time drug-mixing processing based on preparation data in the drug-mixing apparatus 1 is canceled, and in Step S61 described later which is executed in the host system 2, one or a plurality of pieces of cancellation data received up to that point may be collectively selected as a processing target at a preset time or at a preset interval.

[Switching Control Processing of Host System 2]

In addition, the controller 201 of the host system 2 executes the switching control processing (see FIG. 33) for switching drug-mixing processing for preparation data for which drug-mixing processing in the drug-mixing apparatus 1 has been canceled to another method and executing the method. The switching control processing is processing executed by the controller 201 substantially in parallel with the data output processing and the like. In addition, the switching control processing may be executed by the controller 140 of the drug-mixing apparatus 1.

### <Step S61>

As illustrated in FIG. 33, in Step S61, the controller 201 determines whether the cancellation data has been received from the drug-mixing apparatus 1. When it is not determined that the cancellation data has been received (No in Step S61), the process waits in Step S61, and when it is determined that the cancellation data has been received (Yes in Step S61), the process proceeds to Step S62. Drug-mixing processing based on preparation data in the drug-mixing apparatus 1 may be cancelable by an instruction including a user operation in the host system 2. In this case, the controller 201 also advances the process to Step S62 when an operation for canceling drug-mixing processing based on preparation data in the drug-mixing apparatus 1 is performed in the host system 2 (Yes in Step S61).

### <Step S62>

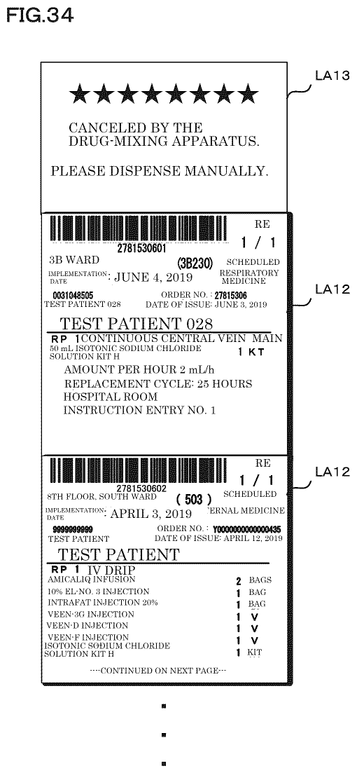

In Step S62, the controller 201 notifies the user of cancellation information indicating that drug-mixing processing executed in the drug-mixing apparatus 1 based on preparation data corresponding to the cancellation data has been canceled, by causing the third recording unit 206 to print the cancellation information on a third label LA13 (see FIG. 34). As a result, the user can easily grasp that the drug-mixing processing executed in the drug-mixing apparatus 1 based on the preparation data corresponding to the cancellation data has been canceled, and can grasp that, for the preparation data, it is required to manually perform preparation of a drug container, drug-mixing processing based on the preparation data, and the like. For example, as illustrated in FIG. 34, the cancellation information printed on the third label LA13 includes a message to the effect that the drug-mixing processing based on the preparation data has been canceled in the drug-mixing apparatus 1, or a message to the effect that preparation of a drug is required. In Step S62, the controller 201 may notify the user of the cancellation information by transmitting the cancellation information to the verification terminal 9 and causing the cancellation information to be displayed on the verification terminal 9. In addition, the controller 201 may notify the user of the cancellation information by transmitting the cancellation information to the drug-mixing support apparatus 8 and causing the cancellation information to be displayed or printed by the drug-mixing support apparatus 8.

On the cancellation information, identification information such as patient identification information, an order number, and an Rp number for identifying preparation data corresponding to the cancellation data may be printed. In addition, in Step S62, the controller 201 may cause the third recording unit 206 to print the second information (example of recorded information) related to the preparation data corresponding to the cancellation data on the second label LA12. In particular, it is conceivable that the controller 201 causes the second label LA12 to be printed subsequently to the third label LA13 printed in Step S62, as illustrated in FIG. 34. As a result, by referring to the third label LA13 and the second label LA12, the user can recognize that preparation data printed on the second label LA12 is one for which drug-mixing processing in the drug-mixing apparatus 1 has been canceled, and that the user is required to manually perform preparation of a drug container and drug-mixing processing for the preparation data.

### <Step S63>

In Step S63, the controller 201 determines whether a drug container used in drug-mixing processing based on preparation data corresponding to the cancellation data can be dispensed from the drug dispensing apparatus 7. For example, the controller 201 acquires information on the type of the drug container housed in the drug dispensing apparatus 7 from the drug dispensing apparatus 7, and determines whether the drug container can be dispensed from the drug dispensing apparatus 7 based on the acquired information. In addition, the controller 201 may inquire of the drug dispensing apparatus 7 whether the drug container can be dispensed, and determine whether the drug container can be dispensed from the drug dispensing apparatus 7 based on a response from the drug dispensing apparatus 7. Then, when it is determined that the drug container cannot be dispensed from the drug dispensing apparatus 7 (No in Step S63), the process proceeds to Step S631, and when it is determined that the drug container can be dispensed from the drug dispensing apparatus 7 (Yes in Step S63), the process proceeds to Step S64.

### <Step S631>

In Step S631, the controller 201 determines whether to use the drug-mixing support apparatus 8 in drug-mixing processing based on preparation data corresponding to the cancellation data. Specifically, when the second group to which the preparation data belongs is preset as a group that uses the drug-mixing support apparatus 8, the controller 201 determines to use the drug-mixing support apparatus 8 in the drug-mixing processing based on the preparation data. When it is determined that the drug-mixing support apparatus 8 is not to be used (No in Step S631), the process proceeds to Step S632, and when it is determined that the drug-mixing support apparatus 8 is to be used (Yes in Step S631), the process proceeds to Step S633.

### <Step S632>

In Step S632, the controller 201 causes the drug dispensing apparatus 7 to dispense the second label LA12 and an injection prescription sheet to the conveyance tray TR1 by outputting the preparation data corresponding to the cancellation data to the drug dispensing apparatus 7 together with the fifth dispensing instruction. After that, the controller 201 returns the process to Step S61. In each step in the switching control processing, when transmitting the preparation data corresponding to the cancellation data to the drug dispensing apparatus 7, the drug-mixing support apparatus 8, or the like, the controller 201 may output cancellation target information indicating that the preparation data is one for which drug-mixing processing in the drug-mixing apparatus 1 has been canceled.

### <Step S633>

In Step S633, the controller 201 causes the drug dispensing apparatus 7 to dispense an injection prescription sheet by outputting the preparation data corresponding to the cancellation data to the drug dispensing apparatus 7 together with the third dispensing instruction. After that, the controller 201 returns the process to Step S61.

### <Step S64>

In contrast, when it is determined that the drug container can be dispensed from the drug dispensing apparatus 7 (Yes in Step S63), in the subsequent Step S64, the controller 201 determines whether to use the drug-mixing support apparatus 8 in drug-mixing processing based on preparation data corresponding to the cancellation data, similarly to Step S631. When it is determined that the drug-mixing support apparatus 8 is not to be used (No in Step S64), the process proceeds to Step S641, and when it is determined that the drug-mixing support apparatus 8 is to be used (Yes in Step S64), the process proceeds to Step S65.

### <Step S641>

In Step S641, the controller 201 causes the drug dispensing apparatus 7 to dispense a drug container, the second label LA12, and an injection prescription sheet by outputting the preparation data corresponding to the cancellation data to the drug dispensing apparatus 7 together with the fourth dispensing instruction. After that, the controller 201 returns the process to Step S61.

### <Step S65>

In Step S65, the controller 201 causes the drug dispensing apparatus 7 to dispense a drug container and an injection prescription sheet by outputting the preparation data corresponding to the cancellation data to the drug dispensing apparatus 7 together with the second dispensing instruction. After that, the controller 201 returns the process to Step S61.

### Step S66>

In Step S66, the controller 201 causes the drug-mixing support apparatus 8 to execute drug-mixing support processing for supporting user's drug-mixing processing performed based on the preparation data, and also to print the second label LA12 for the preparation data, by outputting the preparation data corresponding to the cancellation data to the drug-mixing support apparatus 8. After that, the controller 201 returns the process to Step S61.

In this manner, in the switching control processing, for preparation data for which drug-mixing processing based on the preparation data in the drug-mixing apparatus 1 has been canceled, the controller 201 causes the second information to be recorded on the second label LA12 by the second recorder 704, the second recorder 804, or the like provided separately from the drug-mixing apparatus 1, by outputting the second dispensing instruction to the fourth dispensing instruction to the drug dispensing apparatus 7 together with the preparation data. In addition, as described above, in the drug-mixing system 100, when drug-mixing processing based on preparation data in the drug-mixing apparatus 1 is canceled, the controller 201 switches a drug-mixing method of the drug-mixing processing based on the preparation data from “machine drug-mixing” to another drug-mixing method such as “manual drug-mixing” and causes the switched drug-mixing method to be executed. That is, the controller 201 may be configured such that, after drug-mixing processing based on preparation data in the drug-mixing apparatus 1 is canceled, the controller 201 cannot reassign the preparation data to the drug-mixing apparatus 1, and does not cause the drug-mixing apparatus 1 to execute drug-mixing processing based on the preparation data. As another embodiment, the controller 201 may be configured to be able to reassign the preparation data to the drug-mixing apparatus 1 after drug-mixing processing based on the preparation data in the drug-mixing apparatus 1 is canceled, and to be able to cause the drug-mixing apparatus 1 to execute drug-mixing processing based on the preparation data.

### [Drug Dispensing Processing of Drug Dispensing Apparatus 7]

In addition, the controller 701 of the drug dispensing apparatus 7 executes the drug dispensing processing (see FIG. 35) of placing the second label LA12, a drug container, an injection prescription sheet, and the like corresponding to each piece of preparation data corresponding to the same conveyance tray TR1 on the conveyance tray TR1 and dispensing the second label LA12, the drug container, the injection prescription sheet, and the like, based on preparation data and the association information input to the drug dispensing apparatus 7. An order of placement of the second label LA12, the drug container, the injection prescription sheet, and the like on the conveyance tray TR1 in the drug dispensing apparatus 7 is not limited to that described here, and placement on the conveyance tray TR1 may be performed in another order such as the order of the drug container, the second label LA12, and the injection prescription sheet, or the order of the second label LA12, the injection prescription sheet, and the drug container.

### <Step S71>

As illustrated in FIG. 35, in Step S71, the controller 701 determines whether preparation data corresponding to the conveyance tray TR1 has been input, based on the association information. Specifically, in one or more embodiments, when a plurality of pieces of preparation data are assigned to a plurality of divided regions TR11 provided on the same conveyance tray TR1, the controller 701 determines that the preparation data corresponding to the conveyance tray TR1 has been input when all of the plurality of pieces of preparation data have been input. When only one piece of preparation data is assigned to the same conveyance tray TR1, it is determined that the preparation data corresponding to the conveyance tray TR1 has been input when the one piece of preparation data has been input. Then, until it is determined that preparation data has been input (No in Step S71), the process waits in Step S71, and when it is determined that preparation data has been input (Yes in Step S71), the process proceeds to Step S72. Then, in the following Step S72 to Step S76, dispensing of the second label LA12, a drug container, an injection prescription sheet, and the like to the conveyance tray TR1 is executed with each of one or a plurality of pieces of preparation data corresponding to the same conveyance tray TR1 set as a processing target.

### <Step S72>

In Step S72, the controller 701 determines whether printing of the second label LA12 is required. Specifically, it is determined that printing of the second label LA12 is required when the fourth dispensing instruction or the fifth dispensing instruction is input together with the preparation data. In addition, it is determined that printing of the second label LA12 is not required when the first dispensing instruction, the second dispensing instruction, or the third dispensing instruction is input together with the preparation data. When it is determined that printing of the second label LA12 is required (Yes in Step S72), the process proceeds to Step S73, and when it is determined that printing of the second label LA12 is not required (No in Step S72), the process proceeds to Step S74.

### <Step S73>

In Step S73, the controller 701 prints the second information on the second label LA12 by the second recorder 704 based on the input preparation data, and places the second label LA12 in a divided region TR11 of the conveyance tray TR1 associated with the preparation data. In contrast, when none of the fourth dispensing instruction and the fifth dispensing instruction is input (No in Step S72), this Step S73 is not executed, and the second label LA12 is not dispensed.

### <Step S74>

In Step S74, the controller 701 determines whether dispensing of a drug container is required. Specifically, the controller 701 determines that dispensing of a drug container is required when the second dispensing instruction or the third dispensing instruction is input together with the preparation data. In addition, it is determined that dispensing of a drug container is not required when the first dispensing instruction, the fourth dispensing instruction, or the fifth dispensing instruction is input together with the preparation data. When it is determined that dispensing of a drug container is required (Yes in Step S74), the process proceeds to Step S75, and when it is determined that dispensing of a drug container is not required (No in Step S74), the process proceeds to Step S76.

### <Step S75>

In Step S75, the controller 701 places a drug container required for drug-mixing processing based on the preparation data in the divided region TR11 of the conveyance tray TR1 associated with the preparation data. In contrast, when none of the second dispensing instruction and the third dispensing instruction is input (No in Step S74), this Step S75 is not executed, and a drug container is not dispensed.

### <Step S76>

In Step S76, the controller 701 prints the injection prescription sheet based on the preparation data, and places the injection prescription sheet on the conveyance tray TR1 associated with the preparation data. That is, in one or more embodiments, in the drug dispensing apparatus 7, whether to print the second label LA12 and whether to dispense a drug container are switched depending on the situation, but an injection prescription sheet is always printed and placed on the conveyance tray TR1. Meanwhile, when drug-mixing processing based on preparation data in the drug-mixing apparatus 1 is canceled, the preparation data may have already been input to the drug dispensing apparatus 7, and an injection prescription sheet and the conveyance tray TR1 corresponding to the preparation data may have been dispensed from the drug dispensing apparatus 7. Accordingly, when receiving the same preparation data as already received preparation data, the controller 701 may not cause an injection prescription sheet corresponding to the preparation data to be printed, and a drug container, the second label LA12, or the like may be placed on, for example, a temporary tray for dispensing only a drug on a temporary basis or a new conveyance tray TR1 and dispensed. For example, when the cancellation target information is output together with the preparation data in the switching control processing described above, when the controller 701 has received the cancellation target information, the controller 701 may not cause an injection prescription sheet corresponding to the preparation data to be printed, and may place a drug container, the second label LA12, or the like on, for example, the temporary tray or a new conveyance tray TR1 and dispense the drug container, the second label LA12, or the like. Further, when the conveyance tray TR1 that has already been dispensed from the drug dispensing apparatus 7 is loaded into the drug dispensing apparatus 7, the controller 701 may place a drug container, the second label LA12, or the like corresponding to preparation data input by the switching control processing on the conveyance tray TR1 (divided region TR11), and dispense the conveyance tray TR1. In the drug dispensing apparatus 7, when an injection prescription sheet corresponding to each piece of preparation data is of a size that can be placed in the divided region TR11 of the conveyance tray TR1, the injection prescription sheet corresponding to the preparation data is placed in the divided region TR11 corresponding to the preparation data. In contrast, in the drug dispensing apparatus 7, when an injection prescription sheet corresponding to each piece of preparation data is not of a size that can be placed in the divided region TR11 of the conveyance tray TR1, injection prescription sheets corresponding to the preparation data are placed on the conveyance tray TR1 corresponding to the preparation data so as to overlap each other across a plurality of divided regions TR11.

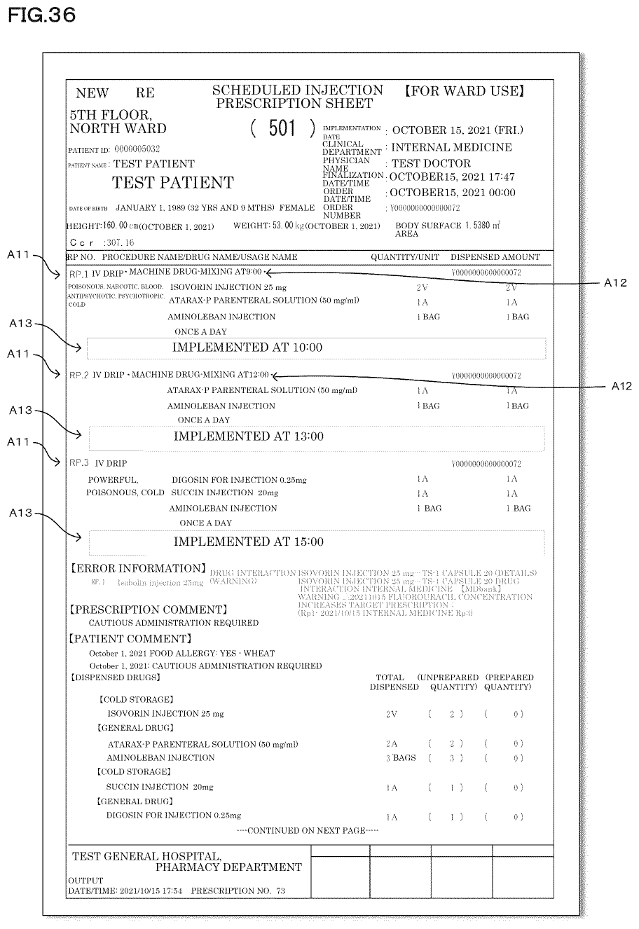

FIG. 36 is a view for illustrating an example of the injection prescription sheet corresponding to a case in which the preparation method is the first preparation method, and drug-mixing processing based on preparation data corresponding to some of a plurality of Rps included in one piece of prescription data is performed by the drug-mixing apparatus 1, and drug-mixing processing based on preparation data corresponding to other Rps is not performed by the drug-mixing apparatus 1. As illustrated in FIG. 36, in a region A11 of the injection prescription sheet, information such as a drug and an infusion container is printed for each of one or a plurality of Rps included in patient's prescription data. In addition, in a region A12 of the injection prescription sheet, for an Rp for which drug-mixing processing is executed by the drug-mixing apparatus 1, information such as a graphic or a character indicating that fact is printed. As a result, the user can easily grasp for each Rp whether drug-mixing processing based on preparation data corresponding to one or a plurality of Rps included in prescription data is executed by the drug-mixing apparatus 1. Accordingly, for example, when a drug container is not placed in the divided region TR11 of the conveyance tray TR1 corresponding to preparation data because drug-mixing processing based on the preparation data is executed by the drug-mixing apparatus 1, the user can easily understand that it is correct that the drug container is not placed in the divided region TR11. In the region A12 of the injection prescription sheet, information such as a graphic or a character indicating that a drug container and the second label LA12 are not placed on the conveyance tray TR1 may be printed. Further, in a region A13 of the injection prescription sheet, for each Rp, a time of administration to a patient of a drug in an infusion container generated based on preparation data corresponding to the Rp is printed.

In addition, for preparation data for which the preparation method is the second preparation method and drug-mixing processing is performed manually by the user, the second label LA12 is not placed on the conveyance tray TR1 dispensed from the drug dispensing apparatus 7. Accordingly, for preparation data for which the preparation method is the second preparation method, the controller 701 may print information such as a graphic or a character indicating that the second label LA12 is not placed on the conveyance tray TR1 on the injection prescription sheet. Similarly, for preparation data for which the preparation method is the third preparation method and both preparation of a drug and drug-mixing processing are performed manually by the user, a drug container and the second label LA12 are not placed on the conveyance tray TR1 dispensed from the drug dispensing apparatus 7. Accordingly, for preparation data for which the preparation method is the third preparation method, the controller 701 may print information such as a graphic or a character indicating that a drug container and the second label LA12 are not placed on the conveyance tray TR1 on the injection prescription sheet. In addition, for preparation data for which the preparation method is the fifth preparation method and both preparation of a drug and drug-mixing processing are performed manually by the user, a drug container is not placed on the conveyance tray TR1 dispensed from the drug dispensing apparatus 7. Accordingly, for preparation data for which the preparation method is the fifth preparation method, the controller 701 may print information such as a graphic or a character indicating that a drug container is not placed on the conveyance tray TR1 on the injection prescription sheet.

In addition, as described above, when pieces of cancellation data for a plurality of pieces of preparation data are collectively processed by the switching control processing, in the switching control processing, the plurality of pieces of preparation data may be grouped as one cancellation group, and the preparation data in the cancellation group may be collectively output to the drug dispensing apparatus 7, the drug-mixing support apparatus 8, and the like. Specifically, it is conceivable that the controller 201 selects a plurality of pieces of preparation data belonging to the cancellation group as a group for one time of finalization processing, and executes the same processing steps as in Step S8 and the subsequent steps. As a result, preparation data belonging to the cancellation group is assigned to the divided region TR11 of the same conveyance tray TR1. In this case, it is conceivable that the controller 201 prints a summary table for the cancellation group by the printing unit 205. For preparation data corresponding to the cancellation data, the controller 201 may print the summary table individually for each piece of preparation data.

### <Step S77>

In Step S77, the controller 701 conveys the conveyance tray TR1 on which the injection prescription sheet and one or both of the second label LA12 and the drug container are placed to a position at which the user can take the conveyance tray TR1 out, and dispenses the conveyance tray TR1. [Tray Verification Processing of Verification Terminal 9]

In addition, the controller 901 of the verification terminal 9 executes the tray verification processing (see FIG. 37) of performing verification on the conveyance tray TR1 and the second label LA12 of the infusion container, and the like.

### <Step S81>

As illustrated in FIG. 37, in Step S81, the controller 901 displays, on the display unit 904, information for prompting reading of identification information such as an order number and an Rp number for identifying preparation data corresponding to an infusion container from code information printed on the second label LA12 attached to the infusion container, and reads the identification information by the code reading unit 903. At this time, the controller 901 may display, on the display unit 904, tray identification information and the like of the conveyance tray TR1 corresponding to the preparation data, based on the association information.

### <Step S82>

In Step S82, the controller 901 displays, on the display unit 904, information for prompting reading of tray identification information of a conveyance tray TR1 from the code BC1 attached to the conveyance tray TR1, and reads the tray identification information by the code reading unit 903.

### <Step S83>

In Step S83, the controller 901 executes verification processing of verifying whether a combination of the identification information of the preparation data read in Step S81 and the tray identification information read in Step S82 matches a combination associated in the association information. In this manner, the controller 901 when executing processing of determining whether identification information of preparation data read from the second label LA12 and identification information of the conveyance tray TR1 read from the conveyance tray TR1 are those associated by the association processor is an example of a determination processor according to one or more embodiments.

### <Step S84>

In Step S84, when a result of the verification processing in Step S83 is a match (Yes in Step S84), the controller 901 advances the process to Step S85. When the result of the verification processing in Step S83 is a mismatch (No in Step S84), the controller 901 displays an error or the like on the display unit 904, and then returns the process to Step S81.

### <Step S85>

In Step S85, the controller 901 notifies the user of a position of the divided region TR11 at which an infusion container is to be placed on the conveyance tray TR1. Specifically, the controller 901 causes the display unit 904 to display the position of the divided region TR11 at which an infusion container is to be placed, based on divided region identification information of the divided region TR11 associated with a combination of the identification information of the preparation data read in Step S81 and the tray identification information read in Step S82, in the association information. The controller 901 when executing Step S85 is an example of a notification processor according to one or more embodiments.

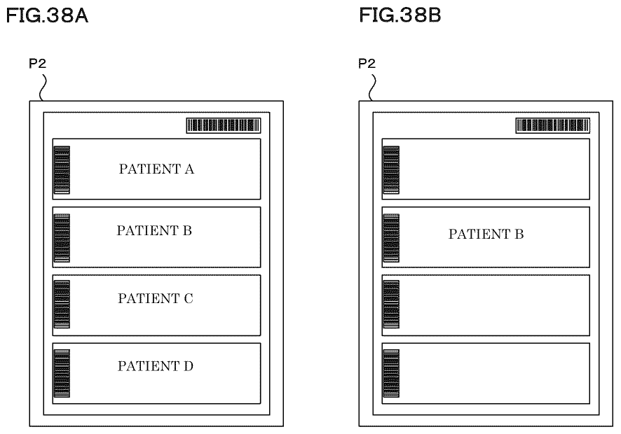

For example, as illustrated in FIG. 38A, the controller 901 displays patient identification information and the like corresponding to preparation data assigned to each of divided regions TR11 at a position of each of the divided regions TR11 on the conveyance tray TR1, on a display screen P2 of the display unit 904. In addition, as illustrated in FIG. 38B, the controller 901 may display patient identification information corresponding to preparation data only at a position of a divided region TR11 to which the preparation data corresponding to identification information read in Step S81 is assigned, among the divided regions TR11 on the conveyance tray TR1, on the display screen P2 of the display unit 904. As a result, the user can easily place an infusion container in each of the divided regions TR11 of the conveyance tray TR1 by referring to the display screen P2.

In addition, in Step S85, when a code BC21 attached to the divided region TR11 is read by the code reading unit 903, the controller 901 may determine whether region identification information of the divided region TR11 corresponding to the code BC21 is one associated with preparation data corresponding to the identification information read in Step S81, in the association information.

As described above, in the drug-mixing system 100, when drug-mixing processing based on preparation data in the drug-mixing apparatus 1 is canceled for some reason such as an error or a schedule change, the second label LA12 is printed by the second recorder 704, the second recorder 804, or the like provided separately from the drug-mixing apparatus 1. Accordingly, even when drug-mixing processing based on preparation data is canceled in the drug-mixing apparatus 1, the user can use the second label LA12 printed by the second recorder 704, the second recorder 804, or the like, and hence the user's work efficiency can be improved.

### [Other Functions]

Now, other functions that the drug-mixing system 100 has are described. The functions described below may be possessed by one of the drug-mixing apparatus 1 and the host system 2 or may be achieved by the drug-mixing apparatus 1 and the host system 2 in cooperation, as long as the functions are possessed by the drug-mixing system 100 as a whole.

### [Equipment Switching Function]

The controller 201 of the host system 2 has an equipment switching function of switching equipment that is required for drug-mixing processing based on preparation data and cannot be used in the drug-mixing apparatus 1 to other equipment. For example, in drug-mixing processing based on preparation data, a special infusion container that has a function of injecting a drug and thus does not require a syringe for drug injection may be used. However, in the drug-mixing apparatus 1, there are cases in which the special infusion container cannot be used in the drug-mixing processing due to mechanical limitations or the like. The special infusion container is generally also called “isotonic sodium chloride solution kit.”

Accordingly, when the special infusion container is required in drug-mixing processing based on preparation data, and the special infusion container cannot be used in the drug-mixing apparatus 1, the controller 201 switches the special infusion container to an infusion container and a syringe that can be used in the drug-mixing apparatus 1. As a result, drug-mixing processing that originally requires the special infusion container and thus cannot be executed by the drug-mixing apparatus 1 can be executed by the drug-mixing apparatus 1 by using the infusion container and the syringe. [Prescription Inspection Function]

The controller 201 of the host system 2 has a prescription inspection function of executing, for example, duplicate administration inspection processing of determining whether a duplicate administration of a drug has occurred when a plurality of pieces of preparation data corresponding to the same patient exist, and upper limit amount inspection processing of determining whether an amount of a drug exceeds an upper limit amount per day.

Specifically, in the duplicate administration inspection processing, when a plurality of pieces of preparation data corresponding to the same patient exist, and both the type of the drug shown in each piece of preparation data and an administration date included in an administration time shown in the piece of preparation data are the same, the controller 201 determines that a duplicate administration of a drug has occurred, and notifies the user of the determination result. In particular, when the type of the drug and the administration date of each piece of preparation data are the same, the controller 201 determines that a duplicate administration of a drug has occurred and notifies the user of the determination result, even when a standard dose such as a dose per body surface area of the drug in the piece of the preparation data is different. As a result, for example, even when a patient's body surface area is different due to a difference in the issuing timing of each piece of preparation data, it is possible to notify the user of the occurrence of a duplicate administration of a drug in the duplicate administration inspection processing.

Similarly, in the upper limit amount inspection processing, when a plurality of pieces of preparation data corresponding to the same patient exist, and both the type of the drug shown in each piece of preparation data and an administration date included in an administration time shown in the piece of preparation data are the same, the controller 201 of the host system 2 determines that an upper limit amount has been exceeded when a total amount of the drug shown in the piece of preparation data exceeds an upper limit amount per day, and notifies the user of the determination result. In particular, when the type of the drug and the administration date of each piece of preparation data are the same, the controller 201 determines that an upper limit amount has been exceeded and notifies the user of the determination result, when a total amount of the drug exceeds an upper limit amount per day, even when a standard dose such as a dose per body surface area of the drug in the piece of preparation data is different. As a result, for example, even when a patient's body surface area is different due to a difference in the issuing timing of each piece of preparation data, it is possible to notify the user of the occurrence of an excess of the upper limit amount of a drug in the upper limit amount inspection processing.

1. A drug-mixing system, comprising:
a drug-mixing apparatus including:
a drug-injecting processor that executes drug-mixing processing of injecting a drug in a drug container into an infusion container based on preparation data; and
a first recorder that records preset recorded information related to the preparation data on a recording medium to be attached to the infusion container; and
a controller that causes the preset recorded information related to the preparation data to be recorded by a second recorder provided separately from the drug-mixing apparatus in response to the drug-mixing processing based on the preparation data in the drug-mixing apparatus being canceled.

2. A drug-mixing system, comprising:
a drug-mixing apparatus including:
a drug-injecting processor that executes drug-mixing processing of injecting a drug in a drug container into an infusion container based on preparation data; and
a first recorder that executes recording processing of recording preset recorded information related to the preparation data on a recording medium to be attached to the infusion container; and
a controller that transmits, to the drug-mixing apparatus, a drug-mixing instruction including an instruction to execute the drug-mixing processing based on the preparation data and an instruction to execute the recording processing, wherein
the controller changes, in response to the drug-mixing processing in the drug-mixing apparatus being canceled, an entity that executes the recording processing from the first recorder to a second recorder provided separately from the drug-mixing apparatus.

3. The drug-mixing system according to claim 1, wherein
the controller notifies cancellation of the drug-mixing processing in response to the drug-mixing processing in the drug-mixing apparatus being canceled.

4. The drug-mixing system according to claim 1, further comprising:
a drug dispensing apparatus that dispenses a drug container and the recording medium on which the preset recorded information is recorded, based on preparation data; and
an assignment processor that assigns preparation data to one of the drug-mixing apparatus or the drug dispensing apparatus, wherein
the controller avoids, for preparation data assigned to the drug-mixing apparatus, causing the drug dispensing apparatus to dispense the drug container and the recording medium, and to cause, for preparation data other than preparation data assigned to the drug-mixing apparatus, the drug dispensing apparatus to dispense the drug container and the recording medium.

5. The drug-mixing system according to claim 4, wherein
the drug dispensing apparatus places the drug container and the recording medium on a conveyance tray and dispense the drug container and the recording medium, and
the drug-mixing system further comprises:
an association processor that associates identification information of the preparation data with identification information of the conveyance tray dispensed by the drug dispensing apparatus based on the preparation data; and
a determination processor that determines whether identification information of the preparation data read from the recording medium and identification information of the conveyance tray read from the conveyance tray are the identification information of the preparation data and the identification information of the conveyance tray that are associated by the association processor.

6. The drug-mixing system according to claim 5, wherein
the association processor associates the identification information of the preparation data, the identification information of the conveyance tray, and identification information of each of divided regions provided on the conveyance tray, and the drug-mixing system further comprises a notification processor that notifies a position of one of the divided regions that is associated with the identification information of the preparation data read from the recording medium and the identification information of the conveyance tray read from the conveyance tray.

7. The drug-mixing system according to claim 1, further comprising an output processor that outputs a list of at least one of the number of infusion containers or a type of the infusion containers corresponding to preparation data for which the drug-mixing processing is executed by the drug-mixing apparatus.

8. The drug-mixing system according to claim 1, further comprising a data output processor that assigns the preparation data corresponding to a plurality of pieces of application data included in one piece of prescription data to the drug-mixing apparatus in units of the plurality of pieces of application data.

9. The drug-mixing system according to claim 8, wherein
the data output processor assigns, based on an instruction, the preparation data to the drug-mixing apparatus in units of one of a prescription classification indicating an administration timing or the plurality of pieces of application data.

10. The drug-mixing system according to claim 9, wherein
the data output processor avoids assigning the preparation data to the drug-mixing apparatus in response to the drug-mixing processing based on the preparation data assigned to the drug-mixing apparatus by an instruction being not executable by the drug-mixing apparatus.

11. The drug-mixing system according to claim 9, wherein
the data output processor displays, on a display screen on which an operation of selecting whether to assign the preparation data to the drug-mixing apparatus is performed by an instruction, whether the drug-mixing processing based on the preparation data is executable by the drug-mixing apparatus.

12. The drug-mixing system according to claim 1, wherein
the drug-mixing apparatus executes drug-mixing processing based on input preparation data in response to execution of the drug-mixing processing being suspended and then a preset condition being satisfied.

13. A non-transitory computer-readable storage medium storing a program for causing a processor provided in a drug-mixing system, the drug-mixing system comprising a drug-mixing apparatus that comprises: a drug-injecting processor that executes drug-mixing processing of injecting a drug in a drug container into an infusion container based on preparation data; and a first recorder that records preset recorded information related to the preparation data on a recording medium to be attached to the infusion container, the program, which when read and executed, causes the processor to perform operation comprising causing the preset recorded information related to the preparation data to be recorded by a second recorder provided separately from the drug-mixing apparatus when the drug-mixing processing based on the preparation data in the drug-mixing apparatus is canceled.

14. The drug-mixing system according to claim 2, wherein
the controller notifies cancellation of the drug-mixing processing in response to the drug-mixing processing in the drug-mixing apparatus being canceled.

15. The drug-mixing system according to claim 2, further comprising:
a drug dispensing apparatus that dispenses a drug container and the recording medium on which the preset recorded information is recorded, based on preparation data; and
an assignment processor that assigns preparation data to one of the drug-mixing apparatus or the drug dispensing apparatus, wherein
the controller avoids, for preparation data assigned to the drug-mixing apparatus, causing the drug dispensing apparatus to dispense the drug container and the recording medium, and to cause, for preparation data other than preparation data assigned to the drug-mixing apparatus, the drug dispensing apparatus to dispense the drug container and the recording medium.

16. The drug-mixing system according to claim 14, further comprising:
a drug dispensing apparatus that dispenses a drug container and the recording medium on which the preset recorded information is recorded, based on preparation data; and
an assignment processor that assigns preparation data to one of the drug-mixing apparatus or the drug dispensing apparatus, wherein
the controller avoids, for preparation data assigned to the drug-mixing apparatus, causing the drug dispensing apparatus to dispense the drug container and the recording medium, and to cause, for preparation data other than preparation data assigned to the drug-mixing apparatus, the drug dispensing apparatus to dispense the drug container and the recording medium.

17. The drug-mixing system according to claim 2, further comprising an output processor that outputs a list of at least one of the number of infusion containers or a type of the infusion containers corresponding to preparation data for which the drug-mixing processing is executed by the drug-mixing apparatus.

18. The drug-mixing system according to claim 3, further comprising an output processor that outputs a list of at least one of the number of infusion containers or a type of the infusion containers corresponding to preparation data for which the drug-mixing processing is executed by the drug-mixing apparatus.

19. The drug-mixing system according to claim 4, further comprising an output processor that outputs a list of at least one of the number of infusion containers or a type of the infusion containers corresponding to preparation data for which the drug-mixing processing is executed by the drug-mixing apparatus.
